(19) United States
(12) Patent Application Publication
(10) Pub. No.: US 2025/0376603 A1
(43) Pub. Date: Dec. 11, 2025

(54) TRI-CURE HYBRID ORGANO-SILICON COATINGS

(71) Applicant: Bowling Green State University, Bowling Green, OH (US)

(72) Inventors: Joseph Furgal, Bowling Green, OH (US); Cory Sims, Bowling Green, OH (US); Chamika Lenora, Bowling Green, OH (US)

(73) Assignee: Bowling Green State University, Bowling Green, OH (US)

(21) Appl. No.: 18/876,874

(22) PCT Filed: Jun. 27, 2023
(86) PCT No.: PCT/US2023/026313

§ 371 Date: Dec. 19, 2024

Related U.S. Application Data
(60) Provisional application No. 63/356,197, filed on Jun. 28, 2022.

(51) Int. Cl. C09D 183/08; C08G 77/14; C08G 77/20; C08G 77/26; C08G 77/28; C09D 5/18

(52) U.S. Cl. CPC C09D 183/08; C08G 77/14; C08G 77/20; C08G 77/26; C08G 77/28; C09D 5/18

(57) ABSTRACT

Protective hybrid coatings are described. The hybrid coatings are silicon-based coatings formed from a multi-stage curing of a single-pot solution containing an epoxy alkoxysilane, an amine alkoxysilane, an alkene alkoxysilane, a thiol alkoxysilane, a solvent, and either (i) a photoinitiator or (ii) a salt, peroxide, or thermal acid generator. Alternative initiators or catalyst can be used to start the cures, and the hybrid coatings may contain various additives.

### RELATED APPLICATIONS

This application claims priority to U.S. Provisional Application No. 63/356,197 filed under 35 U.S.C. § 111 (b) on Jun. 28, 2022, the disclosure of which is incorporated herein by reference in its entirety.

### STATEMENT REGARDING FEDERALLY SPONSORED RESEARCH

This invention was made with government support under Grant Number P20AP00319 awarded by the National Park Service. The government has certain rights in this invention.

### BACKGROUND

Historically, preferred conservation methods for various materials including stones, metals, etc., have used a series of surface coatings. Organic polymers like epoxy resins, acrylates, and fluoropolymers have been used for this purpose due to their hydrophobic and protective capabilities, but they fall short in some areas when used individually. While epoxies offer excellent surface penetration and mechanical strength, they are susceptible to photoinduced oxidation, discoloration, biological surface growth, and have a short pot life (useable time). Acrylics often offer surface reinforcement, are photostable, and may have anti-fouling capabilities, but they tend to be hard to remove and take a long time to cure. Fluoropolymers provide a high hydrophobic surface with photostability, but the hydrophobicity can make them difficult to handle and environmentally unfavorable. Other coatings have used polysiloxanes for their photo and thermal stability and have had success in other industrial applications, but over time they degrade through hydrolysis. Sol-gel systems (i.e. R-alkoxysilanes) have also shown considerable success in preventing oxidative processes on metal surfaces. These silicon-based systems utilize components that can be obtained through green chemical sources such as rice hull ash. While each system has its benefits, the cons lead to difficulty in their application for long-term protection.

Some coatings have been designed to overcome the aforementioned limitations by integrating organics and inorganics into a hybrid system. The use of organic functionalized alkoxysilanes to achieve traits of both systems, including epoxy and fluorocarbon chains, has been successful in some cases. Others have integrated alternative networking side chains such as thiols, alkenes, and alkynes to reduce the stress of shrinkage that occurs in both organic and inorganic polymers. Alternatively, surface modification through spacing or nanoparticle additives with diameters under 0.1 microns has shown an increase in water contact angles through surface roughness, increasing overall hydrophobicity. However, there remains a need in the art for new and improved surface coatings.

### SUMMARY

Provided is a hybrid coating comprising a thiol alkoxysilane; an alkene alkoxysilane; an epoxy alkoxysilane; an amine alkoxysilane; and a solvent; wherein the hybrid coating is in the form of a curable solution.

In certain embodiments, the hybrid coating further comprises a photoinitiator, wherein the hybrid coating is in the form of a photo-curable solution.

In certain embodiments, the thiol alkoxysilane comprises (3-mercaptopropyl)-trimethoxysilane, 2-mercaptoethyltrimethoxysilane, 3-(dimethoxymethylsilyl)-2-methylpropanethiol, or a combination thereof. In certain embodiments, the thiol alkoxysilane is present in an amount of up to about 30% v/v.

In certain embodiments, the alkene alkoxysilane comprises a vinyl group. In certain embodiments, the alkene alkoxysilane comprises an allyl group. In certain embodiments, the alkene alkoxysilane comprises 2,4,6,8-tetramethyl, 2,4,6,8-tetravinylcyclotetrasiloxane, 1,3-divinyltetramethyldisiloxane, vinyltriethoxysilane, N-|2-(vinylbenzylamino)ethyl|-3-aminopropyltrimethoxysilane, vinyltriacetoxysilane, or a combination thereof. In certain embodiments, the alkene alkoxysilane is present in an amount of up to about 60% v/v.

In certain embodiments, the epoxy alkoxysilane comprises 3-glycidyloxypropyltrimethoxysilane, 3-glycidyloxypropyltriethoxysilane, 3-(2,3-epoxypropoxypropyl) methyldiethoxysilane, 2-(3,4-epoxycyclohexyl)ethyltrimethoxysilane, or a combination thereof. In certain embodiments, the epoxy alkoxysilane is present in an amount of up to about 50% v/v.

In certain embodiments, the amine alkoxysilane comprises 3-aminopropyltriethoxysilane, N-(2-aminoethyl)-3-aminopropyltrimethoxysilane, N-[2-(vinylbenzylamino)ethyl]-3-aminopropyltrimethoxysilane, or a combination thereof. In certain embodiments, the amine alkoxysilane is present in an amount of up to about 50% v/v.

In certain embodiments, the photoinitiator comprises phenyl-(2,4,6-trimethylbenzoyl)phosphoryl]-(2,4,6-trimethylaryl)methanone (also known as omnirad 819).

In certain embodiments, the hybrid coating further comprises Norrish type I & II photoinitiators.

In certain embodiments, the hybrid coating further comprises cationic/anionic polymerization initiators.

In certain embodiments, the hybrid coating further comprises a fluorocarbon up to about 30% v/v. In particular embodiments, the fluorocarbon comprises triethoxy (1H,1H,2H,2H-nonafluorohexyl) silane or (tridecafluoro-1,1,2,2-tetrahydrooctyl) triethoxysilane.

In certain embodiments, the hybrid coating further comprises an aromatic alkoxysilane comprising aryltriethoxy silane, trimethyoxy (2-arylethyl) silane, triethyoxy-p-tolylsilane, or a combination thereof. In particular embodiments, the arylalkoxysilane is present in an amount of up to about 30% v/v.

In certain embodiments, the alkoxysilane comprises an alkane, alkene, or alkyne side chain, or a combination thereof. In certain embodiments, the alkyl substituted alkoxysilane is present in an amount of up to about 30% v/v.

In certain embodiments, the alkoxysilane comprises a siloxane side chain or a combination of siloxane side chains. In particular embodiments, the siloxane substituted alkoxysilane is present in an amount of up to about 30% v/v.

In certain embodiments, the hybrid coating further comprises a silsesquioxane. In certain embodiments, the hybrid coating further comprises one or more additional siloxanes, silanes, silsesquioxanes, or combinations thereof. In particular embodiments, the additional siloxanes, silanes, or silsesquioxanes comprise D4 octamethylcyclotetrasiloxane, methyltriethoxysilane, vinyl terminated silsesquioxanes, 1,2-bis(triethoxysilyl)ethane, butylpoly(dimethylsiloxanyl)etbyltriethoxysilane, isooctyltriethoxysilane, isobutyltriethoxysilane, or a combination thereof.

In certain embodiments, the solvent comprises an alcohol. In certain embodiments, the solvent comprises a combination of alcohols. In certain embodiments, the solvent comprises an alcohol having complementarity to one or more of the amine alkoxysilane, the epoxy alkoxysilane, the thiol alkoxysilane, or the alkene alkoxysilane.

In certain embodiments, the thiol alkoxysilane includes a di- or tri-alkoxysilane, the alkene alkoxysilane includes a di- or tri-alkoxysilane, the epoxy alkoxysilane includes a di- or tri-alkoxysilane, and the amine alkoxysilane includes a di- or tri-alkoxysilane.

In certain embodiments, the hybrid coating further comprises a spacer. In particular embodiments, the spacer comprises D4 octamethylcyclotetrasiloxane or a polyethylene glycol (PEG).

In certain embodiments, the hybrid coating further comprises an acid. In particular embodiments, the acid comprises glacial acetic acid, trifluoroacetic acid, or a photoacid generator such as diaryliodonium hexafluorophosphate, or a combination thereof.

In certain embodiments, the hybrid coating further comprises a hydroxide.

In certain embodiments, the hybrid coating further comprises a metal salt. In particular embodiments, the metal salt is zinc chloride.

In certain embodiments, the hybrid coating further comprises a crosslinker.

In certain embodiments, the hybrid coating comprises 3-glycidyloxypropyltrimethoxysilane, 3-aminopropyltriethoxysilane, triethoxy(1H,1H,2H,2H-nonafluorohexyl) silane, (3-mercaptopropyl)-trimethoxysilane, vinyltriethoxysilane, omnirad 819, diaryliodonium hexafluorophosphate, methanol, and isopropanol. In certain embodiments, the hybrid coating comprises 3-glycidyloxypropyltrimethoxysilane in an amount of about 8.2% v/v; 3-aminopropyltriethoxysilane in an amount of about 7.5% v/v; triethoxy(1H,1H,2H,2H-nonafluorohexyl) silane in an amount of about 1.6% v/v; (3-mercaptopropyl)-trimethoxysilane in an amount of about 2.9% v/v; vinyltriethoxysilane in an amount of about 3.3% v/v; omnirad 819 in an amount of about 0.3% w/v; diaryliodonium hexafluorophosphate in an amount of about 0.1% w/v; methanol in an amount of about 36.1% v/v; and isopropanol in an amount of about 40.1% v/v.

In certain embodiments, the hybrid coating comprises 3-glycidyloxypropyltrimethoxysilane, 3-aminopropyltriethoxysilane, (tridecafluoro-1,1,2,2-tetrahydrooctyl) triethoxysilane, (3-mercaptopropyl)-trimethoxysilane, vinyltriethoxysilane, omnirad 819, diaryliodonium hexafluorophosphate, methanol, and isopropanol. In certain embodiments, the hybrid coating comprises 3-glycidyloxypropyltrimethoxysilane in an amount of about 13.7% v/v; 3-aminopropyltriethoxysilane in an amount of about 12.3% v/v; (tridecafluoro-1,1,2,2-tetrahydrooctyl)triethoxysilane in an amount of about 2.8% v/v; (3-mercaptopropyl)-trimethoxysilane in an amount of about 5.0% v/v; vinyltriethoxysilane in an amount of about 5.6% v/v; omnirad 819 in an amount of about 0.5% w/v; diaryliodonium hexafluorophosphate in an amount of about 0.2% w/v; methanol in an amount of about 18.1% v/v; and isopropanol, ethanol, or water in an amount of about 41.8% v/v.

In certain embodiments, the hybrid coating comprises 3-glycidyloxypropyltrimethoxysilane, 3-aminopropyltriethoxysilane, (tridecafluoro-1,1,2,2-tetrahydrooctyl)triethoxysilane, (3-mercaptopropyl)-trimethoxysilane, vinyltriethoxysilane, omnirad 819, diaryliodonium hexafluorophosphate, methanol, and 1-butanol. In certain embodiments, the hybrid coating comprises 3-glycidyloxypropyltrimethoxysilane in an amount of about 13.6% v/v; 3-aminopropyltriethoxysilane in an amount of about 12.3% v/v; (tridecafluoro-1,1,2,2-tetrahydrooctyl)triethoxysilane in an amount of about 2.8% v/v; (3-mercaptopropyl)-trimethoxysilane in an amount of about 5.0% v/v; vinyltriethoxysilane in an amount of about 5.5% v/v; omnirad 819 in an amount of about 0.8% w/v; diaryliodonium hexafluorophosphate in an amount of about 0.3% w/v; methanol in an amount of about 18.1% v/v; and 1-butanol in an amount of about 41.7% v/v.

In certain embodiments, the hybrid coating further comprises a salt, a peroxide, or a thermal acid generator, wherein the hybrid coating is in the form of a thermally curable solution.

In particular embodiments, the salt comprises ZnCl₂. In particular embodiments, the thermal acid generator comprises p-nitrobenzyltosylate. In particular embodiments, the hybrid coating comprises 3-glycidyloxypropyltrimethoxysilane in an amount of about 13.9% v/v; 3-aminopropyltriethoxysilane in an amount of about 12.5% v/v; (3-mercaptopropyl)-trimethoxysilane in an amount of about 5.1% v/v; vinyltriethoxysilane in an amount of about 5.7% v/v; hydrogen peroxide (30% aqueous) in an amount of about 1.0% v/v; ZnCl₂ in an amount of about 1.0% w/v; methanol in an amount of about 18.4% v/v; and isopropanol in an amount of about 42.4% v/v.

In certain embodiments, the hybrid coating further comprises a dye or colorant. In particular embodiments, the hybrid coating comprises a photochromic dye or a combination of photochromic dyes.

In certain embodiments, the hybrid coating further comprises metals or carbon fibers. In particular embodiments, the metals or carbon fibers comprise graphene or nanotubes.

In certain embodiments, the hybrid coating comprises 3-glycidyloxypropyltrimethoxysilane in an amount of about 14.1% v/v; 3-aminopropyltriethoxysilane in an amount of about 12.7% v/v; (3-mercaptopropyl)-trimethoxysilane in an amount of about 5.1% v/v; vinyltriethoxysilane in an amount of about 5.7% v/v; omnirad 819 in an amount of about 0.5% w/v; diaryliodonium hexafluorophosphate in an amount of about 0.2% w/v; methanol in an amount of about 18.6% v/v; and isopropanol in an amount of about 43.0% v/v.

Further provided is a hybrid coating comprising Formula I:

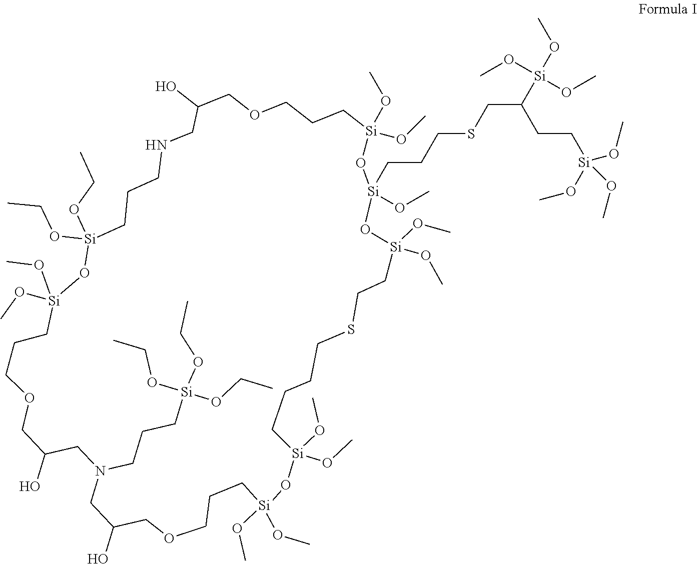

wherein the hybrid coating is in the form of a cured solid.

In certain embodiments, the hybrid coating is a fire retardant. In certain embodiments, the hybrid coating has a water contact angle greater than 90°. In certain embodiments, the hybrid coating is heat resistant up to a temperature of at least 300° C. In certain embodiments, the hybrid coating is coated on a substrate comprising stone, brick, wood, glass, metal, plastic, rubber, fabric, leather, fiberglass, carbon-fiber composites, polyester gel-coat, concrete, steel, aluminum, nitrile, or vinyl.

Further provided is a hybrid coating comprising a composition formed from (i) reaction of an amine alkoxysilane with a thiol alkoxysilane, (ii) reaction of an epoxy alkoxysilane with an alkene alkoxysilane, and (iii) a moisture polymerization to displace alkoxy groups present from the epoxy alkoxysilane, the amine alkoxysilane, the thiol alkoxysilane, and the alkene alkoxysilane.

Further provided is a method of protecting a monument from acid rain and graffiti, the method comprising applying the hybrid coating described herein to a monument and allowing the hybrid coating to cure to protect the monument from acid rain and graffiti.

Further provided is a method of protecting a surface from water, the method comprising applying a hybrid coating comprising a fluorocarbon described herein to a surface and allowing the hybrid coating to cure to protect the surface from water.

Further provided is a method of protecting a surface from scratches, the method comprising applying a hybrid coating described herein to a surface and allowing the hybrid coating to cure to protect the surface from scratches.

Further provided is a method of protecting an item from fire damage, the method comprising applying a hybrid coating described herein to an item and allowing the hybrid coating to cure to protect the item from fire damage. In certain embodiments, the item is wood.

Further provided is a method of protecting or releasing plastics and adhesives from surfaces, the method comprising applying a hybrid coating described herein to a surface and allowing the hybrid coating to cure to protect the surface from adhesion.

Further provided is a method of protecting a surface from biological growth, the method comprising applying a hybrid coating described herein to a surface which may be exposed to biological contamination and allowing the hybrid coating to cure to protect the surface from biological growth.

Further provided is a method of applying a dye to surfaces, the method comprising applying a hybrid coating containing a dye to a surface and allowing the hybrid coating to cure.

Further provided is a method of reducing cell adhesion to a surface, the method comprising applying a hybrid coating described herein to a surface and allowing the hybrid coating to cure to reduce cell adhesion to the surface. In certain embodiments, the surface is glass, metal, plastic, or a silicone. In certain embodiments, the surface comprises a floor or medical instrument. In certain embodiments, the surface comprises a medical device or implant.

Further provided is a method of reducing glossiness of a surface, the method comprising incorporating a salt into the hybrid coating described herein, applying the salt-containing hybrid coating to a surface and allowing the salt-containing hybrid coating to cure to reduce glossiness of the surface. In certain embodiments, the salt is ZnCl₂.

Further provided is a method of reducing static build-up on a surface, the method comprising incorporating a metal or carbon fibers into a hybrid coating described herein, and applying the metal- or carbon fiber-containing hybrid coating to a surface and allowing the metal-or carbon fiber-containing hybrid coating to cure to reduce static build-up on the surface. In certain embodiments, the metal or carbon fibers comprises copper, zinc, iron, graphene, or nanotubes.

Further provided is a method of adhering two surfaces together, the method comprising applying the hybrid coating described herein to at least one of two surfaces, pressing the two surfaces together, and allowing the hybrid coating to cure to adhere the two surfaces together. In certain embodiments, the two surfaces are glass.

Further provided is a method of forming a barrier to oil on a surface, the method comprising applying the hybrid coating described herein to a surface and allowing the hybrid coating to cure on the surface to form a barrier to oil on the surface. In certain embodiments, the surface comprises marble.

Further provided is a method for reducing efflorescence on a surface, the method comprising applying the hybrid coating described herein to a surface and allowing the hybrid coating to cure on the surface to reduce efflorescence on the surface.

Further provided is a method of making a surface more fire resistant, the method comprising applying the hybrid coating described herein to a surface and allowing the hybrid coating to cure on the surface to make the surface more fire resistant. In certain embodiments, the surface comprises wood.

Further provided is a method of improving anti-fouling properties of a surface, the method comprising applying the hybrid coating described herein to a surface and allowing the hybrid coating to cure on the surface to improve anti-fouling properties of the surface. In certain embodiments, the surface comprises glass.

Further provided is a method of making a surface anti-fungal and resistant to rot, the method comprising applying the hybrid coating described herein to a surface and allowing the hybrid coating to cure on the surface to make the surface anti-fungal and resistant to rot. In certain embodiments, the surface comprises wood.

Further provided is a method of preventing wood from splitting at its end, the method comprising applying the hybrid coating described herein to a piece of wood having ends, and allowing the hybrid coating to cure on the piece of wood to prevent the piece of wood from splitting at the ends.

Further provided is a method of curing a hybrid coating, the method comprising coating a substrate with a hybrid coating solution containing a photoinitiator; exposing the hybrid coating solution to sunlight or artificial UV light over a first period of time to allow a first curing process to occur so as to form a coating with non-impressionable surface on the substrate; allowing a second curing process to occur over a second period of time to improve adhesion between the coating and the substrate; and allowing a third curing process to occur over a third period of time to harden the non-impressionable surface. In certain embodiments, the hybrid coating solution comprises a plurality of alkoxysilanes including epoxy, alkene, amine, and thiol components.

Further provided is a method of a coating, applying several layers of a hybrid coating described herein on a substrate, the method comprising applying a first layer of a hybrid coating described herein to a substrate, allowing the first layer to fully cure over a first period of time, and applying a second layer of the hybrid coating to the substrate and allowing the second layer to cure over a second period of time.

Further provided is a method of removing a hybrid coating described herein from a substrate, the method comprising exposing the substrate with the hybrid coating to a solution containing a source of fluoride in a solvent in order to depolymerize siloxane polymers and remove the hybrid coating from the substrate.

Further provided is a coated article comprising a substrate coated with a hybrid coating described herein. In certain embodiments, the article is a monument, tombstone, vehicle, clothing article, tool, industrial mold, or building material.

Further provided is a method of curing a hybrid coating, the method comprising adding a salt to a hybrid coating solution; adding hydrogen peroxide to the hybrid coating solution; coating a substrate with the hybrid coating solution to form a coated substrate; exposing the coated substrate to a temperature of at least about 65° C. for a first period of time; and allowing the coated substrate to rest at room temperature for a second period of time to cure the hybrid coating on the substrate. In certain embodiments, the hybrid coating solution comprises a plurality of alkoxysilanes including epoxy, alkene, amine, and thiol components. In particular embodiments, the hybrid coating solution does not contain a photoinitiator. In certain embodiments, the first period of time is at least about 5 minutes. In certain embodiments, the second period of time is at least about 45 minutes.

Further provided is a method of curing a hybrid coating, the method comprising adding a salt to a hybrid coating solution; adding hydrogen peroxide to the hybrid coating solution; coating a substrate with the hybrid coating solution to form a coated substrate; allowing the coated substrate to rest at room temperature for a first period of time; and exposing the coated substrate to a temperature of at least about 150° C. for a second period of time to cure the hybrid coating on the substrate. In certain embodiments, the hybrid coating solution comprises a plurality of alkoxysilanes including epoxy, alkene, amine, and thiol components. In particular embodiments, the hybrid coating solution does not contain a photoinitiator. In certain embodiments, the first period of time is at least about one hour. In certain embodiments, the second period of time is less than about 30 seconds.

Further provided is a hybrid coating comprising a thiol alkoxysilane, an alkene alkoxysilane, an epoxy alkoxysilane, an amino alkoxysilane, a photoinitiator, and a solvent, wherein the hybrid coating is in the form of a photo-curable solution.

Further provided is a hybrid coating comprising a thiol alkoxysilane; an alkene alkoxysilane; an epoxy alkoxysilane; an amine alkoxysilane; a solvent; and a salt, a peroxide, or a thermal acid generator; wherein the hybrid coating is in the form of a thermally curable solution.

Further provided is a hybrid coating comprising a thiol alkoxysilane; an alkene alkoxysilane; an epoxy alkoxysilane; an amine alkoxysilane; a solvent; and either (i) a photoinitiator, wherein the hybrid coating is in the form of a photo-curable solution, (ii) a salt, peroxide, or thermal acid generator, wherein the hybrid coating is in the form of a thermally curable solution, or (iii) a cation and/or anion, wherein the hybrid coating is in the form of a chemically curable solution.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Scheme showing the general mechanisms of three distinct chemistries in the hybrid coatings described herein: (1) photoinitiated thiol-ene, (2) amine-epoxy, and (3) alkoxysilane polymerization in an example of the crosslinking process.

FIG. 2: ATR-FTIR of the coating solution (black) and cured coating on glass (red) of example 10.

FIG. 3: TGA of example 10 exhibiting a T_{d5%} of 308° C.

FIG. 4: TGA of example 11 exhibiting a T_{d5%} of 275° C.

FIG. 5: TGA of example 12 exhibiting a T_{d5%} of 262° C.

FIG. 6: SEM images at 300× (top) and 1000× (bottom) magnifications comparing the bare (left) and coated (right) surfaces of a marble sample.

FIG. 7: SEM image of the transitional region between surfaces of the marble sample at 50× magnification. The darker region has been coated.

FIG. 8: SEM images at 100× (top) and 500× (bottom) magnifications comparing the bare (left) and coated (right) surfaces of a single glass slide.

FIG. 9: Imaging of stainless-steel histology blades without the manufacturer's coating. The hone of the blade is compared at 1,000× magnification. The raw steel (top) and dip-coated sample (bottom) both exhibit a submicron edge.

FIG. 10: Imaging of stainless-steel histology blades without the manufacturer's coating. The hone of the blade is compared at 100× (top), 500× (middle), and 1,000× (bottom) magnifications. The raw steel (left) and dip-coated samples (right) both exhibit a submicron edge.

FIG. 11: SEM imaging of a nitrile glove at 100× (top) and 1,000× (bottom) magnification, both raw (left) and coated (right).

FIG. 12: Images of a marble sample taken with a Zeiss Stemi 2000-C light microscope at 0.65× (top) and 2.0× magnification (bottom) before (left) and after (right) sandblasting.

FIG. 13: A marble sample's contact angle is 102 days post-cure before abrasion testing (top) and after sandblasting (bottom).

FIG. 14: Surface topography of a stone with half of its surface coated. Blue regions indicate surface depressions, and red regions show elevations. Analysis was performed with a Keyence VK-X1000 Series 3D Laser Confocal Microscope.

FIG. 15: A specified area of brick at 0.65× (top) and 2.0× (bottom) magnification before (left) and after (right) being coated.

FIG. 16: Film thickness analysis performed with a 3D laser confocal microscope which scans the coating surface and sublayer to approximate the difference in distance.

FIG. 17: Table 2, showing coating thickness measurements obtained by an Alpha-Step IQ Surface Profiler (KLA Tencor). Ten measurements were taken of coated glass sides and an average thickness was assessed.

FIG. 18: Time lapse of Sharpie permanent marker removal using a clean, dry Kim-wipe and friction. The bottom image set shows the difference with a half-coated glass slide (coated on left).

FIG. 19: Time lapse of Rust-Oleum Painters touch 2× Ultracover paint+primer removal using a clean, dry Kim-wipe and friction on two different samples.

FIG. 20: Cured coating before (left) and after (right) partial depolymerization when exposed to siloxane targeting solution.

FIG. 21: Table 3, showing average static contact angles of examples on different surfaces. Selected samples represent model systems used in the other analysis methods. Standard deviations are given in parenthesis.

FIGS. 22: Water droplets on the surface of the first (top) and second (bottom) coated bricks after 10 minutes had elapsed from deposition. Images extracted from the end of recordings of each sample taken 2 days after coating (top) and four days after coating (bottom).

FIG. 23: Water droplets on the surface of two samples of raw stainless steel (left) and the coated surface (right).

FIG. 24: Stainless-steel sample before and after seven days of daily exposure to an oxidative rusting solution. The bottom half of the sample was dip-coated.

FIGS. 25A-25B: Dip coated stainless steel samples after seven days of daily exposure to an oxidative rusting solution (FIG. 25A) and after 200 days of exposure to ambient humidity and fumes in a laboratory setting (FIG. 25B). In FIG. 25A, the bottom half of the sample was dip coated, and the photographs show the front (left) and back (right) of stainless-steel sample before (top), after initial treatment (middle), and after seven days of daily exposure to an oxidative rusting solution (bottom). In FIG. 25B, the bottom half was coated and the sample had been suspended ˜6 feet from the ground for the duration of the time. FIG. 25B shows the contrast of gradual rust resistance compared to FIG. 25A where a similar sample went through an accelerated test.

FIGS. 26A-26F: Time-lapse of partially coated steel post submerged in the rusting solution for 14 days. FIG. 26A shows the coated sample. FIG. 26B shows the sample after initial exposure. FIG. 26C shows the sample on day 2. FIG. 26D shows the sample on day 3. FIG. 26E shows the sample 14 days after exposure. FIG. 26F shows the surface condition once the debris was removed.

FIGS. 27A-27D: Sample before (FIG. 27A), after one day (FIG. 27B), 24 days (FIG. 27C), and 208 days (FIG. 27D) after application.

FIGS. 28A-28F: Tombstone before application (FIG. 28A), after one day (FIG. 28B), 111 days (FIG. 28C), 131 days (FIG. 28D), 184 days (FIG. 28E), and 194 days (FIG. 28F) of outdoor exposure to a variety of weather conditions.

FIGS. 29A-29D: Close up of monument edge before coating (FIG. 29A), after one day (FIG. 29B), 111 days (FIG. 29C), and 194 days (FIG. 29D) of environmental exposure.

FIGS. 30A-30C: Time-lapse of the first brick sample before application (FIG. 30A), one day after (FIG. 30B), and 117 days (FIG. 30C) of outdoor exposure.

FIGS. 31A-31C: The second brick before application (FIG. 31A), one day after (FIG. 31B), and 45 days (FIG. 31C) after exposure. It should be noted that the lightening of the brick is due to the repeated, direct (perpendicular) exposure to sunlight, which causes bricks to “bleach” over time.

FIG. 32: Photograph of coated glass given a blue tint through long term submersion in a colored water solution.

FIG. 33: Photograph showing a demonstration of the difference in wettability between a coated (left vial) and uncoated (right vial) glass vial immediately after being removed from water.

FIG. 34: Photographs showing the additive effect on the ability for glass to float on the water's surface. A coated glass slide was dropped onto the water, where it floated from a combination of surface tension effects and coating hydrophobicity and remained afloat when nudged and prodded with a pen. The sample remained afloat until the water evaporated.

FIG. 35: Photograph showing metal needle nose pliers dip coated above the yellow line.

FIG. 36: Photographs showing a demonstration of the low wettability of the pliers in FIG. 35. Only two droplets of water remained on the pliers due to surface tension and they account for the only wet spot on the Kim-wipe (circled in yellow).

FIG. 37: Photograph of a test of the fire retardant properties of the hybrid coating on wood. The piece of wood on the right in the photograph was coated with the hybrid coating, and the piece of wood on the left in the photograph was not coated with the hybrid coating. The coated wood withstood exposure to fire with less damage than the uncoated wood.

FIG. 38: Photographs of a test of the plastic release of coated (left) and uncoated (right) halves of a histology razor blade. Polyethylene terephthalate (PET #1) plastic was melted and attached to the blade.

FIG. 39: Comparison of uncoated (left) and coated (right) portions of a bass boat rail with a hybrid coating thereon.

FIG. 40: Still frame timelapse images of polycarbonate safety glasses which have been coated with a hybrid coating containing a photochromic dye over the course of 15 seconds. Image (1) shows initial exposure to UV light. Image (2) shows full intensity UV light. Image (3) shows the end of exposure (6 seconds). Image (4) shows 4 seconds after exposure. Image (5) shows 9 seconds after exposure.

FIG. 41: Photographs showing a still-frame time lapse (22 seconds) of a camo-painted surface coated with an active loaded hybrid coating.

FIG. 42: Photograph showing glass squares coated with a hybrid coating containing an active dye before (top) and after (bottom) 5 seconds of exposure to sunlight. The color vanishes seconds after removal from the sun.

FIG. 43: Photographs showing a still-frame time lapse of a glass slide coated with a hybrid coating which contains two dyes.

FIG. 44: Photographs showing fluorocarbon-containing coatings containing 0.95 M (left) and 1.84 M (right) ZnCl₂, exhibiting an off-white color and showing a loss of gloss and reflectiveness.

FIG. 46: Photograph showing glass slides adhered to a larger sheet of glass using a hybrid coating.

FIG. 47: Photograph showing marble coated (left of the line) and uncoated (right of the line) with a hybrid coating. The hybrid coating on the marble prevented the absorption of used motor oil, and the uncoated marble absorbed the motor oil.

FIG. 48: Photograph showing a granite tombstone coated with a hybrid coating and exposed to 100% humidity and 5% NaCl salt fog for 240 hours, exhibiting reduced efflorescence on the coated surface (bottom) compared to the uncoated surface (top).

FIG. 49: Photographs showing a comparison of raw pine wood (left) and pine wood coated with a hybrid coating (right), both burned for 4 minutes at greater than 1,000° C. The coated pine wood demonstrated fire resistance compared to the uncoated pine wood.

FIG. 50: Photographs of a glass square coated with a hybrid coating and inoculated with HEK293 mammalian adherence cells. The hybrid coating did not prevent growth but reduced adhesion of the cells to the glass.

FIG. 51: Photograph of submerged glass vials with an interior coated with a hybrid coating, and zebra mussels in the glass vials. Adhesion by the zebra mussels was minimal and the zebra mussels showed difficulty climbing the coated interior of the vials.

FIG. 52: Photographs showing the difference in mold and mildew growth and color change when raw pine, non-fluorinated hybrid coating coated wood, and fluorinated hybrid coating coated wood were saturated by a 100% humidity, 5% NaCl salt fog for 240 hours. The samples were still wet when the photographs were taken.

FIG. 53: Photograph of the same wood blocks shown in FIG. 52 after being left to dry for 6 months. The uncoated samples (left) still supported mold and mildew but had lost color and began to split on the ends. The non-fluorinated (middle; coated with example 14) and fluorinated (right; coated with example 12) hybrid coating coated samples retained their original color and had not begun to split on the ends.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Ideal protective coating systems offer rapid curing, a long life, surface hardness, versatile application methods/conditions, exhibit hydrophobicity, and resist photodegradation and acid rain. In accordance with the present disclosure, the integration of various coating curing methods has produced unique hybrid coating systems with a combination of desired individual characteristics and surprisingly advantageous properties. Provided herein are hybrid coatings made from three orthogonal curing methods in varying ratios to provide first a rapid non-impressionable surface polymerization, second an enhanced epoxide-amine surface adhesion, and third a long-term sol-gel surface hardening with longevity, recoatability, recyclability of components for future uses, easy removability, and enhanced epoxide adhesion. The curing process results in a clear, colorless, hard, hydrophobic, acid-resistant, photodegradation-resistant, temperature-resistant, UV-stable, fire-resistant, and graffiti-resistant surface covering that can be applied to any substrate including, but not limited to, stone, glass, brick, wood, fabric, plastic, rubber, fiberglass, plastic (such as polyethylene or polypropylene), concrete, silicone, ceramic, or metal surfaces. The coatings may be referred to as hybrid coatings, or tri-cure hybrid organo-silicon coatings. The hybrid coating effectively exhibits the strengths of conventional silicon-based coatings but dilutes their shortcomings. Among many other examples, the hybrid coatings are usable as, but not limited to, a top coat or finish, a water sealant, a protective coating for monuments or vehicles, a floor coat, a coating or film for glass products such as eyeglasses, windows, and windshields, an adhesive, a barrier for oils, an efflorescence reducer, a flame-resistant coating, a bio-medical coating for floors, equipment, instruments, and the like, an anti-fouling coating, or an anti-fungal coating.

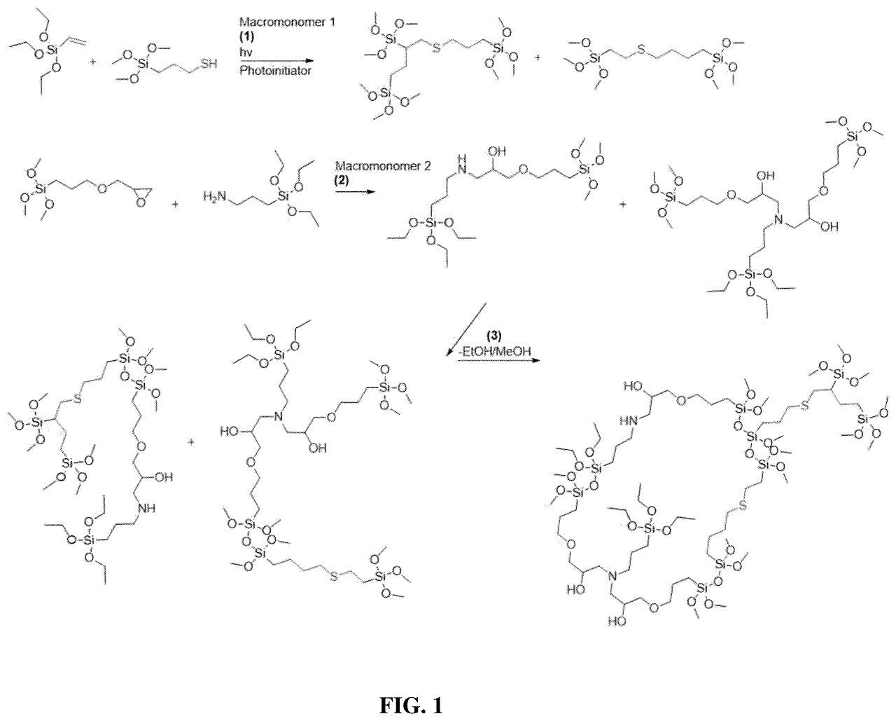

FIG. 1 illustrates non-limiting example structures of the components and curing processes of the hybrid coatings in accordance with the present disclosure. In general, in some embodiments, the hybrid coatings include a thiol alkoxysilane, an alkene alkoxysilane, an epoxy alkoxysilane, an amine alkoxysilane, a photoinitiator, and a solvent. Together, these components form a photo-curable solution that can be cured either by sunlight or artificial light into a hardened, transparent, and protective coating. In other embodiments which can be cured through thermal processes instead of photo-initiated processes, the photoinitiator is not present. Instead, the hybrid coatings may include a salt, such as ZnCl₂, a thermal acid generator, or a peroxide, such as hydrogen peroxide, in order to allow for thermal curing, and the hybrid coating solution can be heated to initiate the three different curing processes instead of using light to do so. In other embodiments which can be cured through cationic/anionic curing, the hybrid coatings may include a cationic or anionic substance capable of initiating the polymerization process. In still other embodiments, the hybrid coatings may contain no initiator.

As described below, many optional additives may also be included in the hybrid coatings. Suitable additives include, but are not limited to, dyes; pigments; liquid crystals; particulates; metals such as copper, zinc, or iron; carbon fibers such as graphene and nanotubes; salts such as NaCl or ZnCl₂; and combinations thereof.

Each of the alkene alkoxysilane, thiol alkoxysilane, epoxy alkoxysilane, and amino alkoxysilane may be either a di- or tri-alkoxysilane. When present, any other additional alkoxysilanes (such as a phenyl alkoxysilane) may also be either a di- or-tri alkoxysilane. Thus, the hybrid coatings herein are silane-based coatings. In one non-limiting example, the hybrid coating may have the following structure of Formula I, after the first two curing processes have completed:

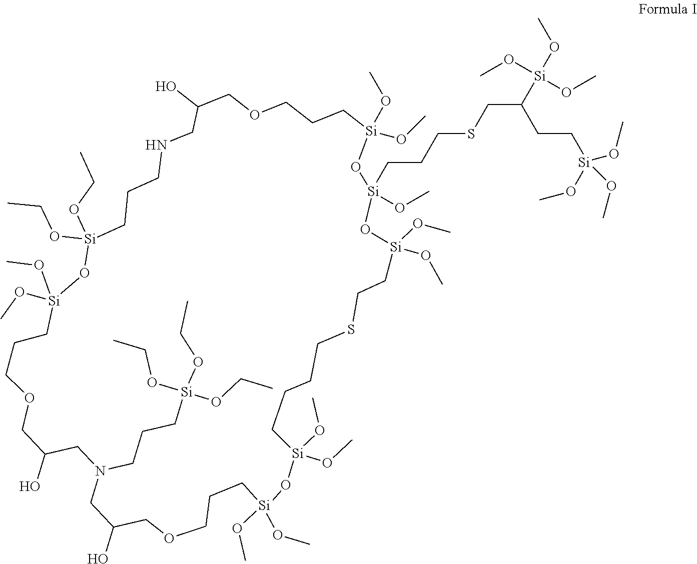

It is understood, however, that further alkoxysilane reactivity may occur, and, therefore, the structure of the final, fully-cured hybrid coating may differ. Furthermore, the structure of the final, fully-cured hybrid coating depends on the identity of the components used in the solution, and thus many other structures of the cured hybrid coating are possible and encompassed within the scope of the present disclosure.

As seen in FIG. 1, in this coating system, sol-gel processes are used to form an oxidation resistant, thermal-stable, and photostable siloxane network backbone, with functionalized side chains that undergo alternative curing processes. In some embodiments, the hybrid coating integrates a thiol and vinyl photoinitiated cure (thiol-ene) to rapidly form a hard surface and relieve network stress on the overall system while adding extra photostability. Additionally, epoxy, amine, and optional fluorocarbon and aromatic side chains increase surface adhesion and penetration, mechanical strength, and hydrophobicity (lower surface energy). The overall network exhibits favorable qualities of each coating type while reducing the drawbacks frequently seen in their separate usage.

The alkene alkoxysilane may include either a vinyl group or an allyl group tied to the alkoxysilane. There is no limit to the number of carbons in the chain between the alkene group and the alkoxysilane in the alkene alkoxysilane. In some embodiments, there are from 1 to 9 carbons in the chain between the alkene group and the alkoxysilane. In the non-limiting example depicted in FIG. 1, there is one carbon between the double bond of the alkene group and the alkoxysilane. The alkene alkoxysilane may be present in an amount of up to about 60% v/v. The alkene alkoxysilane may be present in the form of a combination of multiple alkene alkoxysilanes which together are present in a combined amount of up to about 60% v/v. The alkoxysilane moiety may be a di- or tri-alkoxysilane, but not a mono-alkoxysilane, because polymerization into the silicon polymer is important for the overall hybrid coating. Non-limiting examples of suitable alkene alkoxysilanes include 2,4,6,8-tetramethyl,2,4,6,8-tetravinylcyclotetrasiloxane, 1,3-divinyltetramethyldisiloxane, vinyltriethoxysilane, N-[2-(vinylbenzylamino) ethyl]-3-aminopropyltrimethoxysilane, vinyltriacetoxysilane, or a combination thereof.

The thiol alkoxysilane may include a thiol group and an alkoxysilane with no limit to the chain length between the two. In some embodiments, there are from 1 to 9 carbons in the chain between the thiol group and the alkoxysilane. In the non-limiting example depicted in FIG. 1, the chain length between the thiol and the alkoxysilane is 3 carbons long. The alkoxysilane moiety may be a di- or tri-alkoxysilane, but not a mono-alkoxysilane, because polymerization into the silicon polymer is important for the overall hybrid coating. Non-limiting examples of suitable thiol alkoxysilanes include (3-mercaptopropyl)-trimethoxysilane, 2-mercaptoethyltrimethoxysilane, 3-(dimethoxymethylsilyl)-2-methylpropanethiol, or a combination thereof. The thiol alkoxysilane, or combination of thio alkoxysilanes, may be present in an amount (or a combined amount) of up to about 30% v/v.

The epoxy alkoxysilane may include an epoxy group and an alkoxysilane with no limit to the chain length between the two. In some embodiments, there are from 1 to 9 carbons in the chain between the epoxy group and the alkoxysilane. In the non-limiting example depicted in FIG. 1, the chain length between the epoxy and the alkoxysilane is 3 carbons long. The alkoxysilane moiety may be a di- or tri-alkoxysilane, but not a mono-alkoxysilane, because polymerization into the silicon polymer is important for the overall hybrid coating. Non-limiting examples of suitable epoxy alkoxysilanes include 3-glycidyloxypropyltrimethoxysilane, 3-glycidyloxypropyltriethoxysilane, 3-(2,3-epoxypropoxypropyl)methyldiethoxysilane, 2-(3,4-epoxycyclohexyl)ethyltrimethoxysilane, and combinations thereof. However, other epoxy alkoxysilanes are possible and encompassed within the scope of the present disclosure. The epoxy alkoxysilane, or combination of epoxy alkoxysilanes, may be present in an amount (or combined amount) of up to about 80% v/v.

The amine alkoxysilane may include an amine group and an alkoxysilane with no limit to the chain length between the two. In some embodiments, there are from 1 to 9 carbons in the chain between the amine group and the alkoxysilane. In the non-limiting example depicted in FIG. 1, the chain length between the amine and the alkoxysilane is 3 carbons long. The alkoxysilane moiety may be a di- or tri-alkoxysilane, but not a mono-alkoxysilane, because polymerization into the silicon polymer is important for the overall hybrid coating. Non-limiting examples of suitable amine alkoxysilanes include 3-aminopropyltriethoxysilane, N-(2-aminoethyl)-3-aminopropyltrimethoxysilane, N-[2-(vinylbenzylamino)ethyl]-3-aminopropyltrimethoxysilane, or a combination thereof. However, other amine alkoxysilanes are possible and encompassed within the scope of the present disclosure. The amine alkoxysilane, or combination of amino alkoxysilanes, may be present in an amount (or a combined amount) of up to about 80% v/v.

The amounts of the thiol and alkene alkoxysilanes may be less than the amounts of the epoxy and amine alkoxysilanes. The thiol-ene components are provided to make the hybrid coating not sticky, and to prevent debris accumulation. However, the thiol-ene system is prone to nucleophilic attack. Therefore, it is advantageous to include more epoxy and amine alkoxysilanes compared to thiol and alkene alkoxysilanes.

The photoinitiator, when present in the hybrid coating solution, is present to catalyze the thiol-ene reaction (i.e., the reaction between the alkene alkoxysilane and the thiol alkoxysilane). Any radical or photo acid initiator may be used including Norrish type I & II. Non-limiting examples of suitable photoiniators include aryl-(2,4,6-trimethylbenzoyl)phosphoryl]-(2,4,6-trimethylaryl)methanone (also known as omnirad 819), diaryliodonium hexafluorophosphate, or a combination thereof. However, many other photoinitiators are possible and are encompassed within the scope of the present disclosure. Furthermore, as mentioned above, in some embodiments, the hybrid coating solution does not include a photoinitiator. Instead, the hybrid coating solution may be configured for a thermal curing process, and may include a salt, such as ZnCl₂, and a peroxide, such as hydrogen peroxide, or a thermal acid generator. Thermal acid generators include, but are not limited to, p-nitrobenzyltosylate. Alternatively, the hybrid coating may include a cationic or ionic substance capable of initiating cationic/anionic curing.

The hybrid coating may optionally further include one or more fluorocarbons in an amount of up to about 30% v/v. The presence of a fluorocarbon in the hybrid coating increases the hydrophobicity of the hybrid coating. Suitable fluorocarbons include fluorosiloxanes or long chain fluoro-containing alkyls. Non-limiting example fluorocarbons include triethoxy (1H,1H,2H,2H-nonafluorohexyl) silane, (tridecafluoro-1,1,2,2-tetrahydrooctyl) triethoxysilane, or a combination thereof. However, many other fluorocarbons are possible and encompassed within the scope of the present disclosure. Advantageously, the hybrid coating does not release the fluorocarbons. Furthermore, one or more coats of a hybrid coating that includes a fluorocarbon can be applied over one or more coats of a hybrid coating that does not include a fluorocarbon after 48 hours, or over one or more coats of a hybrid coating that includes a fluorocarbon after a month. Using a combination of coating formulas can allow for surfaces to not be contacted by a fluorinated coating if necessary to comply with any applicable law, regulation, or preference while still providing the hydrophobicity benefits of a fluorinated coating.

The hybrid coating may optionally further include one or more aromatic, alkane, alkene, or alkyne alkoxysilanes in an amount of up to about 30% v/v. For example, the hybrid coating may include one or more aryl alkoxysilanes and one or more perfluoro alkoxysilanes. The presence of a hydrocarbon group in the hybrid coating increases the hydrophobicity of the hybrid coating. Suitable hydrocarbon alkoxysilanes include short and long chain saturated and unsaturated containing alkyls. Non-limiting example hydrocarbon alkoxysilanes include aryltriethoxy silane, trimethyoxy(2-arylethyl)silane, triethyoxy-p-tolylsilane, isooctyltriethoxysilane, isobutyltriethoxysilane, (alkyl)ₙtriethoxysilane, or a combination thereof. However, many other aryl, alkane, alkene, and alkyne silanes are possible and encompassed within the scope of the present disclosure.

The hybrid coating may optionally further include one or more aromatic, alkane, alkene, or alkyne siloxane alkoxysilanes in an amount of up to about 30% v/v. The presence of a siloxane side chain in the hybrid coating increases the hydrophobicity, crosslinking, and relieves stress of the hybrid coating. Suitable hydrocarbon alkoxysilanes include short and long chain saturated and unsaturated containing siloxane side chains. A non-limiting example of a siloxane side chains is butylpoly(dimethylsiloxanyl)ethyltriethoxysilane. However, many other siloxane containing side chain alkoxysilanes are possible and encompassed within the scope of the present disclosure.

The hybrid coating may optionally further include a spacer, which is an unreacting diluent that slows the curing process. The advantage of including a spacer is to alleviate the possibility of cracking caused by too fast of a curing process. The spacer may be, for example non-reactive siloxanes (i.e., siloxanes which do not include a reactive group such as an epoxy, amine, thiol, or alkene) or a polyethylene glycol (PEG) compound. Non-limiting examples of suitable spacers include D₄ octamethylcyclotetrasiloxane, poly(ethylene glycol) 400, and combinations thereof. However, many other spacers are possible and encompassed within the scope of the present disclosure.

The hybrid coating may optionally further include a crosslinker in order to increase the flexibility of the hybrid coating, which may cause a decrease in the hardness of the hybrid coating. A crosslinker softens the hybrid coating, which is particularly useful when the hybrid coating is being used to coat something flexible such as a pair of gloves. Suitable crosslinkers include, but are not limited to, compounds having amine-reactive groups such as an ester or an imidoester; and compounds having sulfhydryl-reactive groups such as a maleimide, a haloacetyl compound, a pyridyldisulfide, a thiosulfonate, or a vinylsulfonate. Non-limiting examples of crosslinkers include dimethyl suberimidate, ethylene dimethacrylate, ethylene glycol dimethacrylate, polymethyl(ketoxime) siloxane, or a combination thereof. However, other crosslinkers are possible and encompassed within the scope of the present disclosure.

The hybrid coating may optionally further include a thickener, such as an anthraquinone siloxane, if desired. The presence of a thickener may aid in wiping or painting the hybrid coating onto a substrate before curing.

The hybrid coating solution can be prepared by combining the components in a sufficient amount of a suitable solvent to dissolve the solids. The solvent can be any non-water liquid which dissolves the components of the hybrid coating. Water cannot be used as the solvent because it would interfere with the third coating process. Alcohols are especially advantageous solvents because they are environmentally friendly. Furthermore, alcohols which are complementary to groups on the reactants (i.e., the alkene alkoxysilane, the amine alkoxysilane, the thiol alkoxysilane, and the epoxy alkoxysilane) can be selected, so as to allow an exchange of those groups without creating polymers. This complementarity between reactants and solvent(s) improves the shelf life of the hybrid coating. However, any intermediate polarity solvent or combination thereof (excluding water), can be used. Furthermore, in some embodiments, the solvent is a mixture of solvents. For example, if methanol is used alone as the solvent, it may evaporate too quickly in high temperatures (such as in certain outdoor environments where the hybrid coating is being applied to monuments), so a higher boiling point solvent such as butanol may be used in combination with the methanol.

The solvent may be present in an amount of up to about 80% v/v, and is typically present in an amount of at least about 20% v/v. The high solvent loading (relatively low solids content) of the hybrid coating allows the hybrid coating to be aerosolized for application by a suitable aerosol spraying system if desired. The solvent may be, for example, water, ethanol, isopropanol, methanol, 1-butanol, or combinations thereof. However, many other solvents are possible and encompassed within the scope of the present disclosure.

One non-limiting example hybrid coating, referred to herein as example 11, includes (before being cured) 3-glycidyloxypropyltrimethoxysilane in an amount of about 8.2% v/v, 3-aminopropyltriethoxysilane in an amount of about 7.5% v/v, triethoxy (1H,1H,2H,2H-nonafluorohexyl) silane in an amount of about 1.6% v/v, (3-mercaptopropyl)-trimethoxysilane in an amount of about 2.9% v/v; vinyltriethoxysilane in an amount of about 3.3% v/v, omnirad 819 in an amount of about 0.3% w/v, diaryliodonium hexafluorophosphate in an amount of about 0.1% w/v, methanol in an amount of about 36.1% v/v, and isopropanol in an amount of about 40.1% v/v.

Another non-limiting example hybrid coating, referred to herein as example 12, includes (before being cured) 3-glycidyloxypropyltrimethoxysilane in an amount of about 13.7% v/v, 3-aminopropyltriethoxysilane in an amount of about 12.3% v/v, (tridecafluoro-1,1,2,2-tetrahydrooctyl) triethoxysilane in an amount of about 2.8% v/v, (3-mercaptopropyl)-trimethoxysilane in an amount of about 5.0% v/v, vinyltriethoxysilane in an amount of about 5.6% v/v, omnirad 819 in an amount of about 0.5% w/v, diaryliodonium hexafluorophosphate in an amount of about 0.2% w/v, methanol in an amount of about 18.1% v/v, and isopropanol in an amount of about 41.8% v/v. Example 12 is an example of a fluorinated hybrid coating.

In an alternative version of example 12 using ethanol as the solvent (referred to herein as example 12E), the hybrid coating includes (before being cured) 3-glycidyloxypropyltrimethoxysilane in an amount of about 13.7% v/v, 3-aminopropyltriethoxysilane in an amount of about 12.3% v/v, (tridecafluoro-1,1,2,2-tetrahydrooctyl)triethoxysilane in an amount of about 2.8% v/v, (3-mercaptopropyl)-trimethoxysilane in an amount of about 5.0% v/v, vinyltriethoxysilane in an amount of about 5.6% v/v, omnirad 819 in an amount of about 0.5% w/v, diaryliodonium hexafluorophosphate in an amount of about 0.2% w/v, methanol in an amount of about 18.1% v/v, and ethanol in an amount of about 41.8% v/v.

In yet another alternative version of example 12 using water as the solvent (referred to herein as example 12W), the hybrid coating includes (before being cured) 3-glycidyloxypropyltrimethoxysilane in an amount of about 13.7% v/v, 3-aminopropyltriethoxysilane in an amount of about 12.3% v/v, (tridecafluoro-1,1,2,2-tetrahydrooctyl) triethoxysilane in an amount of about 2.8% v/v, (3-mercaptopropyl)-trimethoxysilane in an amount of about 5.0% v/v, vinyltriethoxysilane in an amount of about 5.6% v/v, omnirad 819 in an amount of about 0.5% w/v, diaryliodonium hexafluorophosphate in an amount of about 0.2% w/v, methanol in an amount of about 18.1% v/v, and water in an amount of about 41.8% v/v.

Another non-limiting example hybrid coating, referred to herein as example 13, includes (before being cured) 3-glycidyloxypropyltrimethoxysilane in an amount of about 13.6% v/v, 3-aminopropyltriethoxysilane in an amount of about 12.3% v/v, (tridecafluoro-1,1,2,2-tetrahydrooctyl) triethoxysilane in an amount of about 2.8% v/v, (3-mercaptopropyl)-trimethoxysilane in an amount of about 5.0% v/v, vinyltriethoxysilane in an amount of about 5.5% v/v, omnirad 819 in an amount of about 0.8% w/v, diaryliodonium hexafluorophosphate in an amount of about 0.3% w/v, methanol in an amount of about 18.1% v/v, and 1-butanol in an amount of about 41.7% v/v.

Another non-limiting example hybrid coating, referred to herein as example 14, includes (before being cured) 3-glycidyloxypropyltrimethoxysilane in an amount of about 14.1% v/v, 3-aminopropyltriethoxysilane in an amount of about 12.7% v/v, (3-mercaptopropyl)-trimethoxysilane in an amount of about 5.1% v/v, vinyltriethoxysilane in an amount of about 5.7% v/v, omnirad 819 in an amount of about 0.5% w/v, diaryliodonium hexafluorophosphate in an amount of about 0.2% w/v, methanol in an amount of about 18.6% v/v, and isopropanol in an amount of about 43.0% v/v. Example 14 is an example of a non-fluorinated hybrid coating.

Another non-limiting example hybrid coating, which is suitable for thermal curing and referred to as example 15, includes (before being cured) 3-glycidyloxypropyltrimethoxysilane in an amount of about 13.9% v/v, 3-aminopropyltriethoxysilane in an amount of about 12.5% v/v, (3-mercaptopropyl)-trimethoxysilane in an amount of about 5.1% v/v, vinyltriethoxysilane in an amount of about 5.7% v/v, hydrogen peroxide (30% aqueous) in an amount of about 1.0% v/v, ZnCl₂ in an amount of about 1.0% w/v, methanol in an amount of about 18.4% v/v, and isopropanol in an amount of about 42.4% v/v.

Many other specific formulations of the hybrid coating solutions are possible and encompassed within the scope of the present disclosure. Furthermore, although the above specific formulations are given as non-limiting examples, it is understood that the addition of additives (such as dyes or pigments, silver for antimicrobial properties, or salts) to these example formulations will change the concentrations of the components in the formulations from the specific concentrations given above.

The hybrid coating can be applied to a substrate in a wide variety of ways before the hybrid coating is cured. The hybrid coating solution can be sprayed onto a desired substrate, or the substrate may be dipped in the hybrid coating solution, or the hybrid coating solution may be wiped or brushed onto the substrate. The manner in which the hybrid coating is applied to the substrate before curing is not particularly limited. Furthermore, there is no limit to the type of substrate that the hybrid coating is useful on. The substrate may be porous or non-porous, hard or soft, flexible or rigid. Non-limiting examples of substrates include stone, brick, wood, glass, metal, plastic, fabric, fiberglass, concrete, ceramic, steel, aluminum, and polymeric materials such as nitrile or vinyl. With a stone substrate, a slight acid etch of the stone before coating is beneficial. However, this is not strictly necessary.

The curing of the hybrid coating may happen in stages. Referring to FIG. 1, in some embodiments, there is an initial fast curing process (1) from the thiol-ene reaction which takes about 10-30minutes upon exposure to light, after which time the hybrid coating is non-impressionable yet soft. This first curing process (1) involves the photoinitiator, which can be any radical initiator. The thiol-ene reaction occurs with the aid of an initiator. The ideal wavelength of light for the curing depends on the identity of the photoinitiator, but in general, UV light may be used to complete the first curing process. In fact, the first curing process (1) works well in sunlight. If being cured indoors, a UV lamp may be used. There is a second curing process (2) of the epoxy and amine curing which improves the adhesion of the hybrid coating to the substrate, and this curing takes several hours. The second curing process (2) causes the hybrid coating to better adhere to the substrate and makes the hybrid coating somewhat harder. There is a third curing process (3) to make the silicon polymer so as to improve the long-term stability of the hybrid coating and obtain the hybrid coating's final hardness, and this curing process takes a few days to complete. The third curing process (3) is a moisture cure which takes place by pulling in water so as to displace alkoxy groups and harden the coating to its final hardness. When acid is present in the hybrid coating, the acid can speed up the second (2) and third curing process (3) to some extent. Therefore, in some embodiments, the hybrid coating further includes an acid such as a photoacid generator, which is any photoresponsive group that can release a photon. Non-limiting example acids are glacial acetic acid, the photoacid generator diaryliodonium hexafluorophosphate, and combinations thereof. However, other acids and photoacid generators are possible and encompassed within the scope of the present disclosure.

Even though the hybrid coating is fully cured through three distinct curing processes, the hybrid coating can be formulated as a one-pot composition, i.e., a single solution. This provides the advantages of easier and simpler storage, transport, and application of the hybrid coating.

As noted above, the hybrid coating can be cured through various alternative curing processes. The formulation of the hybrid coating solution can be divided into one or more containers which cure through non-photo-initiated processes. For example, a cationic and/or anionic initiated polymerization process can be utilized. As another example, thermal curing, including but not limited to thermal activation through peroxides, thermal acid generators, or general heating, is possible. This includes thermal curing methods which are stable at room temperature.

Upon curing, the components become interdispersed to form a homogenous coating which, as noted above, may be a siloxane and may have the formula of Formula I:

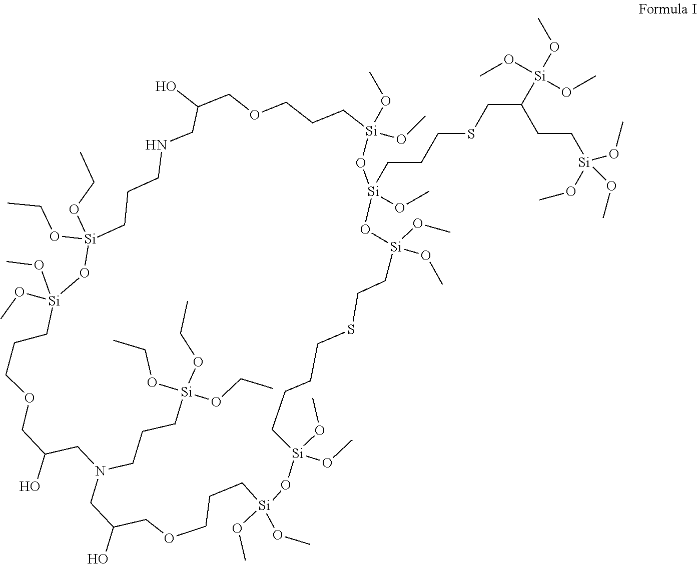

In some embodiments, the cured hybrid coating has a thickness that may range from about 1.3 microns to about 10.3 microns. However, the thickness of the cured hybrid coating can be adjusted according to the method by which the hybrid coating is applied to a substrate, and may be tailored as desired.

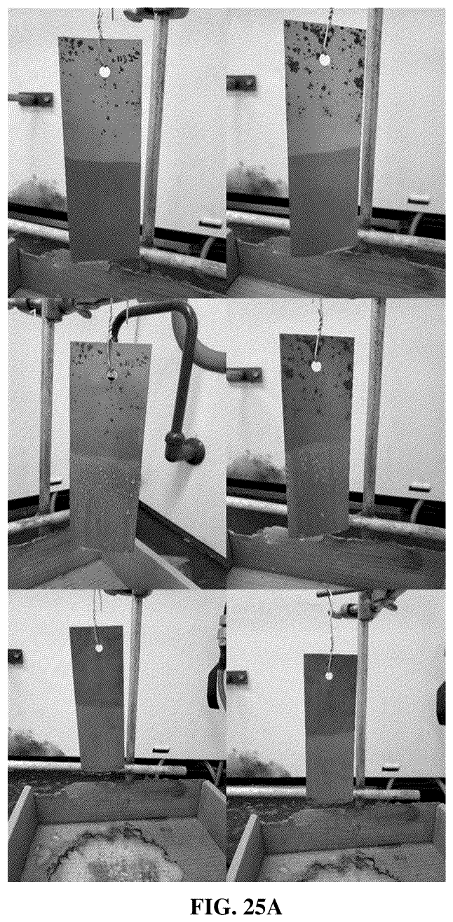

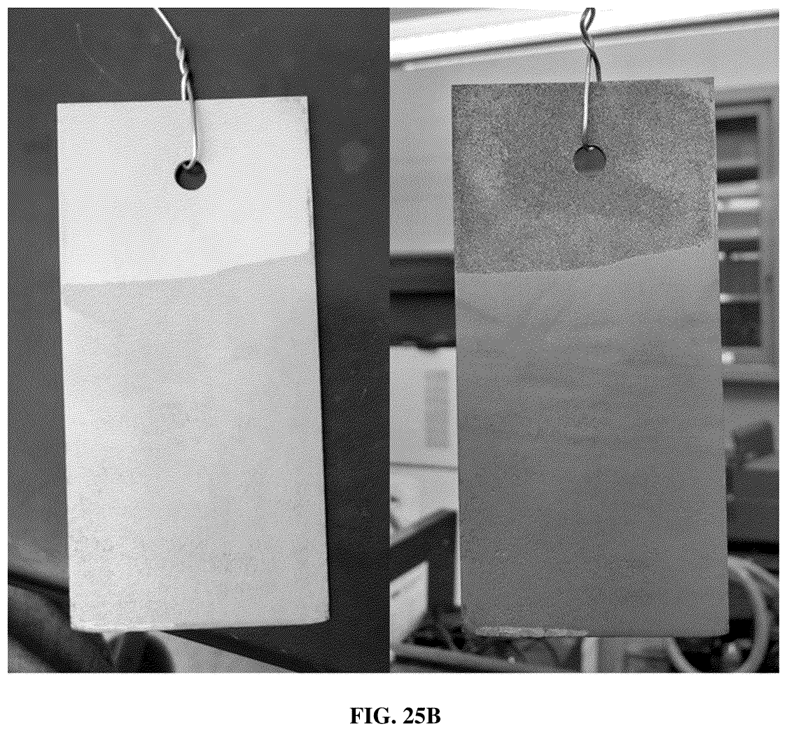

The cured hybrid coating is a non-impressionable coating with resistance to water, acid, impacts, scratches, fire, and graffiti, increasing longevity of the substrate it is coated on by providing a multi-purpose protective coating. The hybrid coating has excellent hardness, stain resistance, and ability to be cleaned. The graffiti resistance allows for the easy removal of permanent markers and paints which are otherwise costly to remove, and makes the hybrid coating advantageous for use on public monuments. The hybrid coating has good heat resistance, being stable up to at least about 300° C. The hybrid coating is also a flame retardant, preventing fire damage to a substrate the hybrid coating is coated on and self-extinguishing flames. The hybrid coating is resistant to water spotting, exhibits an ability to inhibit rust over time (see FIG. 25B), and adheres to oxidation. The hybrid coating is not prone to any noticeable deterioration from exposure to the elements. The hybrid coating combines the use of three distinct, orthogonal curing processes to achieve these benefits, and does so in a one-pot manner for ease and simplicity of use. The hybrid coating solution (i.e., before curing) has an excellent shelf life, of at least 3 years, if kept sealed and in the dark. Some color change may occur after about 6 months with frequent exposure to light, but this color change does not affect the properties of the resulting coating once cured.

The hybrid coating is generally transparent, allowing the hybrid coating to be used on monuments or other structures without observers noticing the coating or even knowing that the monument or structure includes a coating. However, the hybrid coating is reflective on glass substrates. Furthermore, one or more dyes or pigments can be added to the hybrid coating before curing if a color or opacity is desired for a particular application. Photo-chromic dyes and compounds can be integrated into the hybrid coating to offer a transitional effect. Non-limiting examples of such dyes are spiropyrans. The hybrid coating can effectively be tinted if desired.

The hybrid coating is stable to submersion in water to a pH of 3. Therefore, the hybrid coating can be coated onto a substrate which is placed underwater after curing, or on a dry, floating surface. As a non-limiting example, the hybrid coating can be coated onto the hull of a boat above the water line, and then cured from the sunlight to form a protective coating on the boat hull. Alternatively, as a non-limiting example, the hybrid coating can be coated onto the surface of an oil rig above the water line, and then cured from the sunlight to form a protective coating on the structure.

The surface adhesion of the cured hybrid coating is very good. In fact, in some embodiments, the hybrid coating may be used as an adhesive to adhere two substrates, such as glass substrates, together. Once fully cured, the hybrid coating cannot be easily pried off of a substrate or removed with common cleaning agents. The epoxy alkoxysilane helps the surface adhesion of the hybrid coating. Rather, the hybrid coating can be removed from a substrate by methods which depolymerize siloxane polymers. The hybrid coating can be removed easily using the process for depolymerizing a siloxane polymer described in international patent application PCT/US2022/014500 (published as WO 2022/165305 A1, incorporated herein by reference in its entirety). In particular, the hybrid coating can be removed with a solution containing a solvent (such as THF) and a source of fluoride, which dissolves the alkoxysiloxane bonds of the cured hybrid coating. However, other methods of depolymerizing the alkoxysiloxane polymer, and thus removing the hybrid coating from a substrate, are possible and encompassed within the scope of the present disclosure.

The hybrid coatings described herein are advantageous compared to conventional coatings because they can offer a long pot life, variable applications, rapid photo-initiated curing, and enhanced hardness. Further, the hybrid coatings provide resistance to oxidation and hydrolysis, which are common issues with most current technologies. Rapid curing prevents contamination of the surface from exterior sources, something not currently seen. The hybrid coatings can be easily removed without defacing or damaging the original surface, which is an issue with acrylates. Most conventional technologies based on siloxanes do not offer a fast photocure and non-thermal post cure methodologies. The siloxane system described herein utilizes three independent curing methods to simultaneously form a colorless, transparent, and hard coating. A photoinduced fast cure using UV and/or visible light enables a hard-to-touch non-penetrable cure in less than 30 min, preventing debris contamination. The second stage and third stages continue to cure over time under ambient conditions, strengthening surface adhesion and hardness over a period of days. No specific thermal conditions are necessary, and ambient conditions are preferred to give best coating performance. The solutions for these hybrid coatings have an observed pot life of one year with ambient temperature, dark storage, and can be applied by spray, dip, roll, etc. The hybrid coatings are environmentally friendly, composed of non-toxic materials, and applicable through variable means.

Advantageously, the hybrid coatings are a one pot system that is easy, simple, and can be inexpensive. The hybrid coatings can be made entirely from components which are commercially available. There are a plethora of possible uses for the hybrid coatings. The hybrid coatings may be used to protect monuments, such as outdoor monuments at parks, from graffiti and acid rain. The hybrid coatings may be used to protect vehicle surfaces from scratches or other marring. The hybrid coatings may be used to reduce structural fire damage. The hybrid coatings may be used to protect boat hulls from scratches or other damage. The hybrid coatings are especially useful for the outdoor/indoor preservation of elements- exposed objects in the architecture, construction, and cultural heritage protection industries where stone, concrete, metal, and glass are prevalent. The hybrid coatings can protect against acid rain, water erosion, and graffiti while increasing the longevity of cultural resources. Furthermore, the hybrid coatings can be used as protection for stone, glass, and metal objects in marine and aerospace environments. The hybrid coatings may also be useful in the automotive industry, for protecting automotive surfaces, imparting hydrophobicity (for example, to a window to cause rain to run off it), and enabling photochromic coloring. The hybrid coatings are similarly useful to protect marine, recreational vehicle (RV), aviation, and aerospace vehicles or other surfaces. The hybrid coatings can be used in biomaterials for surgical implants or devices. The hybrid coatings may also be useful in production facilities, for coating high temperature material molds or presses and enabling ease of material release, such as the release of plastics or rubbers from aluminum or steel molds. Acid rain in particular is of great future importance due to the lowering pH of rain with higher concentrations of CO₂ and H₂SO₄ in the atmosphere, as well as a higher propensity for severe storms. These conditions as well as vandalism can destroy expensive buildings and monuments that are left unprotected. The hybrid coatings are a great solution for this problem. The hybrid coatings are also useful for HVAC applications to protect HVAC systems from the elements or any environment. Coating an HVAC unit or component (e.g., blowers, doors, enclosures, fans, louvers, exposed piping, and coils) can extend the unit life with improved functionality. The hybrid coatings can be used to carry or encapsulate pigments, dyes, liquid crystals, or particulates, and thereby provide an altered surface color or appearance after curing on a surface. This can be used, for example, to change the appearance of a painted surface such as unwanted graffiti. Thus, the hybrid coatings are particularly useful for protecting architectural and cultural resources, but have a plethora of valuable uses in addition to protecting architectural and cultural resources.

### EXAMPLES

A coating system integrating three distinct chemistries was developed to protect a series of materials including but not limited to stone, concrete, polymer, metals, and glass. Initial curing is achieved using a UV-initiated thiol-ene/vinyl reaction to form a non-impressionable surface. Second, amine/epoxy reactions form a firm surface adhesion and give mechanical strength. Third, alkoxysilane sol-gel curing integrates the silicon network while adding thermal stability, hydrophobicity, surface hardening, and abrasion resistance. Curing can be facilitated by the incorporation of one or more photo-initiators, including radical and cation (i.e., photoacid generator) initiators, to increase reaction efficiency. The coating composition can be applied by spray, dip, or wipe-on methods. This coating exhibits a rapid non-impressionable surface (as fast as 10 min) that resists graffiti, environmental conditions (moisture, sunlight, acid), and is used and stored as a single component system with a pot life exceeding 1 year. A series of examples are given to show the coating properties and longevity, including field testing and accelerated weathering.

Base formulations of the coatings in these examples contained vinyl, thiol, epoxy, amino, and fluorocarbon (optional) alkoxysilane components as detailed in these examples and given in ratios as outlined in Table 1. Initial formulations also contained various ratios of components with relatively low solvent percentages (10-15% methanol) and D₄ octamethylcyclotetrasiloxane as a spacing agent. These were designed to investigate the effects of altering the ratios of components pertaining to the different curing methods. This was achieved by increasing one set of components while decreasing another over a range of volume percentages and repeating the process for multiple combinations of adjustments (i.e., increasing thiol-ene/lowering adhesion, increasing adhesion/decreasing fluorocarbon).

The resulting coatings were inspected for their hydrophobicity, and systems which did not delaminate after curing were chosen for further exploration and given throughout. This included example 1, which was made using 3-glycidyloxypropyltrimethoxysilane (28.0%), 3-aminopropyltriethoxysilane (28.0%), triethoxy (1H,1H,2H,2H-nonafluorohexyl) silane (5.5%), (3-mercaptopropyl)-trimethoxysilane (9.0%), vinyltriethoxysilane (9.0%), omnirad 819 (.5%), D₄ octamethylcyclotetrasiloxane (8.0%), and methanol (12.0%), and was applied by spraying. A set of solutions was designed to investigate adjustments using example 1 as a base system. While adhesion was successful, example 1 systems led to delamination over time, and thus a series of formulations were designed to see the effect of increasing the solvent ratio to 25%, 50%, and 70%. From these tests the delamination occurring upon hardening was resolved and example 2 [3-glycidyloxypropyltrimethoxysilane (13.8%), 3-aminopropyltriethoxysilane (12.4%), triethoxy(1H,1H,2H,2H-nonafluorohexyl) silane (2.8%), (3-mercaptopropyl)-trimethoxysilane (4.8%), vinyltriethoxysilane (5.6%), omnirad 819 (0.3%), and methanol (60.3%), applied by spraying] was found to have the highest water contact angle when inspected on glass (to ensure comparable surface roughness).

Next, the implementation of different vinyl containing compounds, the effects of adding acetic acid to increase the reaction rate, and modifications to the surface through nanoparticle formation were explored as ways to increase the hydrophobicity of the system and ensure survival of samples through long-term water exposure tests. The best samples were chosen from all previous formulations based on contact angles, adhesion, and removability of permanent marker. From these, example 3 was chosen to expand upon due to its lack of toxic components and overall lower production cost stemming from its use of 3-glycidyloxypropyltrimethoxysilane (13.8%), 3-aminopropyltriethoxysilane (12.3%), triethoxy (1H,1H,2H,2H-nonafluorohexyl) silane (2.7%), (3-mercaptopropyl)-trimethoxysilane (4.9%), vinyltriethoxysilane (5.6%), omnirad 819 (0.6%), and methanol (60.2%), and spray application. To resolve the delamination caused by submersion, several sets of this formula were investigated and included effects of varying the coating thickness, UV exposure times, alternative solvents, thickness versus cure time, annealing, and the addition of tetrabutyl ammonium fluoride as a co-catalyst. From these tests it was determined that advantageous thickness (˜10 microns) resulted from applying approximately 1.2 mL of solution on a 8.5×10 cm marble surface (1 mL for 70.8 cm²) when spraying the solution; example 4 gave these results from a mixture of 3-glycidyloxypropyltrimethoxysilane (13.8%), 3-aminopropyltriethoxysilane (12.3%), triethoxy (1H,1H,2H,2H-nonafluorohexyl) silane (2.7%), (3-mercaptopropyl)-trimethoxysilane (4.9%), vinyltriethoxysilane (5.6%), Omnirad 819 (.4%), and methanol (60.3%). Increasing the cure time and annealing at 45° C. for 24 hours resulted in an increase in contact angle, and showed high suitability for outdoor application, but keeping a 2-minute UV exposure indoors allows for a versatile range of end-user applications.

Using ethanol as a solvent resulted in example 5 [3-glycidyloxypropyltrimethoxysilane (13.7%), 3-aminopropyltriethoxysilane (12.3%), triethoxy (1H,1H,2H,2H-nonafluorohexyl) silane (2.7%), (3-mercaptopropyl)-trimethoxysilane (4.9%), vinyltriethoxysilane (5.6%), omnirad 819 (0.7%), and ethanol (60.1%) and spray application], which shared its resistance to graffiti with its methanol counterpart. While example 4 successfully survived the water submersion test and subsequent acid rain and base solution tests, example 5 delaminated after prolonged water exposure.

With example 4 surviving long-term exposure, the effects of coating method and surface preparation were investigated. The results indicated that the application method had little effect on the resulting coating. However, when comparing stone pretreated with water, vinegar (5%), or 0.11M nitric acid, an improved contact angle was seen in the latter. Results to this point indicated that a thinner coating and nitric acid prepped surface (mimicking long term acid rain exposure) should be used for indoor application of coatings, where outdoor surfaces exposed to rain are adequate for usage. Next, examples 6 [3-glycidyloxypropyltrimethoxysilane (14.1%), 3-aminopropyltriethoxysilane (12.7%), (3-mercaptopropyl)-trimethoxysilane (5.0%), vinyltriethoxysilane (5.7%), omnirad 819 (0.7%), and methanol (61.8%), applied by spraying] and example 7 [3-glycidyloxypropyltrimethoxysilane (12.7%), 3-aminopropyltriethoxysilane (11.3%), triethoxy (1H,1H,2H,2H-nonafluorohexyl) silane (10.5%), (3-mercaptopropyl)-trimethoxysilane (4.5%), vinyltriethoxysilane (5.1%), omnirad 819 (0.5%), and methanol (55.4%), sprayed on] confirmed the additive effect the fluorocarbon species had on hydrophobicity. Similarly, a set of examples was made without the thiol-ene components according to the same conditions, however they delaminated, indicating that the thiol most likely relieves tension in the alkoxysilane network.

In an effort to increase the overall hydrophobicity and reaction rate, a photo-acid generator (for example diaryliodonium hexafluorophosphate) was added in small amounts and the effects on contact angle were compared through sprayed example 8 [3-glycidyloxypropyltrimethoxysilane (13.3%), 3-aminopropyltriethoxysilane (11.9%), triethoxy (1H,1H,2H,2H-nonafluorohexyl) silane (2.6%), (3-mercaptopropyl)-trimethoxysilane (4.7%), vinyltriethoxysilane (5.4%), omnirad 819 (.5%), diaryliodonium hexafluorophosphate (3.4%), and methanol (58.2%)] and example 9 [3-glycidyloxypropyltrimethoxysilane (13.7%), 3-aminopropyltriethoxysilane (12.3%), triethoxy (1H,1H,2H,2H-nonafluorohexyl) silane (2.7%), (3-mercaptopropyl)-trimethoxysilane (4.9%), vinyltriethoxysilane (5.6%), omnirad 819 (0.5%), diaryliodonium hexafluorophosphate (.1%), and methanol (60.1%)]. These samples were used in initial outdoor testing, however the solvent in the first samples evaporated before curing could be achieved. In response, the formulas were diluted with isopropanol where dilute example 8 is still in the field and shows stability for >250 days of weather exposure.

A variant of example 9, example 10, was made solely using isopropanol and underwent various analyses and was spray applied and utilized 3-glycidyloxypropyltrimethoxysilane (13.7%), 3-aminopropyltriethoxysilane (12.3%), triethoxy (1H,1H,2H,2H-nonafluorohexyl) silane (2.7%), (3-mercaptopropyl)-trimethoxysilane (4.9%), vinyltriethoxysilane (5.6%), omnirad 819 (0.6%), diaryliodonium hexafluorophosphate (0.2%), and isopropanol (60.1%).

An isopropanol diluted example 9 was applied to a stone monument which was still stable at 300 days. This example 11 [3-glycidyloxypropyltrimethoxysilane (8.2%), 3-aminopropyltriethoxysilane (7.5%), triethoxy (1H,1H,2H,2H-nonafluorohexyl) silane (1.6%), (3-mercaptopropyl)-trimethoxysilane (2.9%), vinyltriethoxysilane (3.3%), omnirad 819 (0.3%), diaryliodonium hexafluorophosphate (0.1%), methanol (36.1), and isopropanol (40.1%)] was more dilute and sprayed on with a pressurized garden sprayer. Two more systems were designed which used an alternative fluorocarbon, (tridecafluoro-1,1,2,2-tetrahydrooctyl) triethoxysilane, which is longer and cheaper. The first, example 12 [3-glycidyloxypropyltrimethoxysilane (13.7%), 3-aminopropyltriethoxysilane (12.3%), (tridecafluoro-1,1,2,2-tetrahydrooctyl) triethoxysilane (2.8%), (3-mercaptopropyl)-trimethoxysilane (5.0%), vinyltriethoxysilane (5.6%), omnirad 819 (0.5%), diaryliodonium hexafluorophosphate (.2%), methanol (18.1), and isopropanol (41.8%)], uses the isopropanol dilution and has comparative characteristics to example 11 when sprayed or dip coated. Alternatively, example 13 was designed to lengthen the working time of the solution and used a dilution of butanol to increase the time to non-impressionability from 30 minutes with the forementioned systems to between 60 and 100 minutes depending upon the application method and thickness [3-glycidyloxypropyltrimethoxysilane (13.6%), 3-aminopropyltriethoxysilane (12.3%), (tridecafluoro-1,1,2,2-tetrahydrooctyl) triethoxysilane (2.8%), (3-mercaptopropyl)-trimethoxysilane (5.0%), vinyltriethoxysilane (5.5%), omnirad 819 (.8%), diaryliodonium hexafluorophosphate (0.3%), methanol (18.1), and 1-butanol (41.7%)]. The final collection of systems included several formulations including examples 4-13, all of which share similar characteristics. Some of the ranges of materials used in the different example formulations 1-13 are shown in Table 1. These are non-limiting examples, and other thiol, allyl, epoxy, amine, initiators, optional alkoxysilanes, and additives are readily substituted within these ranges.

TABLE 1
Ranges included in the set of examples 4-13. Minimum and maximum
volume percentages are given. Omnirad 819 and diaryliodonium
hexafluorophosphate are solids and were calculated by % w/v.

| Reagent Volume Percentages | Min | Max |
|---|---|---|
| 3-Glycidyloxypropyltrimethoxysilane | 0 | 70 |
| 3-Aminopropyltriethoxysilane | 0 | 70 |
| Triethoxy(1H,1H,2H,2H-nonafluorohexyl) silane | 0 | 15 |
| (Tridecafluoro-1,1,2,2-tetrahydrooctyl)triethoxysilane | 0 | 15 |
| (3-Mercaptopropyl)-trimethoxysilane | 0 | 30 |
| Omnirad 819 | 0.2 | 4 |
| Vinyltriethoxysilane | 0 | 30 |
| 2,4,6,8-Tetramethyl,2,4,6,8-tetravinylcyclotetrasiloxane | 0 | 15 |
| 1,3-Divinyltetramethyldisiloxane | 0 | 15 |
| Vinyl Terminated Silsesquioxanes (mixed cages) | 0 | 15 |
| D4 Octamethylcyclotetrasiloxane | 0 | 20 |
| Methyltriethoxysilane | 0 | 8 |
| 1,2-Bis(triethoxysilyl)ethane | 0 | 14 |
| Tetrabutylammonium fluoride | 0 | 5 |
| Diaryliodonium hexafluorophosphate | 0 | 16 |
| H₂O | 0 | 10 |
| Poly(ethylene glycol) 400 | 0 | 12 |
| Glacial Acetic Acid | 0 | 10 |
| Aryltriethoxy silane | 0 | 30 |
| Alkyltriethoxy silane | 0 | 30 |
| Methanol | 0 | 90 |
| Ethanol | 0 | 90 |
| Isopropanol | 0 | 90 |
| 1-Butanol | 0 | 80 |

### Curing Process

Formulations were developed with several end-of-life goals in mind. The solution is made in a single container as a no-mix system, and the final formulations have achieved a pot life exceeding 3 years. Formulations are still usable after 3 years and the cured hybrid coatings are stable after 2 years of environmental exposure and 2 years of simulated ocean exposure. The series of formulations was designed with rapid curing in mind, however adjustments to how quickly the coating dries can be made by using longer chain alcohols for the base solvent, lengthening the time it takes for the network to settle on the surface. While the system has been successful through spraying, dipping, and wiping application methods, it was designed for ease of use through pressurized pump spraying systems outdoors, or industrial spraying systems. One example use is for monument preservation, and this led to most of the testing being focused on spray and dipped applications utilizing marble samples.

The tri-cure system was developed using the three distinct chemistries shown in FIG. 1. The system composition was designed to integrate thiol-ene, epoxy/amine, and optionally fluorocarbon chemistries on an alkoxysilane sol-gel backbone. The thiol-ene reaction provides a photo-initiated rapid curing surface which has achieved a consistent non-impressionable yet soft surface within thirty minutes. To drive the initial thiol-ene cure, omnirad 819 photoinitiators were used in the presence of either a UV-C mercury lamp or sunlight. This was initially adjusted to occur within 10 minutes. However, this may sometimes be too fast to allow for proper settling and rearrangement of the other components. For this reason it was tuned toward a 30 min cure after 2 minutes of irradiation.

The amine-epoxy components are designed to provide further penetration into the surface, adding adhesion and mechanical strength to the coating as the secondary curing process. The initial formulations did not include a specific activator for this process, but it was found that a push was helpful to drive ring opening. A general photoacid generator (PAG) (e.g., diaryliodonium hexafluorophosphate), was then used to increase the reaction rate of the secondary and later discussed tertiary reactions. When used in high concentrations, like example 8, the system was non-impressionable within 9 minutes and lower amounts maintained the previously achieved 30-minute surface hardness. Ultimately, small amounts of the PAG were utilized as adding too much decreased the observed contact angle with a higher concentration used in example 8, and a lower amount in example 9 (95.9° to) 101.5°. This also allowed for the same UV process to drive both the radical and acid cure processes together. The first two curing processes form macromonomers for the third sol-gel curing process.

The third curing process takes advantage of alkoxysilane sol-gel reactions occurring more slowly over time, offering thermal and photostability while unifying the polymer network. Other functionalities were installed in the system through the alkoxysilane cross-linkage. Optional fluorocarbon components were used in low ratios to increase the hydrophobicity and due to their chemical and biological resistance. Triethoxy (1H,1H,2H,2H-nonafluorohexyl)silane and (tridecafluoro-1,1,2,2-tetrahydrooctyl)triethoxysilane were used depending on the formulation, with the latter being a much lower cost option. Overall property differences between them were negligible. Minimal amounts of fluorocarbon were used due to costs, but removing it completely resulted in a decreased contact angle of 92.5°, as shown in example 6. Testing showed that increasing the amount resulted in a slight increase from 97.1° (˜3%) to 101.5° (˜10%) in the observed contact angle between examples 4 and 7, however it was an unnecessary added cost to explore any further ratios higher than 5% for protective systems. The combination of the above components was investigated through various chemical and physical properties analyses as detailed below.

### Chemical Characterization

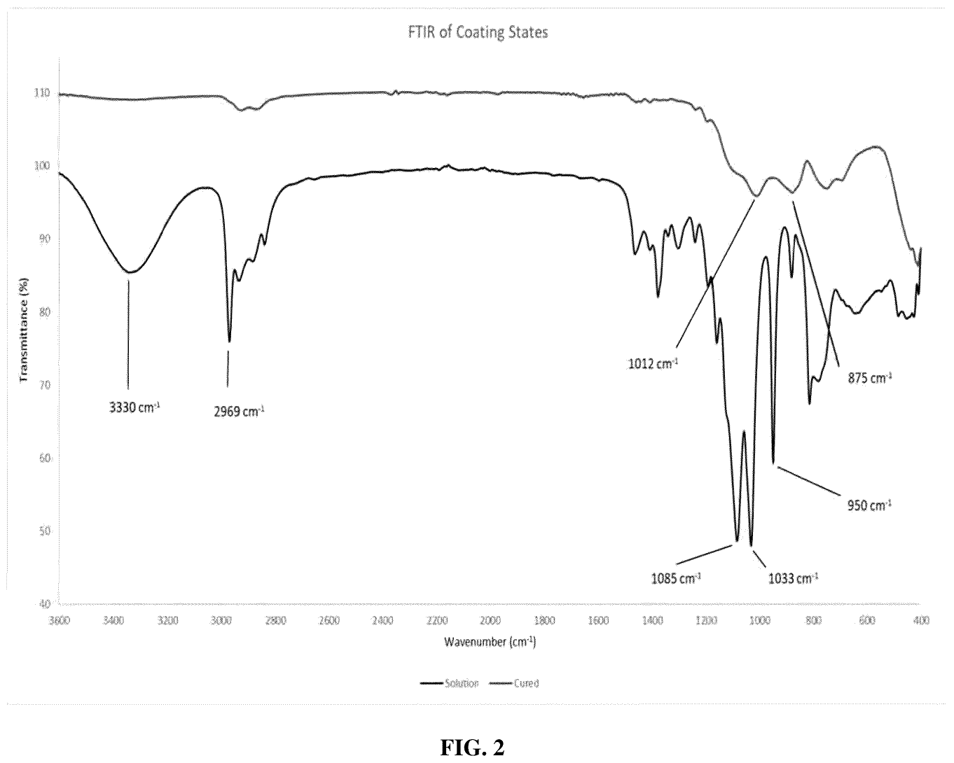

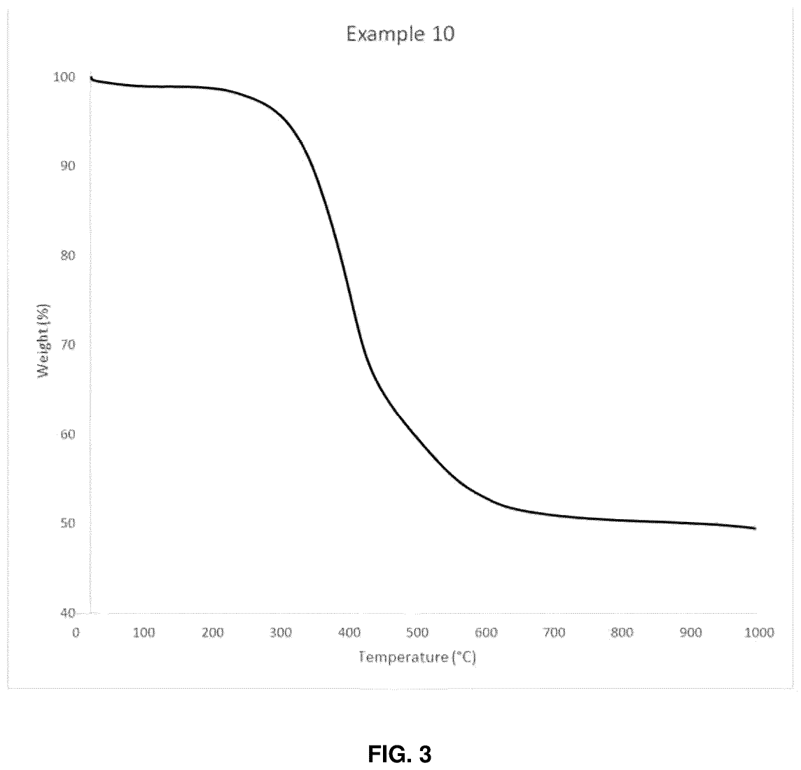

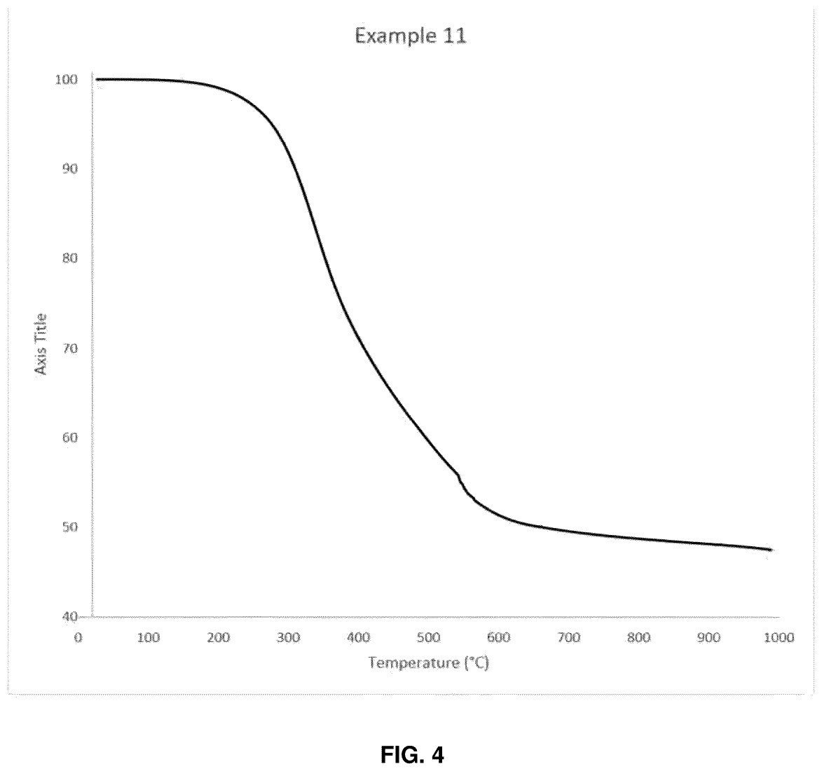

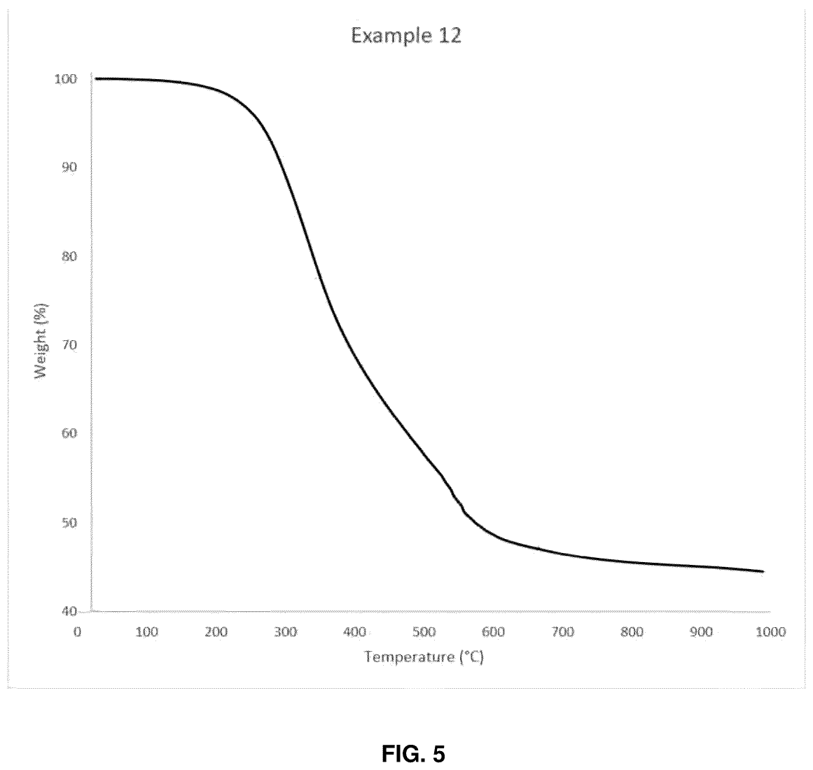

Chemical analysis was carried out using attenuated total reflection fourier transform infrared spectroscopy (ATR-FTIR) and thermal gravimetric analysis (TGA) to probe the reaction mechanisms of the system. ATR-FTIR was taken for the solution and a coated glass surface to observe changes occurring during the curing process (FIG. 2). The solution spectra primarily show the presence and loss of methanol and isopropanol by the O—H stretching at 3300 cm⁻¹, C—H peaks at 2900 cm⁻¹, C—O stretching at 1085 cm⁻¹, and C—O stretching 1033 cm⁻¹, and O—H bending at 950 cm⁻¹, which are mostly absent from the cured sample. Additionally, the absence of amine and alcohol peaks in the final product indicates the reactivity of the secondary epoxy and amine process occurred. However, partial products may still be present in the system. S—H peaks are absent around 2600 cm⁻¹ or C═C−H peaks around 3000 cm⁻¹ in the coated spectra, indicating minimal amounts of vinyl remain in the system, supporting that the thiol-ene reaction is reaching completeness. Furthermore, the peaks at 1012 cm⁻¹ and 875 cm⁻¹ in the cured spectra indicate the presence of a combination consisting of Si—O, C—O, and Si—O—C bonds which are from alkoxysilanes and partially reacted species, supporting the occurrence of the tertiary sol-gel reaction taking place over a more extended period. Siloxane formation is further supported through TGA analysis (FIGS. 3-5). When allowed to dry prior to analysis, these coatings remain stable with a T_{d5%} of 308° C., 275° C., and 262° C. for examples 10, 11, and 12, respectively, which is within the anticipated range for siloxane networks. This information supports the reaction mechanisms described herein.

### Physical Characterization

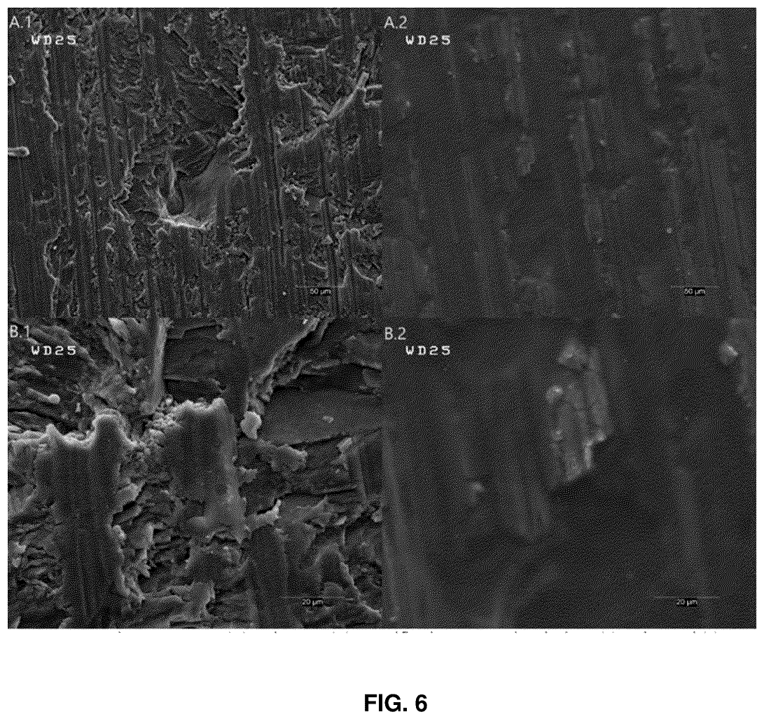

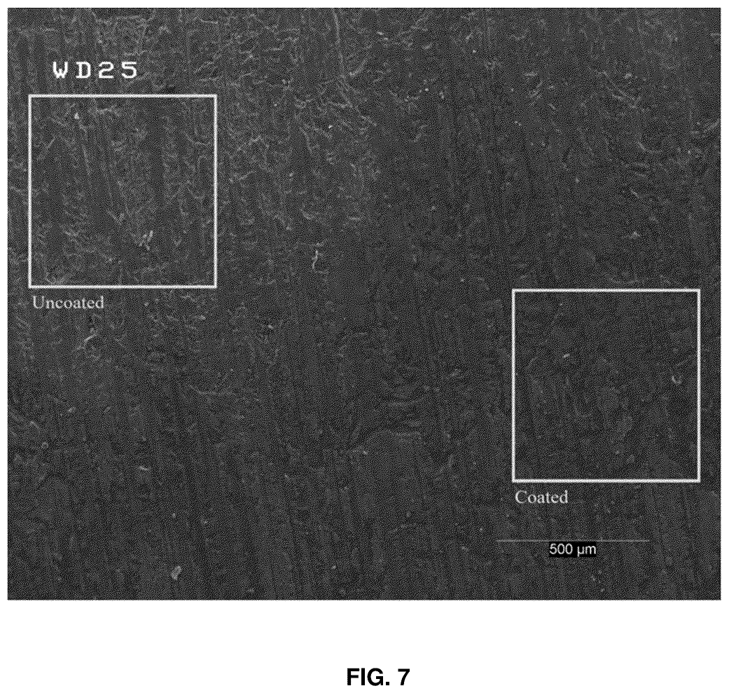

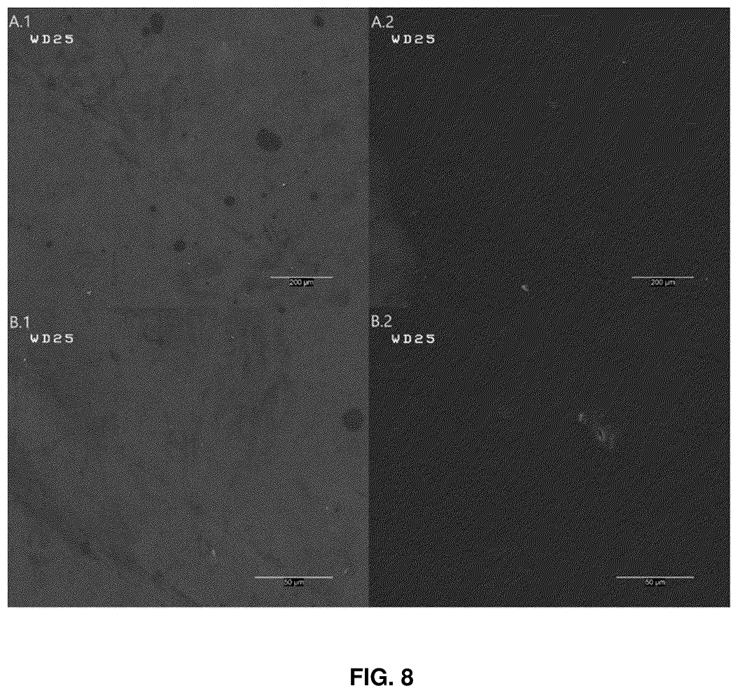

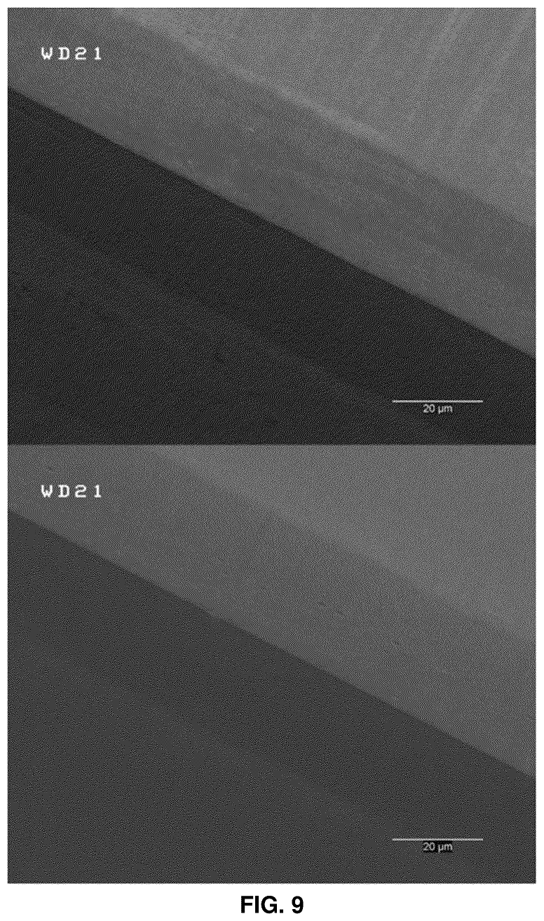

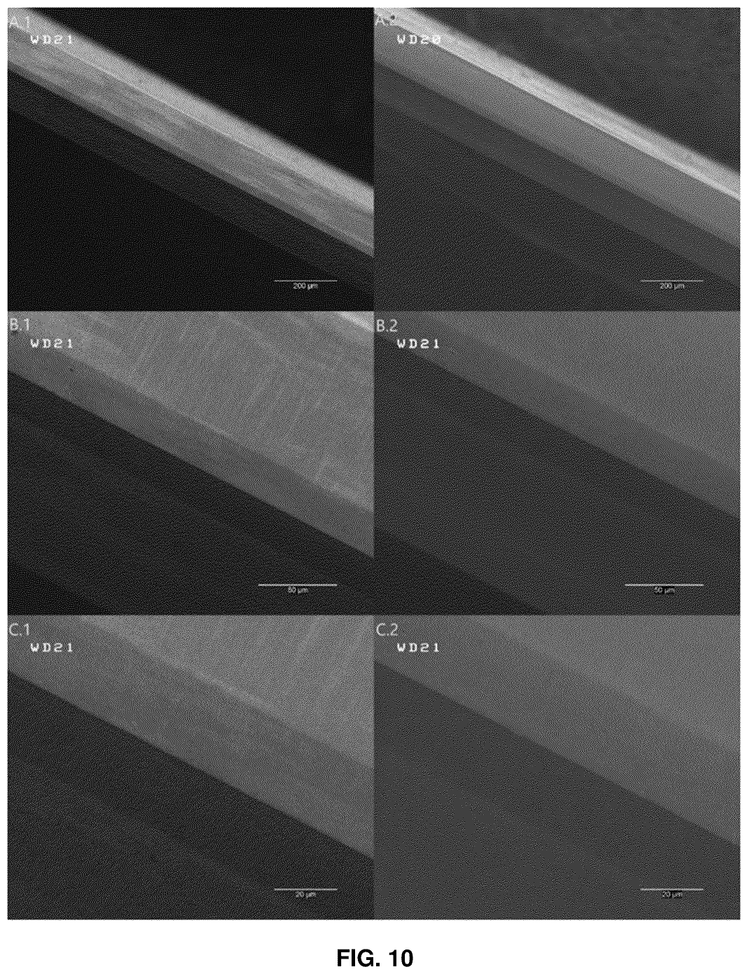

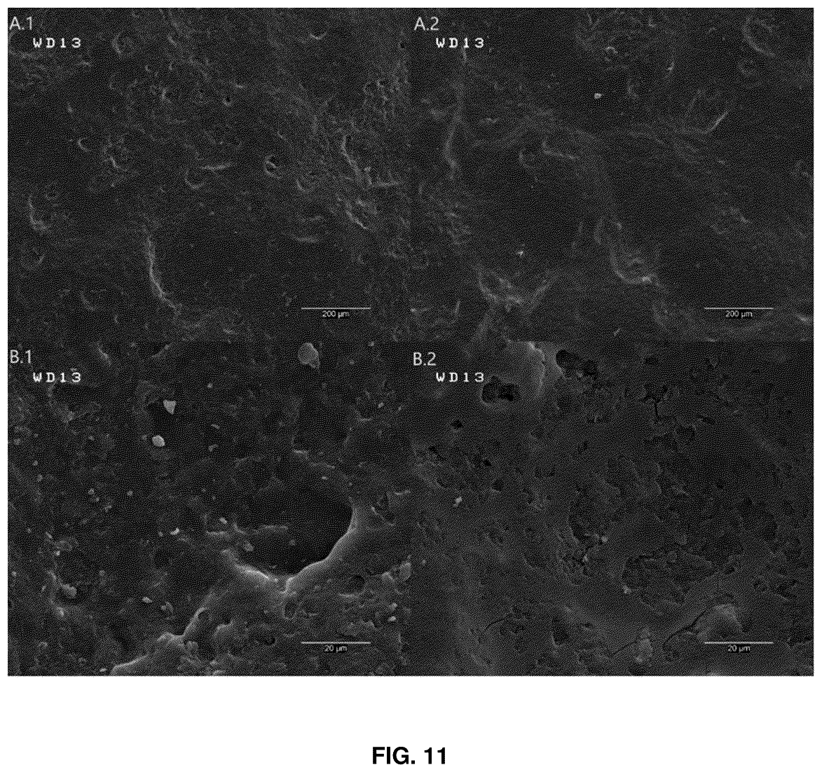

Surface inspection was performed through scanning electron microscope (SEM) images to investigate how the coating adheres to the various substrates. Initial images focused on marble samples coated with example 11. In both the 50× and 300× images, there is a drastic difference in the surface once the solution settled into the defects, giving a much smoother appearance (FIG. 6). Coated regions have a lower resolution since the electron beam interacts with the transparent coating, resulting in a dark, semi-opaque appearance of features which becomes more intense the thicker the coating is. There is evidence of micron-sized protrusions in the 1000×, coated image, indicating a thin, secondary application may be useful to protect the rough stone. The abrasive removal of the top layer of stone using sandpaper is evident through the tracts seen in FIG. 7, and the transition from the raw to the protected surface is easily distinguished. Due to air pockets trapped under the coating, imaging a thicker surface resulted in fissures forming in these areas upon exposure to ultra high vacuum. There are no surface depressions with glass that air could be trapped in, eliminating this issue. Images of the raw glass surface show spotting from oils, while the coated surface has minimal distinctions. A region of the surface which had encased debris and formed a defect was chosen as the remainder of the area was featureless, and both sides are smooth by nature (FIG. 8). The raw glass appears dirtier despite both sides being cleaned with dry air prior to imaging. Stainless steel was inspected using a dip-coated histology razor which includes an ultra-fine edge less than a micron thick (FIG. 9). A slight bevel is visible on the coated surface where the system closely encases the hone, but the overall edge remains well defined. Small indentations are evident in the final magnification; however, there is no evidence of any system defects, and the entirety of the blade edge remains smooth and ready for use (FIG. 10). This indicates that the surfaces investigated in the oxidation experiment (see below) had adequate adhesion from similar application methods, and this system may be used to cover acute angles on different substrates. Lastly, the surface interaction of a nitrile glove and wipe-on coating was investigated. Detailed imaging shows how the coating covers and fills in many depressions on the surface (FIG. 11). At 1,000× magnification, a depression in the surface illustrates how thin plates are formed through this application method. While the entire surface is not covered, this may offer additional protection against chemicals that traditionally penetrate nitrile gloves since the coating exhibited no changes when exposed to some of these reagents as detailed below.

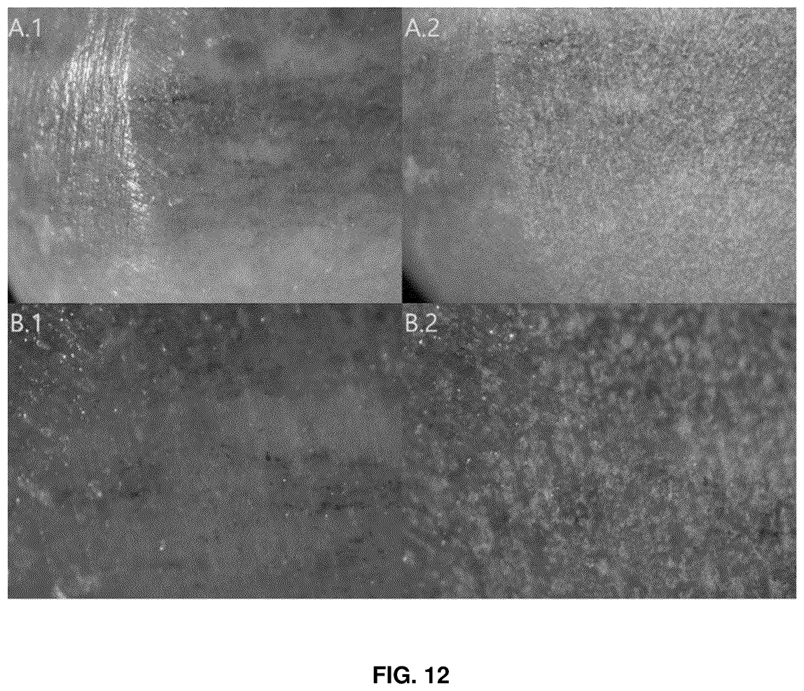

Surface assessment was carried out to investigate the hardness and abrasion of the coating. Pencil hardness tests were conducted with samples on various surfaces (marble, glass, steel), achieving a hardness of 9H on each for every sample assessed, the highest rating with this method. Abrasion resistance was quantified using a combination of sandpaper and sandblasting techniques and measuring the mass lost from each marble sample. Initial testing with small, coated stone pieces (average of 3.5×4 cm) had a maximum mass loss of 3 mg after both smooth (400 grit) and then rough (220 grit) sandpapers. After exposure to both sandpaper trials, two larger samples (average 8.5×10 cm) exhibited a total mass loss of 4 mg and 7 mg. Overall, with a direct abrasive force, the change in surfaces may be considered minimal (207.768 g to 207.764 g for example 8 and 197.445 g to 197.438 g for example 9). Marring on these stone samples was observable with these sandpaper grits with a microscope but not the naked eye. Next, the same samples were sandblasted for thirty seconds, and they lost 15 mg and 5 mg, respectively, and damage was visibly evident (FIG. 12). This was reinforced by a loss in surface hydrophobicity in the second sample, example 9, which dropped from 101.5° to 80.3° after sandblasting, indicating a significant loss of coating (FIG. 13). This indicates that while the coating system is rigid and provides some resistance to minor abrasion, it may not be ideal for protecting surfaces in dry, ultra-sandy environments that undergo extreme sandstorms.

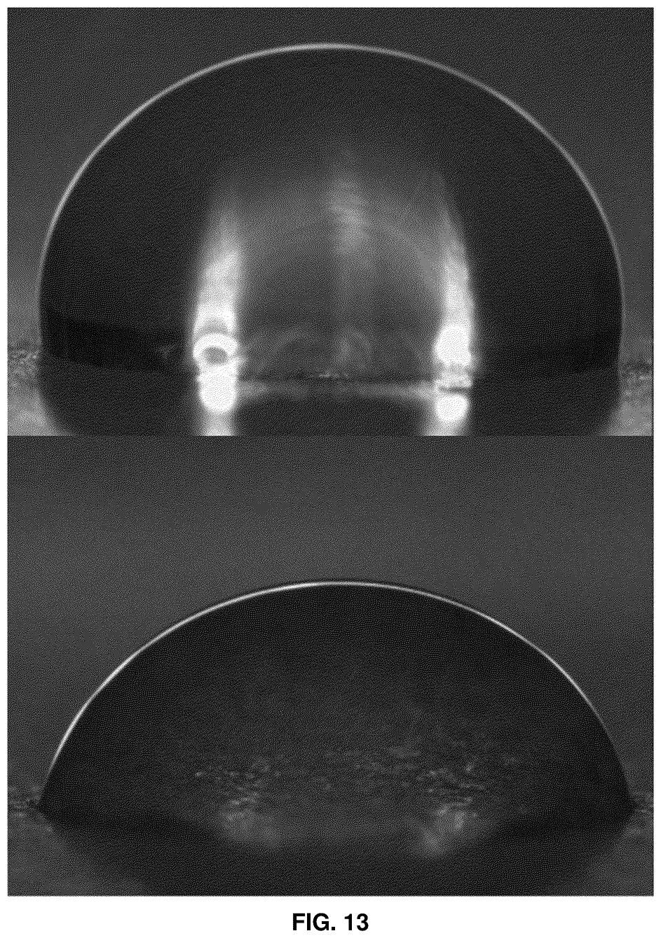

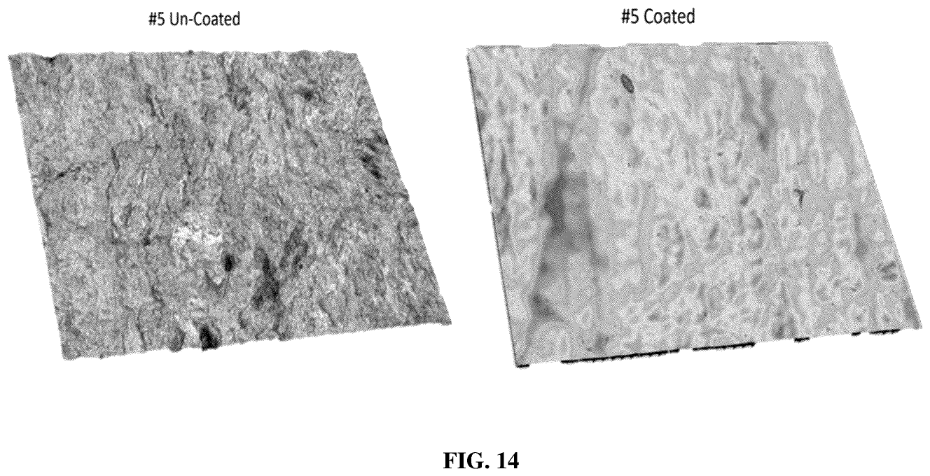

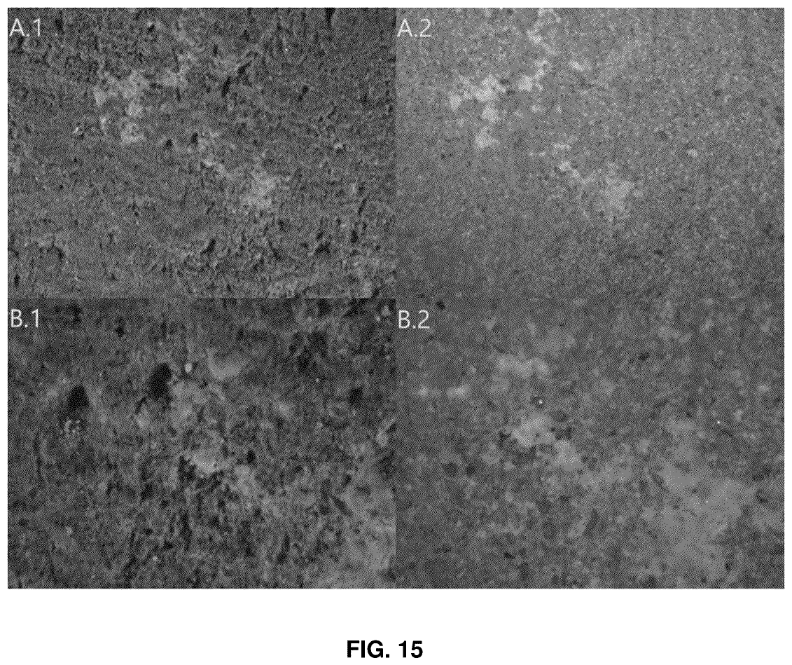

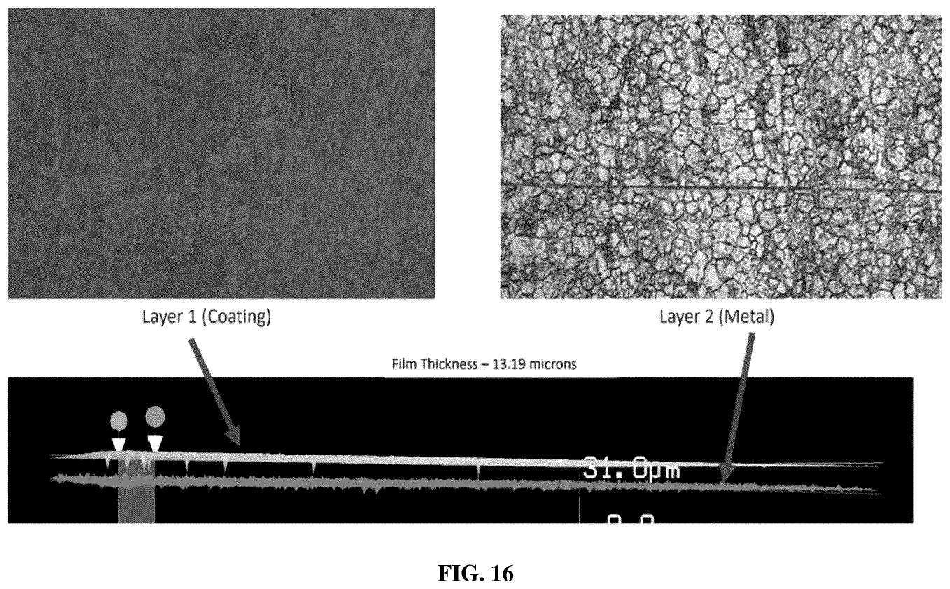

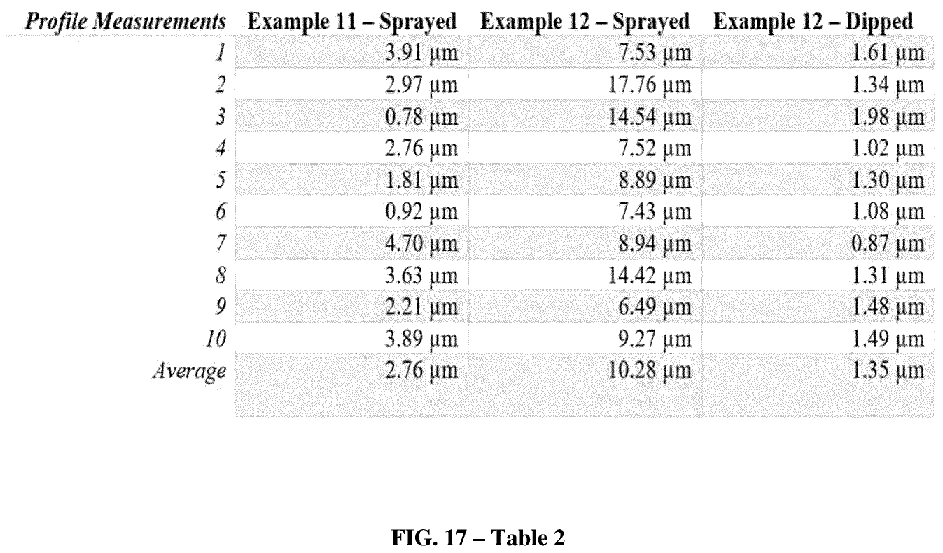

Coating thickness was analyzed for sprayed and dipped samples. An initial investigation of surface topography and coating thickness was carried out with a Keyence 3D laser confocal microscope and example 1 applied to stone and steel samples. Topography mapping of the uncoated and coated sides of a single stone specimen shows a more subtle and consistent surface across the region, which indicates settling of the coating within the depressions of the surface (FIG. 14). Coating deposition on a brick surface supports this, as the solution appears to coat the surface, fill in many defects, and get absorbed into the substrate (FIG. 15). Film thickness was also assessed on an optical profilometer using stainless steel, and measuring the distance between the upper and lower scanned surfaces, giving an estimated thickness measurement of 0.013 mm (FIG. 16). Next, ten measurements were taken for examples 11 and 12 applied to glass slides and used to calculate the average thickness (FIG. 17, Table 2). Sprayed samples had an average thickness of 2.76 μm (example 11) and 10.28 μm (example 12) while the dip-coated sample had a thickness of 1.35 μm (example 12), indicating that this is the ideal application method for a thinner coating. When applied on stone or glass surfaces in the intended manner, the resulting coating will have a thickness resemblant of the second analysis due to the surface differences.

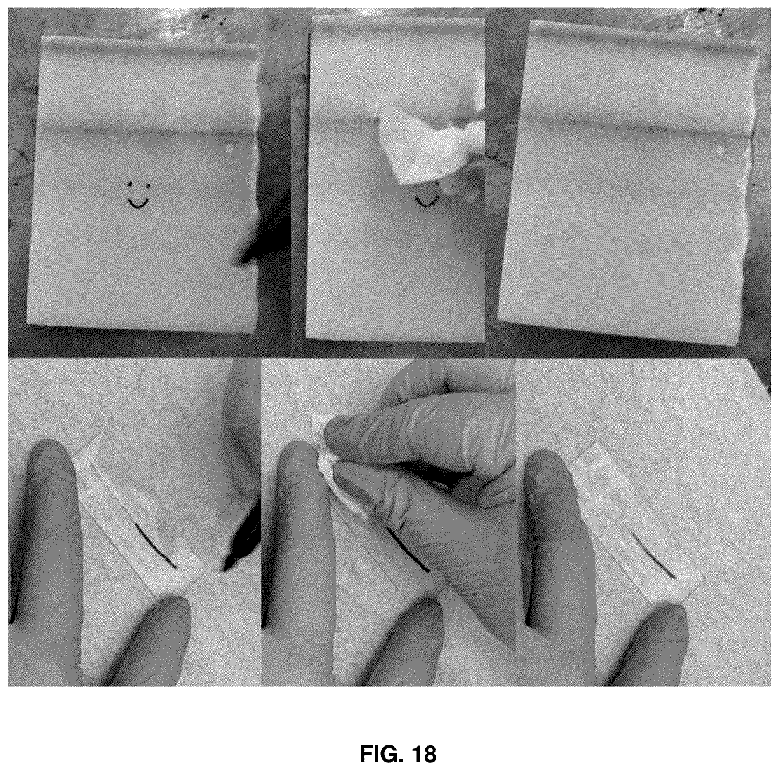

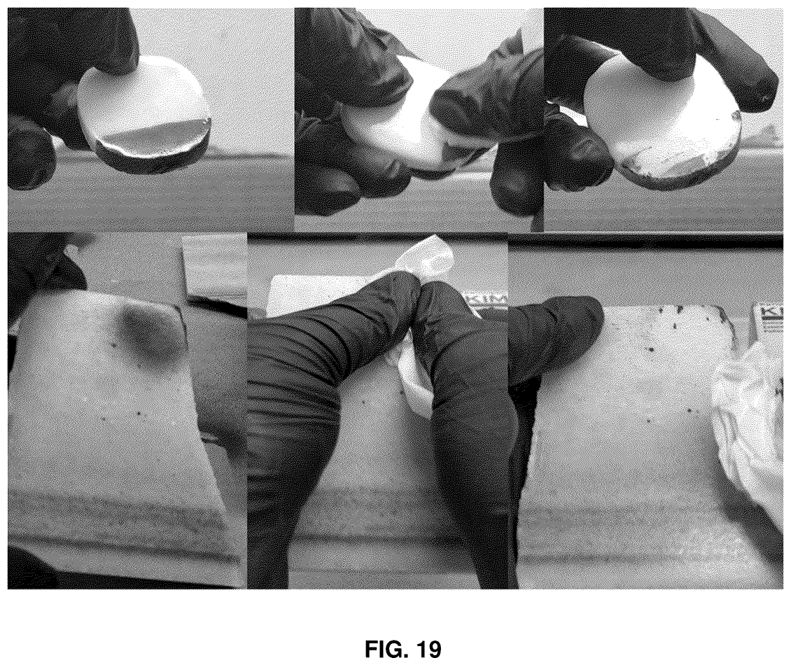

Interactions with water and other solutions were investigated through various methods. Coating stability was investigated through submersion tests detailed in the methods. Starting with example 4, the systems showed no changes in the surface when submerged in water, synthetic acid rain, and a sodium hydroxide solution. Prior to this, delamination was observed with water exposure. Chemical resistance was observed in examples 8-12 when pieces of cured coating were exposed to small amounts of tetrahydrofuran, hexanes, dichloromethane, ethanol, isopropanol, 0.1 M nitric acid, 0.1 M sodium hydroxide, and acetone with no change in sample size, shape, color, or condition. This coating stability also ensures graffiti resistance/removal ease to the finished surface. Both Sharpie permanent marker and Rust-o-leum outdoor paint can be removed from coated surfaces using a dry Kim-wipe (or tissue paper) and light force, leaving the coated surface unscathed (FIGS. 18-19). This has a wide range of implications and is highly beneficial for coatings on surfaces that are targets of vandalism.

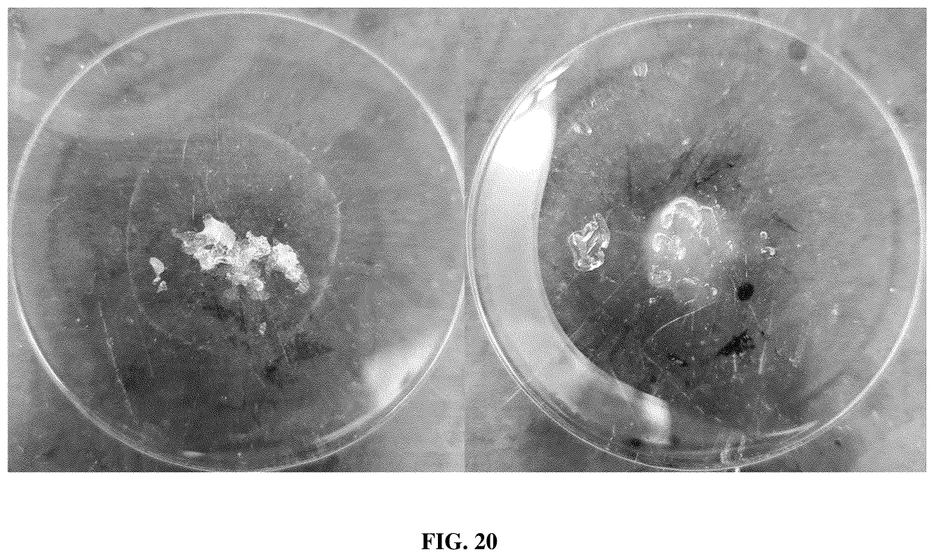

Recyclability and recoat-ability were investigated to see if the system can be recovered, reused, or reinforced. When exposed to a siloxane depolymerization solution containing a source of fluoride as described in international patent application PCT/US2022/014500 (incorporated herein by reference) for four weeks, partial removal of the coating was observed in a sample of example 10, but the solid was still partially intact, likely due to the thiol-ene and epoxy/amine cross-linking (FIG. 20). This technique breaks down siloxane chains and forms cyclic monomers which can be reused, offering a second purpose for any siloxanes after their initial use. While incomplete, the partial degradation enables improvement in recoating by reopening siloxane bonds for improved adhesion of the next layer.

Initial recoating tests were performed within two days of curing using a spray method and resulted in a self-repellence of the two layers, and while the second coat delaminated, the first layer remained unchanged (due to full curing and fluorocarbon interactions). Follow up testing utilized samples over a month old, from both outside and inside environmental exposures. In both instances, the second layer was successful in adhesion, but minor delamination was evident in some samples which had a thicker 2^{nd} application, however the majority of the second layer remained intact. This demonstrates the system's recoat ability but indicates the advantage of a longer time lapse between applications to ensure the complete reactivity of the initial layer or using the aforementioned chemical breakdown of the first application. Additional testing has shown that a second coat can be applied to a non-fluorinated base coat after 48 hours. When the base coat contains a fluorocarbon, one month may be important between applications. Any combinations of formulas can be used for applying multiple layers. A non-fluorinated base coat can be coated over once the cure is completed, can have a second coat applied over the top of it after 48 hours (and over fluorinated formulas after a month). Furthermore, a combination of coating formulas can be used when recoating.

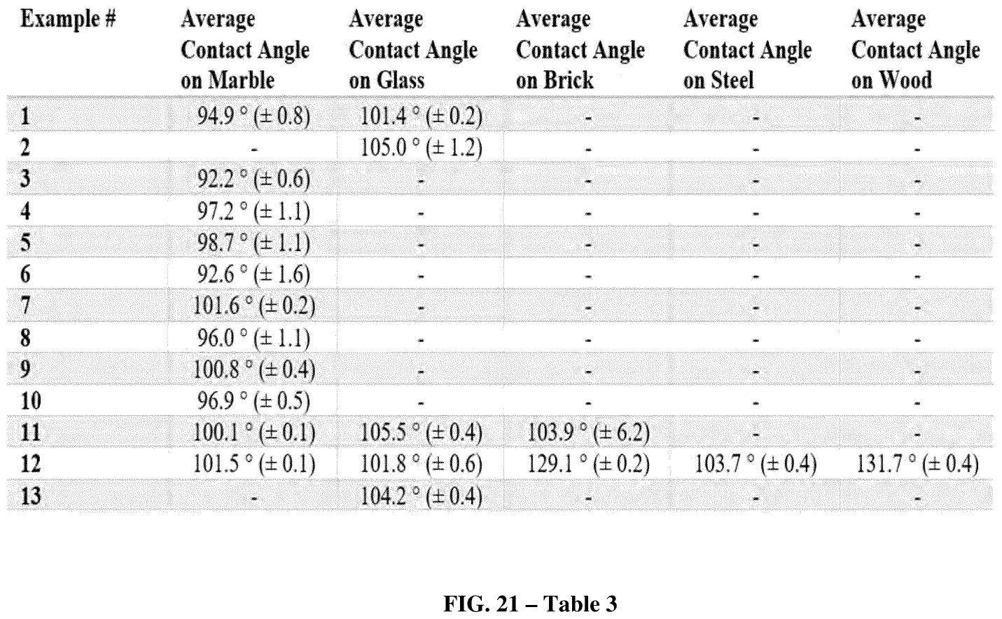

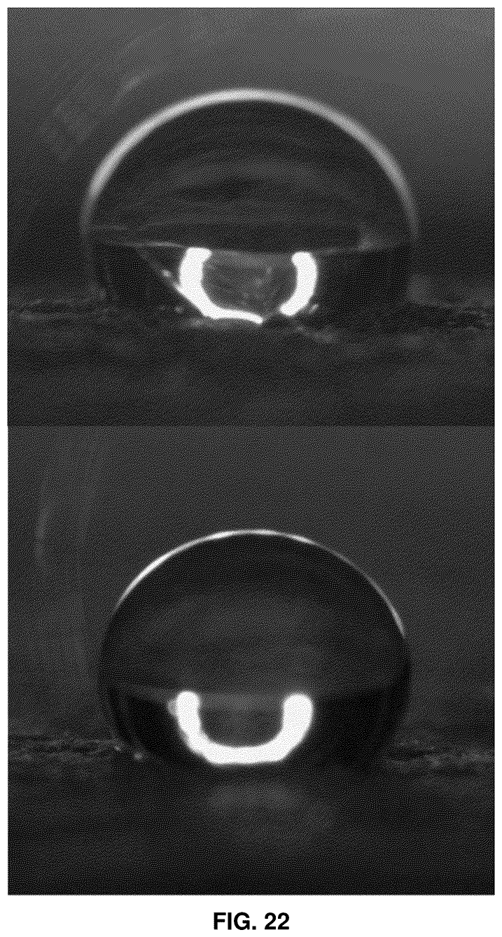

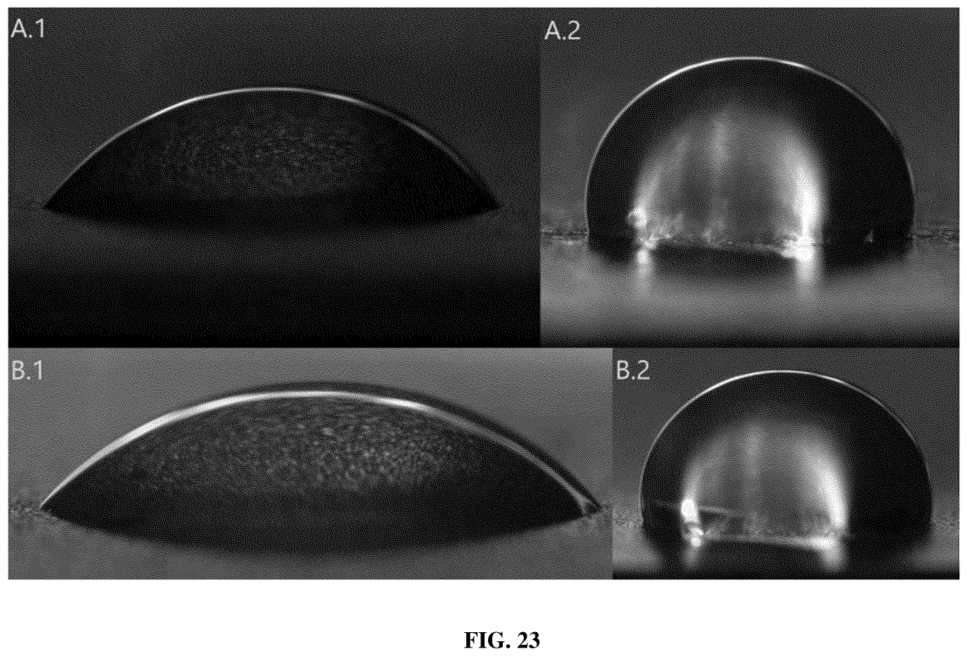

Hydrophobicity was important to this system's design and was assessed through static contact angle measurements in addition to the submersion tests above. As mentioned, the implementation of fluorocarbons increased the overall hydrophobicity observed and was integrated into this variation for this reason. The range of static contact angles observed in examples 1-13 of this lineage is shown in Table 3 (FIG. 21). All coated marble samples of this system variation, not just those shown, had a range between 85.0° and 103.4°, with many ideal samples measuring between 96° and 101°. When applied to glass slides for a smooth and consistent surface, a maximum contact angle of 105.5° and a minimum of 95.6° were found with this lineage consistently measuring over 100°. Examples 8-12 were tested on several different substrates to ascertain their effectiveness on other materials. Nitrile gloves were investigated to see if additional hydrophobicity could be imparted. Solutions were wiped onto the surface, and once hardened, the surface was pulled taut. Contact angles were estimated due to the elastic nature of the substrate, where the raw surface was ˜88.1°, and the coated samples were around 88.8° to 93.4°. While the difference in contact angles was not astounding, water droplets ran off the surface easier than the uncoated glove, which indicates this system can be used on vinyl surfaces. Brick and steel were investigated as they are used in building construction and have similar environmental erosion issues like stone. Since bricks are porous, contact angles were taken before, post-cure, and several days after. The non-coated surface completely absorbs water droplets within 30 seconds. For the first brick, two days post-cure, it exhibited a contact angle of 103.9° after 10 minutes had elapsed from deposition, and at 39 days, it measured at 94.4°. A second brick was coated and inspected four days post-cure, where the contact angle was measured after 10 minutes had elapsed from deposition and achieved 129.1°, an extremely high angle compared to our other substrates (FIG. 22). A wood sample was also tested in this manner, where the uncoated sample absorbed the water droplet within 30 seconds, and the dip coated sample, three days post cure, exhibited a static contact angle of 131.7° after 10 minutes had elapsed. Stainless steel also showed drastic differences in hydrophobicity once it was dip-coated. The uncoated samples had initial contact angles of 58.8° (A.1) and 53.5° (B.1) on the raw surface, but once coated, measured at 103.7° (A.2) and 103.5° (B.2), respectively (FIG. 23). This indicated that the coating was highly effective at increasing the hydrophobicity of steel surfaces and may add oxidative resistance.

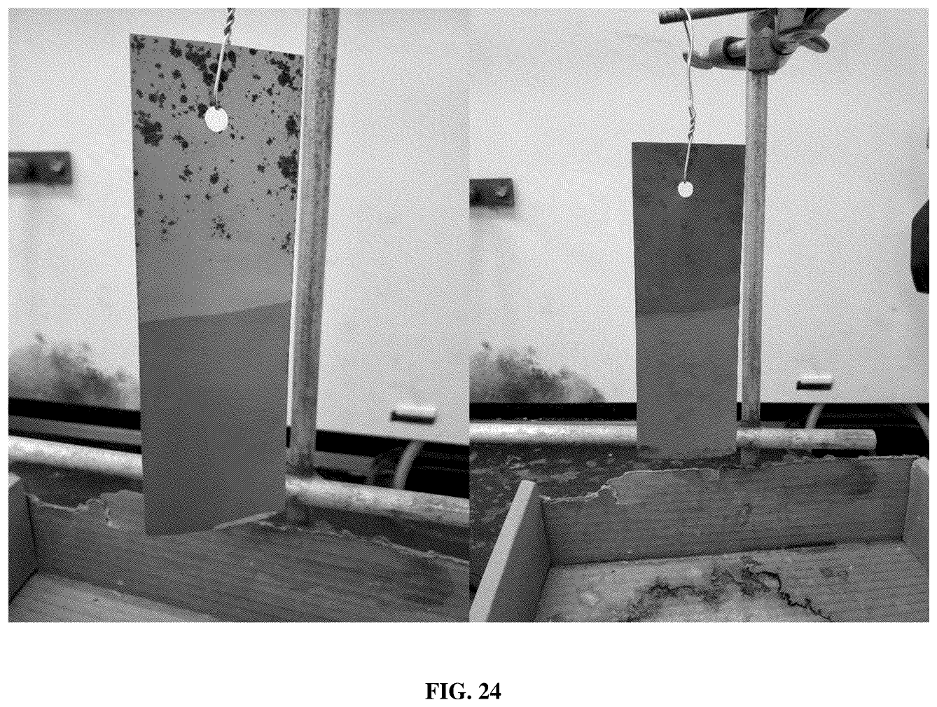

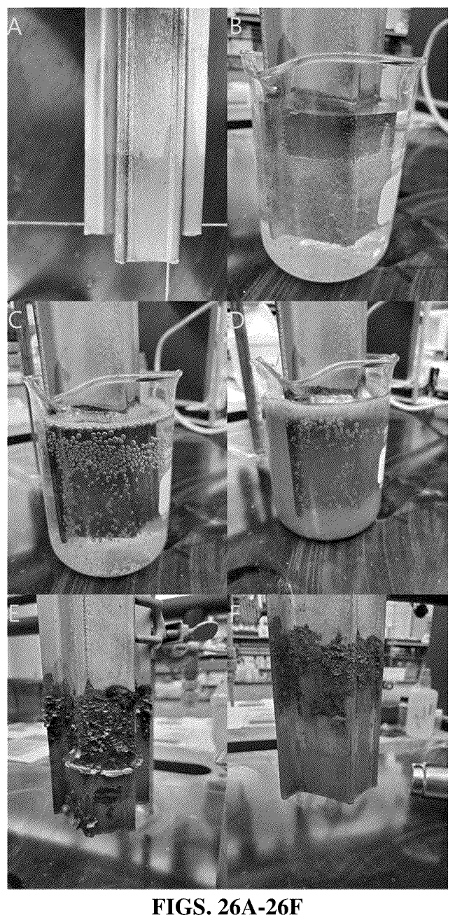

Stainless steel samples were put through oxidative stress using a rusting solution. After dip coating, samples were sprayed and submerged according to the methods, and both raw and coated surfaces were observed. When sprayed, the solution quickly rusted the raw surface while the coated surface was adequately protected; this is seen in FIG. 24, where the top half of the sample was left raw and showed the differences in the effect. This indicates that the coating system adequately prevents oxidation when exposed periodically (FIG. 25A). In comparison, a similar sample was left suspended approximately 6 feet in elevation and exposed to ambient conditions in a laboratory to show the less severe example of long-term oxidative stress. FIG. 25B shows the gradual oxidation of the unprotected portion of the sample after 200 days of exposure. A second rusting test was conducted by submerging a stainless-steel post which was dip-coated directly into the rusting solution (FIGS. 26A-26F). FIG. 26B shows the formation of bubbles on the coating surface, but not the raw material. Once 14 days had passed, significant oxidation had occurred on the uncoated surface, but the coated section only had minor rusting and discoloration, indicating the process had been slowed (FIG. 26F).

Water staining hinders surfaces, leading to discoloration and calcification over time. Resistance to ion adhesion was tested by partially coating glass slides and using a concentrated synthetic hard water solution. Rapid heating resulted in the formation of hard residue, and a Kimwipe was used to attempt the removal of it. Using the same force, the calcification easily wipes off the coated surface, breaking apart, yet remains adhered to the raw surface. The resulting build-up was soft when the same experiment was conducted but dried through slow heating. A Kimwipe was used to remove the spots on the uncoated side and coated side. While the build-up was quickly removed, there was smudging on both sides, which was readily wiped off the coating and remained on the glass. These results indicate that this coating system offers resistance to calcification and helps prevent hard water build-up.

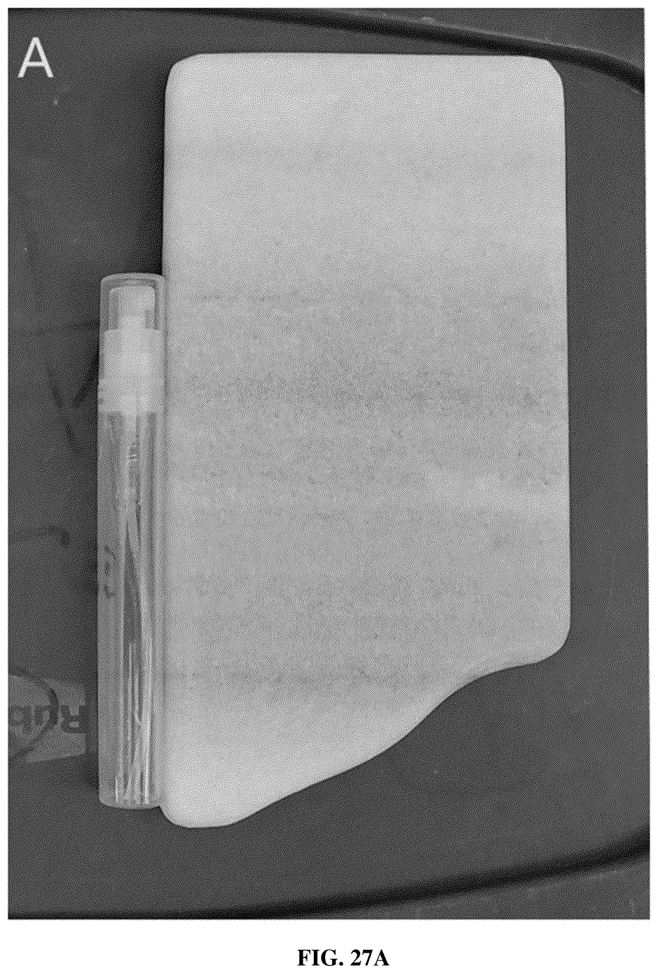

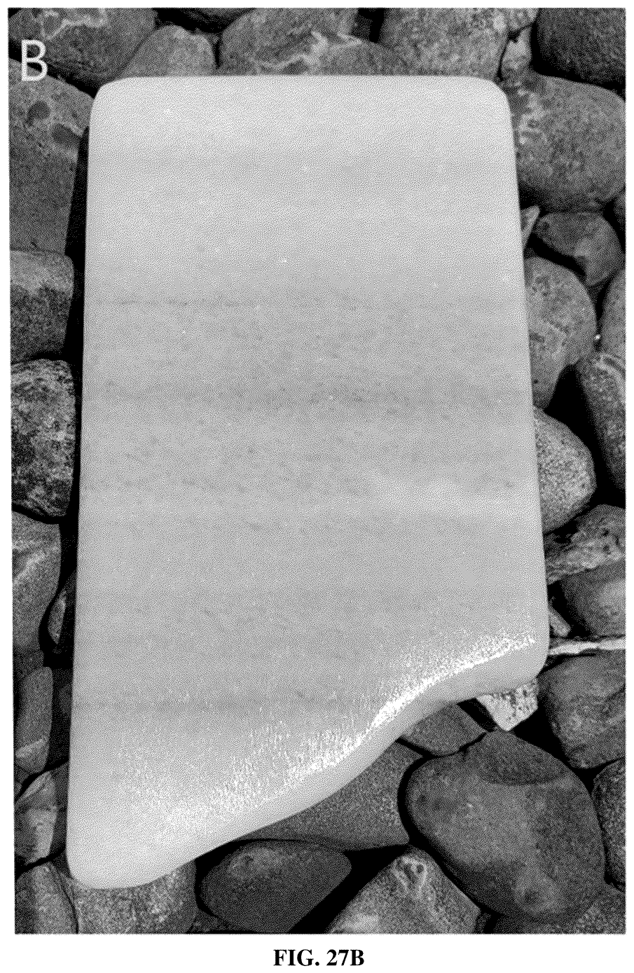

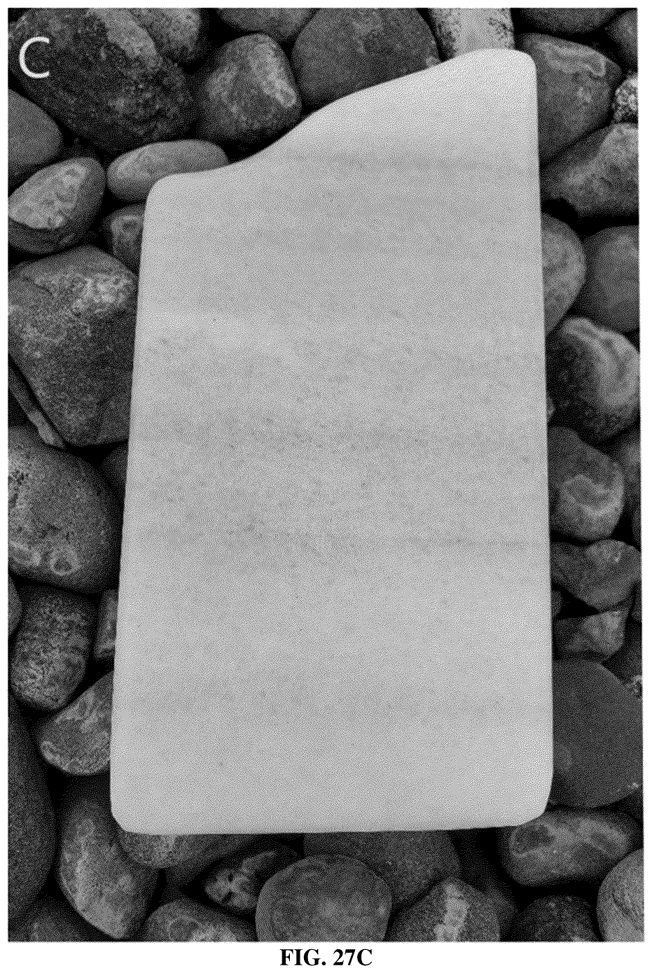

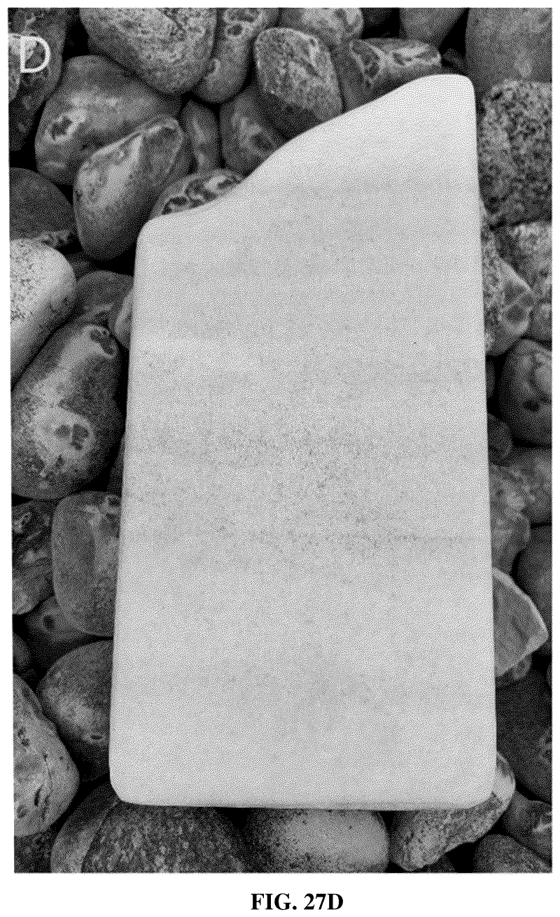

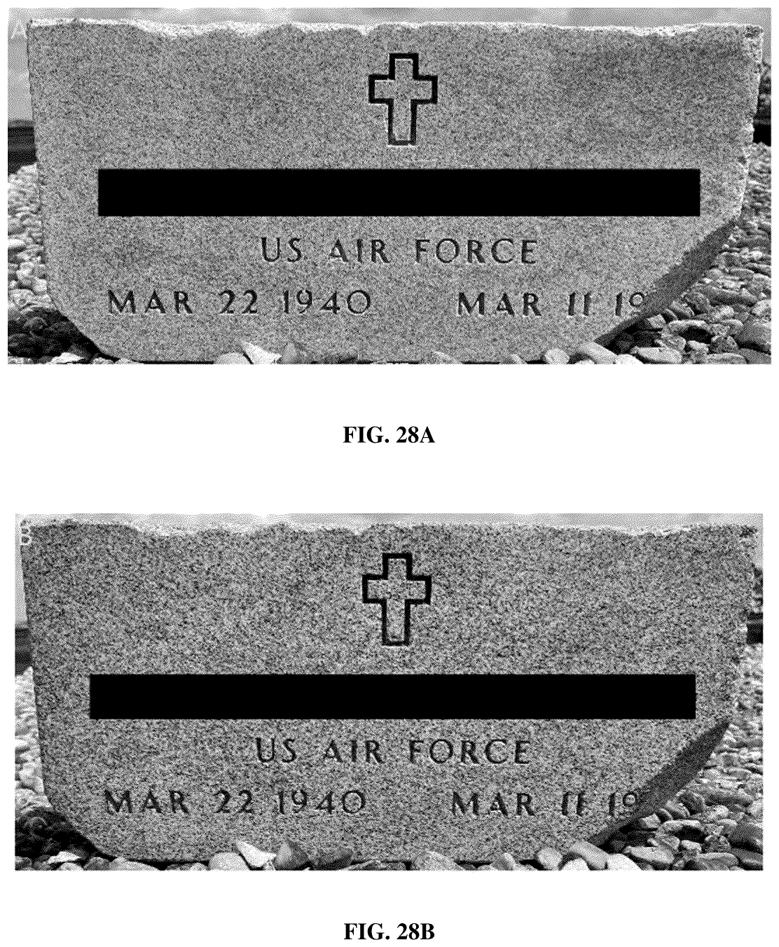

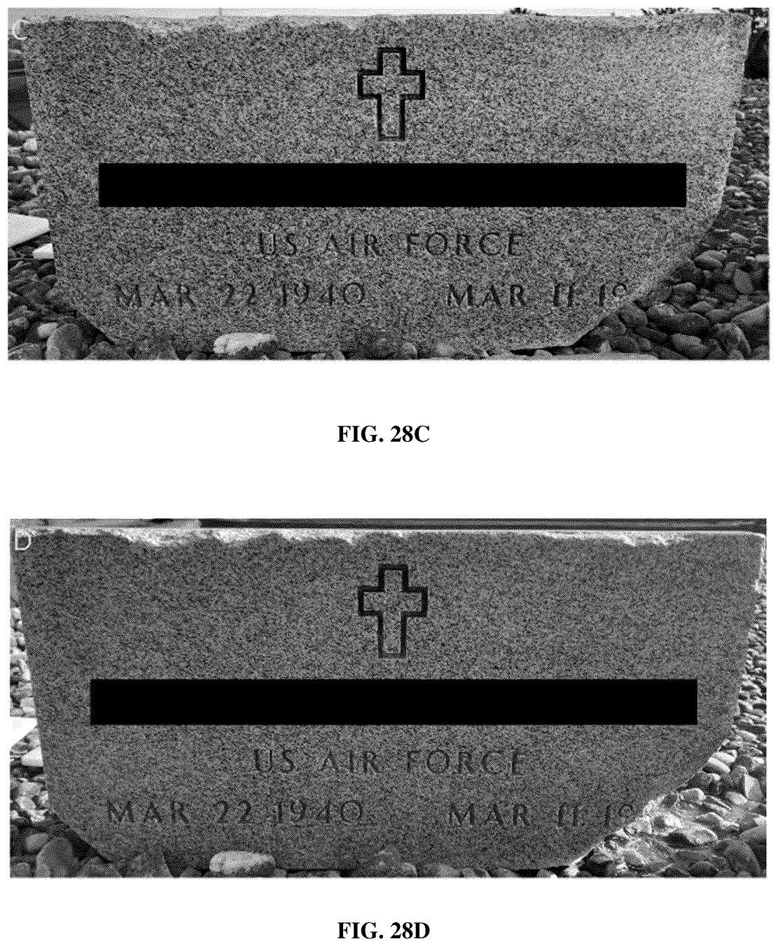

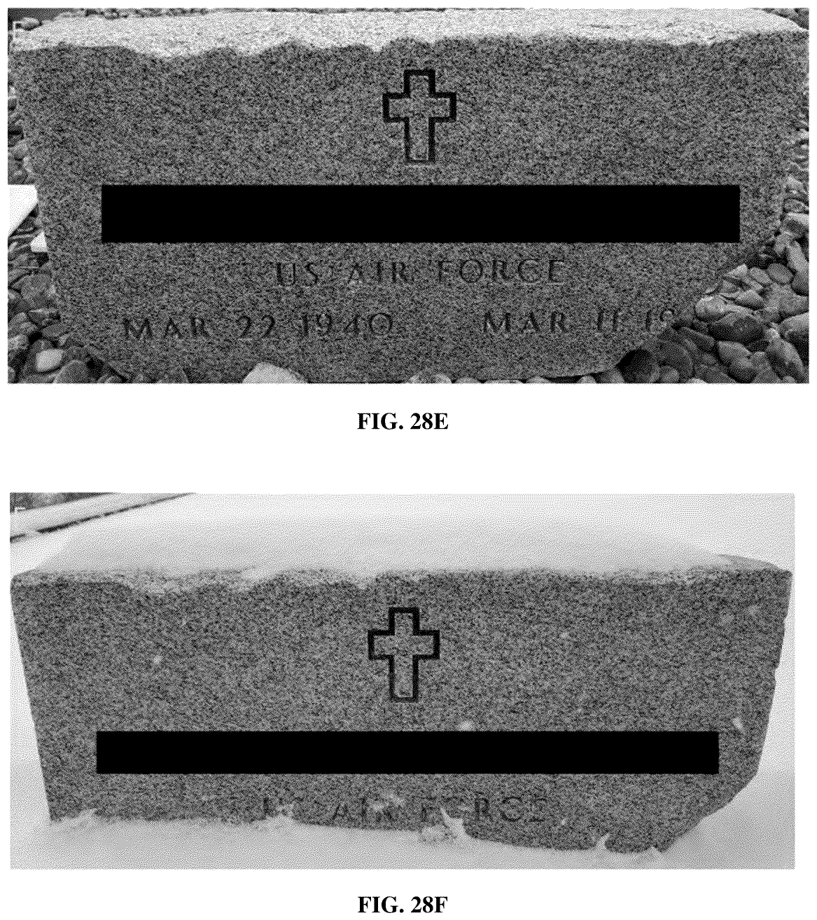

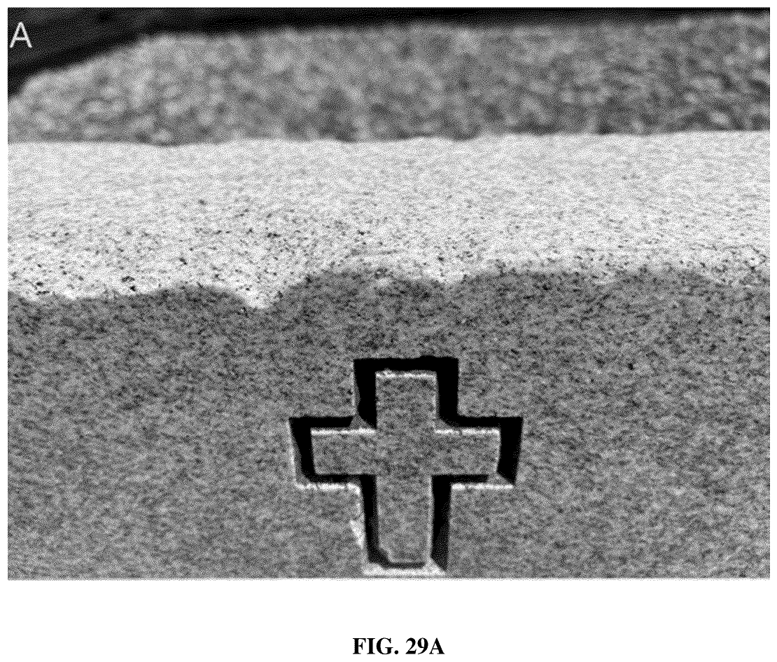

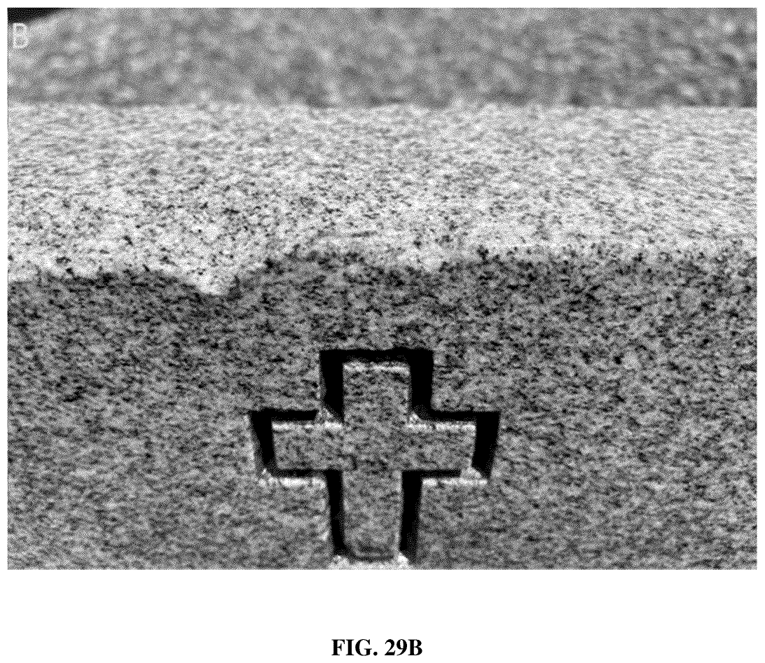

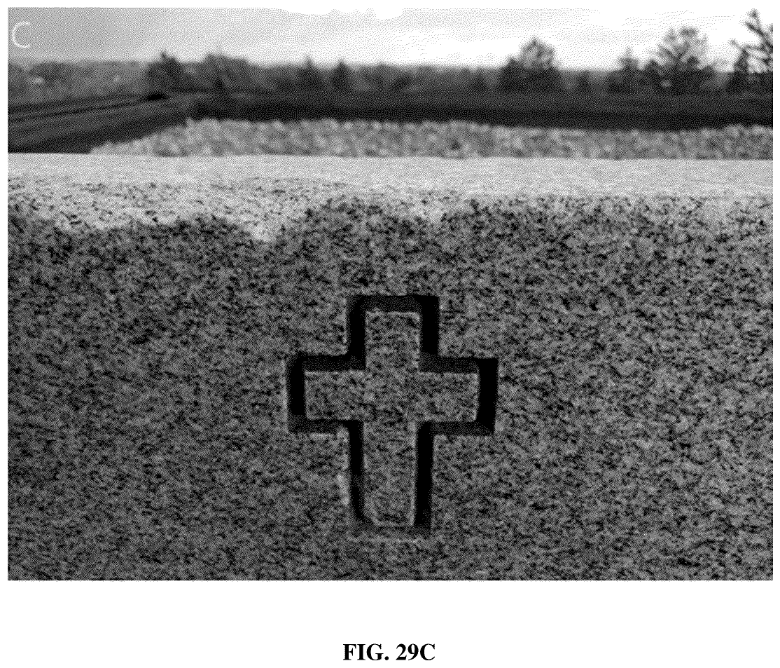

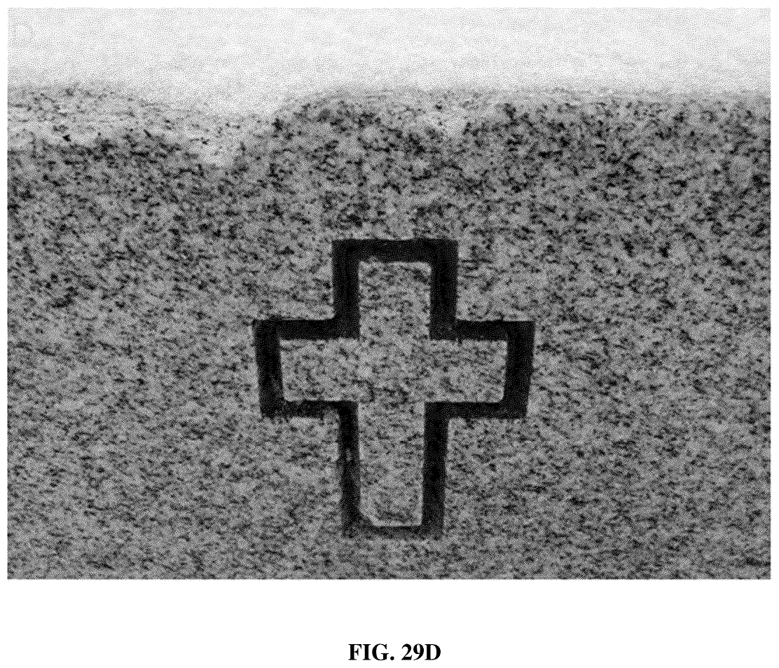

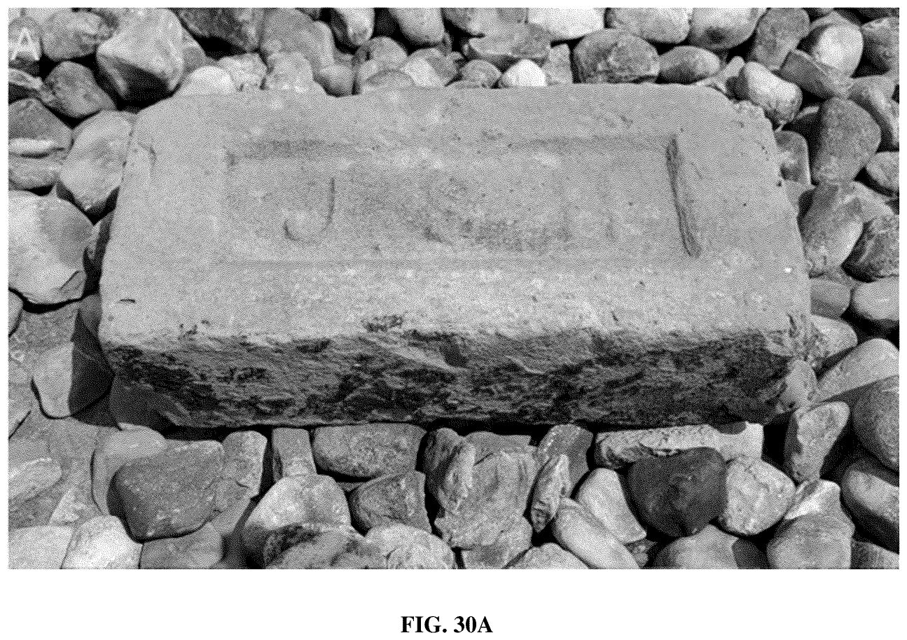

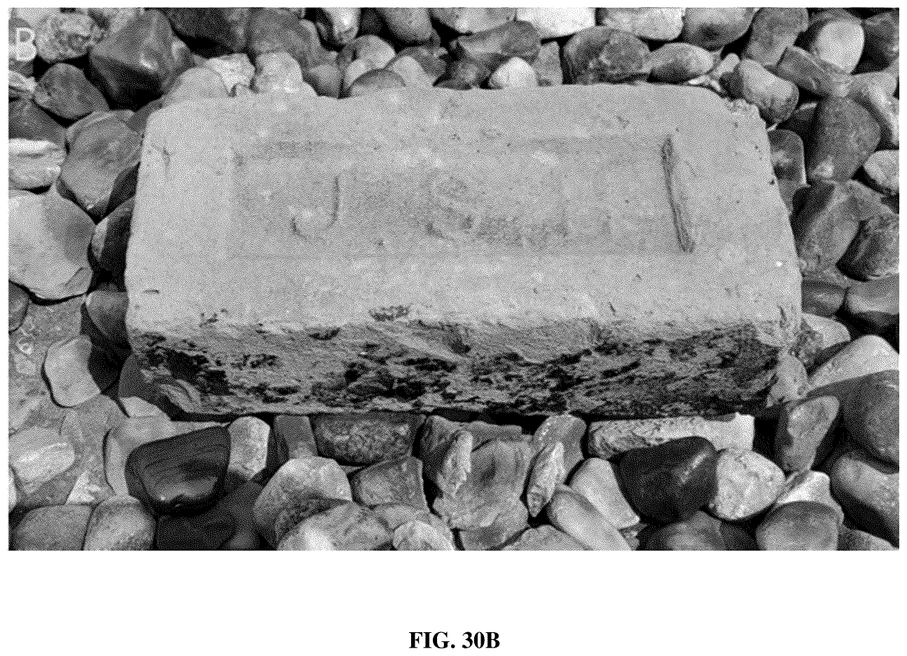

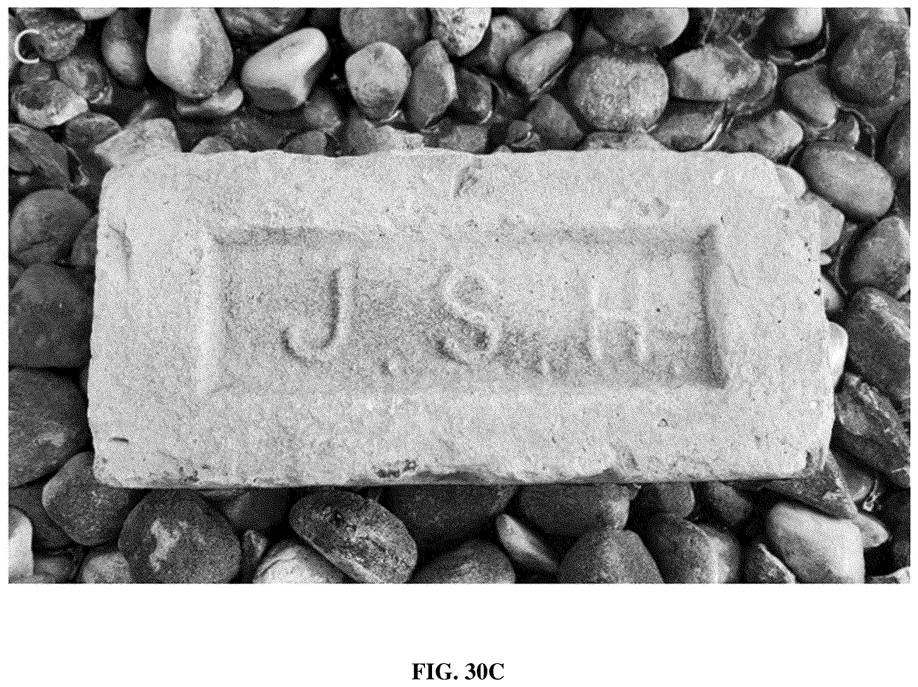

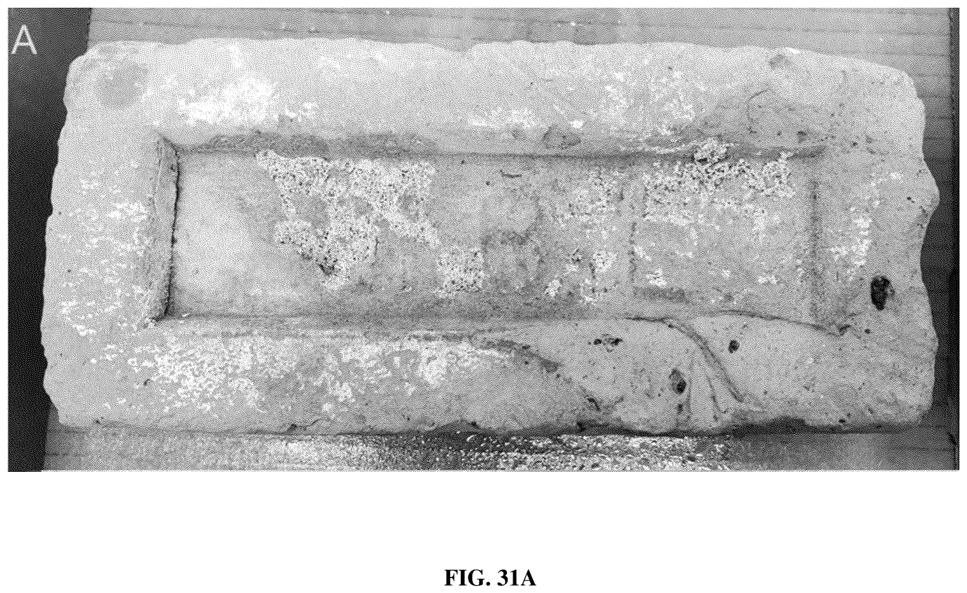

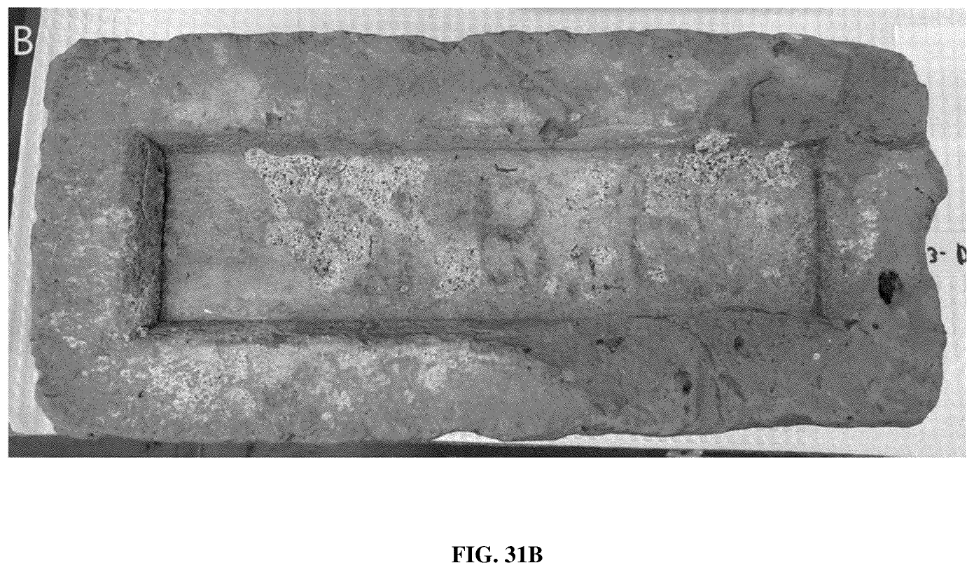

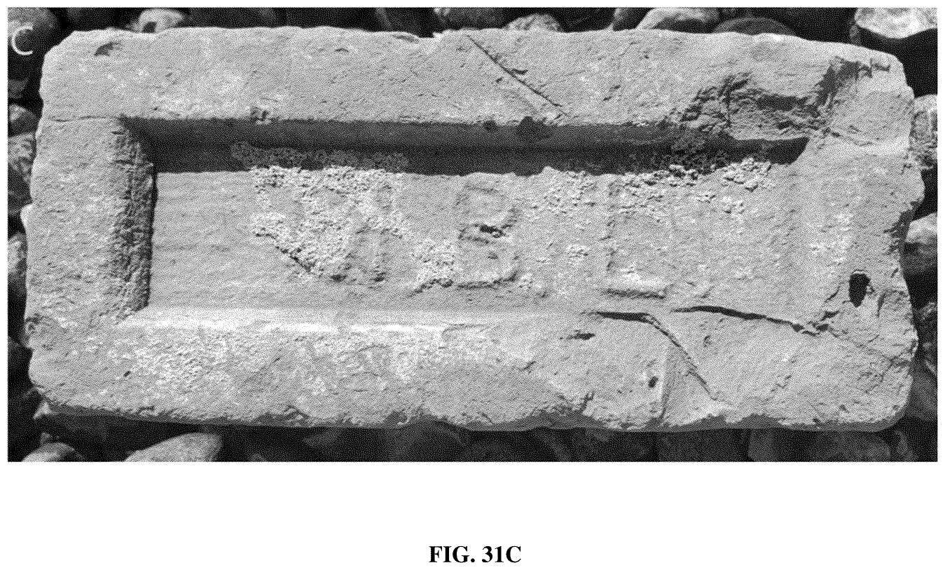

Environmental stability was the final set of physical characterization investigated. Initial testing was performed indoors to test general thermal stability when exposed to varying circumstances. For both methods, exposure to high and low temperatures had no noticeable effect on surface appearance, survivability in submersion tests, and a negligible effect on post-exposure contact angles (±3°). As previously mentioned, submersion tests were also conducted using a synthetic acid rain solution with a pH of 4.3 to mimic outdoor weather phenomena, and there was no effect on the system. Long-term stability tests were conducted on a flat rooftop, providing a secure outdoor environment with limited access to reduce the artificial influence. Daily weather and atmospheric conditions were recorded since the start of these tests, and samples were inspected periodically to ensure continued success and note any unusual events which may affect testing. To gauge the optimal conditions for coating applications, the UV index was recorded and monitored. This approximates the UV exposure a particular area is forecast to receive [(mW/m²/s)/25 mW]. Samples were applied during the summer, and early fall with a UV index exceeding 7.2 (˜180 mW/m²/s), which is less power than the 200 W UVA lamp used indoors which measures 18.7 mW/cm²/s at the distance used. When coated during peak exposure times at a UV index exceeding 7.2 and a temperature over 21° C., the sample surface was non-impressionable within 30 minutes of application as intended. The longest-lived sample was in place for 252 days and counting and used a diluted variation of example 8 (FIGS. 27A-27D). Until close to 250 days, it had shown no change to the surface, but as seen in FIG. 27D, it had lost the glossy appearance it had; however, the coating was still intact and noticeable by touch due to its leathery texture. For upscaling, a tombstone was cleaned and sanded to remove any existing protective surfaces and then coated using a pressure pump sprayer which yielded a slightly thicker but even finish. This monument has been in field testing for over 300 days and has experienced various environmental conditions with no notable surface status changes. This may be attributed to the hydrophobicity of the surface, with smaller-scale samples applied in the same manner exhibiting a contact angle of 100.1° on stone and 105.5° on glass (Table 3, FIG. 21—example 11). Before application, the headstone had a dull gray appearance (FIG. 27A), and after application, the colors of the stone became more vivid (FIG. 27B), as seen in FIGS. 28A-28F. This change in appearance, accompanied by a glossy sheen and leathery texture, has continued to indicate the presence and longevity of this coating. A closer look at the edge and etching details emphasizes the difference between the uncoated and protected surfaces (FIGS. 29A-29D). A similar initial enhancement of the surface color is also seen in the two brick samples, but this appears to have dulled over time under exterior conditions yielding a paler color than the original substrate as is common with brick materials (FIGS. 30A-30C, 31A-31C).

### Conclusions

The successful synthesis of the tri-cure hybrid organic silicone coating system, which utilizes three orthogonal cross-linking processes, was achieved. An example formulation, which was designed for outdoor use on stone substrates, has been applied to various material surfaces, and the material characteristics of the resulting layer have been investigated. Analysis shows the coatings exhibit hydrophobicity through consistent contact angle measurements around 100°. Additionally, the coating offers a hard surface that is photo and thermal stable. The unique ability to resist and repel permanent marker and spray paint offers additional end-use possibilities and provides a low-cost method for maintaining surfaces often targeted for vandalism. Applicability extends beyond flat surfaces with the successful coating of glass cylinders and tubes as well as metal blades and hand tools, all of which retained the characteristics detailed above. Ideal application parameters have been established as follows, with the understanding that these parameters, while helpful, are not strictly necessary. When applied to surfaces outdoors, the system should be exposed to sunlight when the UV index exceeds 7 and the temperature is higher than 21° C. To ensure a complete cure, usage should be limited to days with no precipitation forecast. An indoor application should utilize a UVA lamp with 200 Watts of power and the system should be exposed to the lamp for 2 minutes after application. When dip-coated, the lowest edge of the item should have excess solution removed. The solution should be stored in an airtight amber bottle in a cool, dark location. The system will form a non-impressionable surface within thirty minutes of initial UV exposure and can be stored as a one-pot solution for over 1 year with repeated usability. However, it is understood that the coating can still be formed and cured and provide advantageous properties in conditions that are less than the ideal conditions described herein.

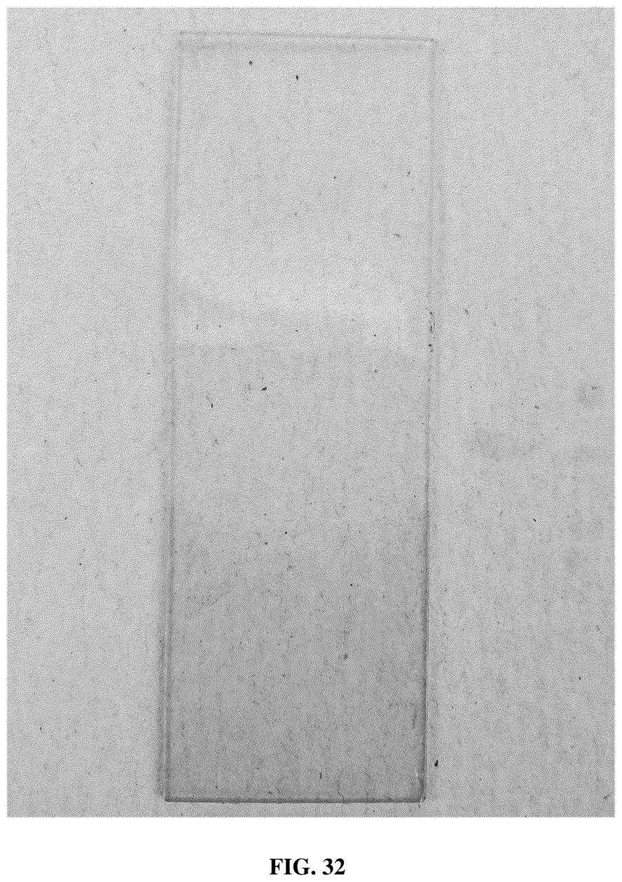

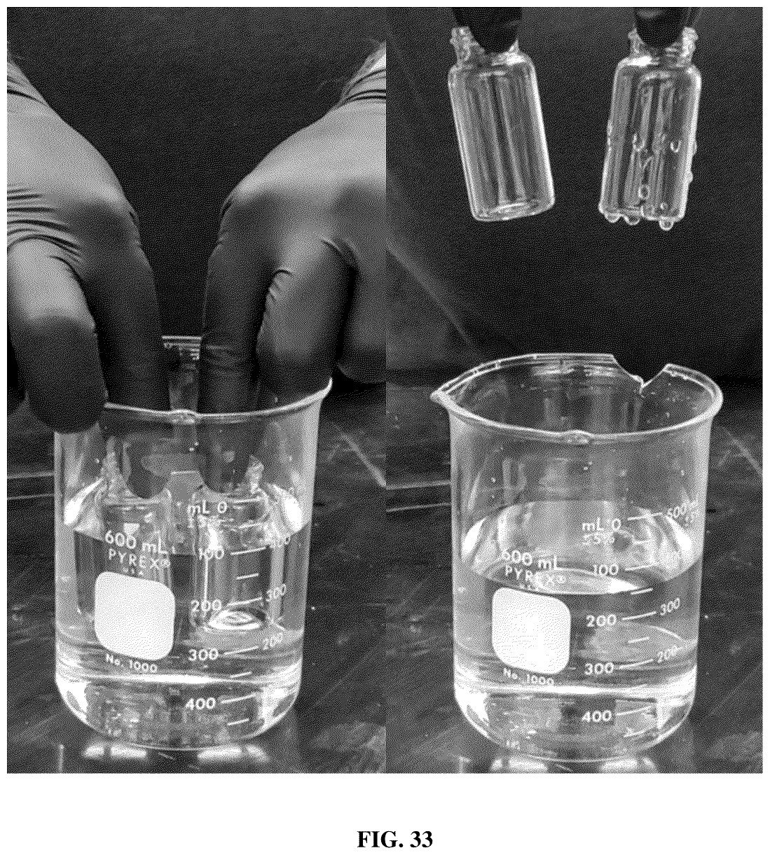

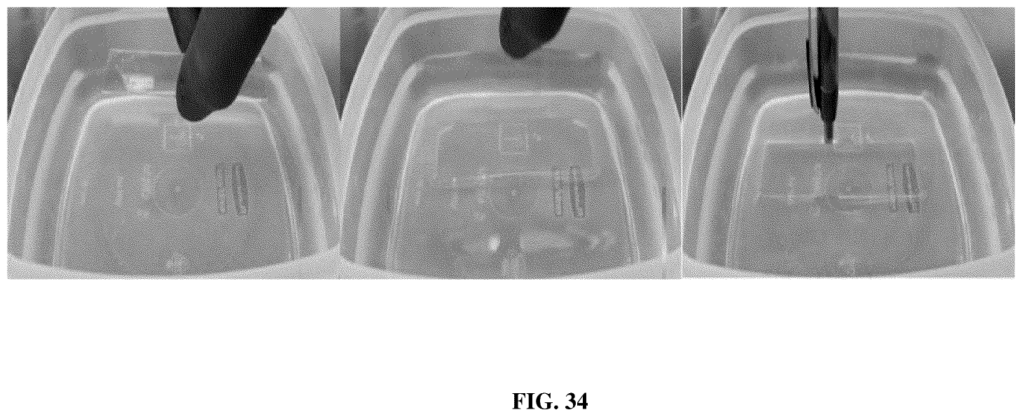

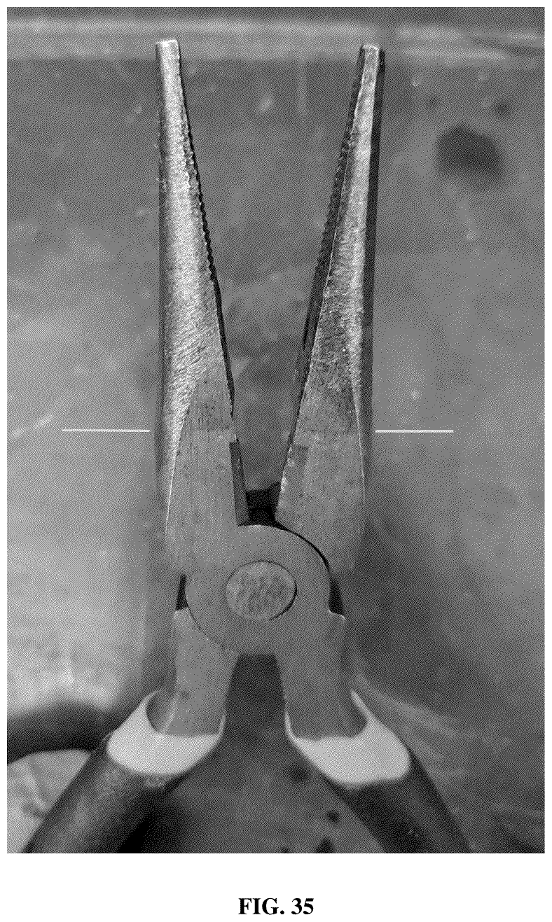

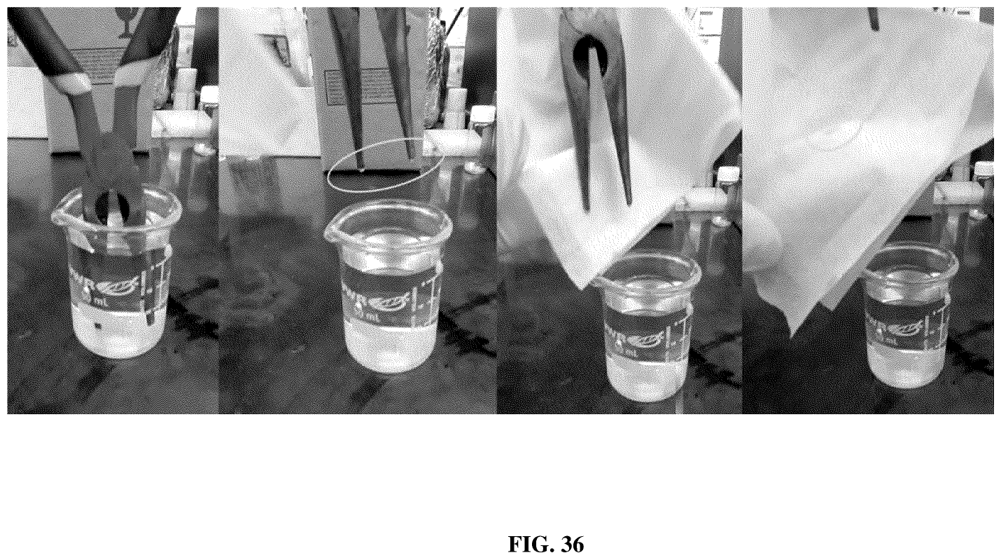

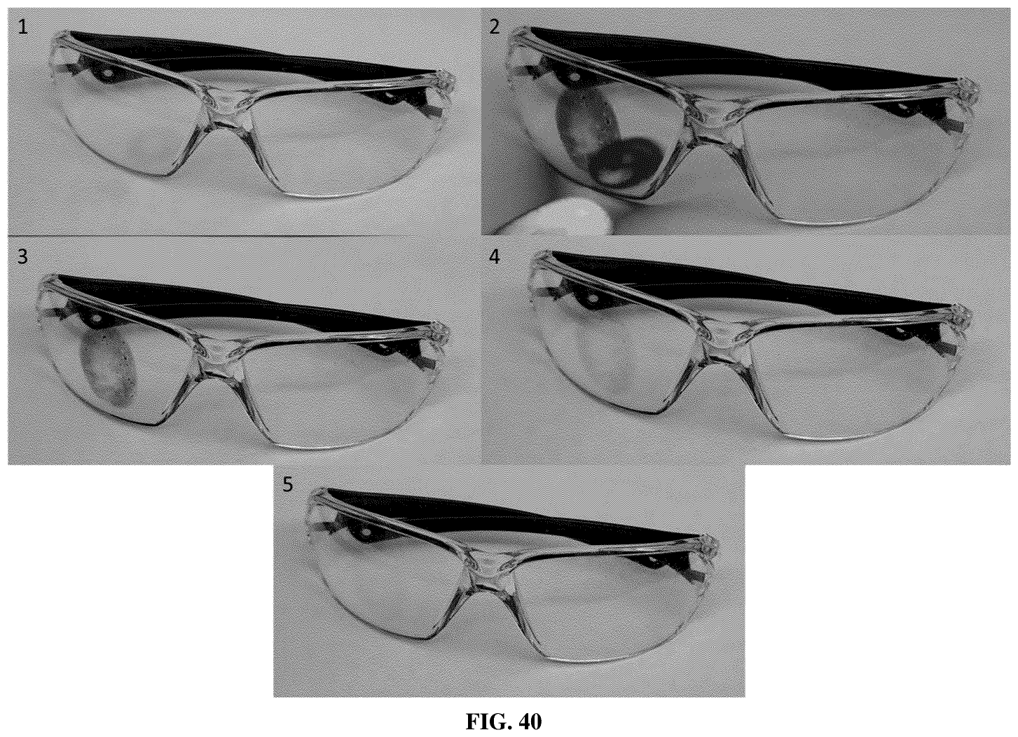

A variety of possible uses have been discovered throughout the development process. The system has shown success in coating many types of materials including stone, brick, glass, and steel used in buildings, monuments, sculptures, and architectural design. However, it has also been successful in use with nitriles, vinyls, and materials such as leather. While the characteristics on some of these materials may not be the same as those mentioned above (nitrile and leather have much lower contact angles and the coating solution should be wiped on these surfaces with several coats), they still offer unique functionality. When applied to the railing of a bass fishing boat, the hybrid coating gave a smooth, glossy finish which offers protection from marring (FIG. 39). Glass may be stained through long term submersion (e.g., one month) of coated samples in water which contains food dyes and may then have a second coating applied, trapping the color (FIG. 32). Dyes may also be integrated into the system or applied in-between layers of coating to give a desired color or effect. For example, a photochromic dye may be incorporated into a hybrid coating coated on eyeglasses (FIG. 40). As another example, the hybrid coating may include dyes or pigments and be coated over a painted substrate to provide an alternative color or appearance to the substrate when cured. When glass vials are coated on the inside or outside, aqueous solutions are easier to remove, and the container is dry immediately upon removal. Additionally, coated glass slides float on the surface of water by adding additional hydrophobicity to the surface tension effects (FIGS. 33-34). While the steel blades showed great adhesion over edges in the SEM images, similar hydrophobicity as seen in glass are also imparted on metal tools when coated (FIGS. 35-36). When initial tests for the release of PET plastics were carried out with melted PET and the coated blades, the system showed some promise, however the metal sample used was too flimsy to quantify. Secondary testing using raw and coated aluminum samples showed the adhesion of melted PET to the raw sample, while the coated aluminum readily released the material. These findings indicate a versatile range of possible uses for the one pot system including architectural, preservation, graffiti resistance, art, textiles, tooling, industrial mold processes, flame resistance, automotive, aquatic vehicles, marine tools, anti-fouling, rust resistance, water stain prevention, hardwater system protection, anti-fogging/smearing, and items that require added chemical resistances.

Integration of three orthogonal polymeric chemistries has led to the formation of a single coating system that combines each species' preferred characteristics. By using complementary systems, many of the negative characteristics of the individual polymeric groups are prevented or deafened. The addition of a fluoropolymer adds additional desired properties when done in a reasonable amount; however, too much becomes contradictory. Providing a UV-initiated reaction forms a base network for the underlying system to form along, offering a unique set of properties with a rapid formation and long potlife.

### Materials

All chemicals were obtained through reputable commercial sources and used without further purification unless otherwise noted. The following chemicals were used in the formation of examples 1-13, and the testing methods detailed above. Hexane and sodium chloride were obtained from VWR International. Calcium chloride dihydrate, dichloromethane, glacial acetic acid, magnesium chloride, nitric acid, sodium hydroxide, sulfuric acid, and 1-butanol were purchased through Fisher Chemicals. 3-aminopropyltriethoxysilane, (3-glycidoxypropyl) trimethoxysilane, 3-mercaptopropyltrimethoxysilane, (tridecafluoro-1,1,2,2-tetrahydrooctyl)triethoxysilane, and vinyltriethoxysilane were obtained through Gelest Inc. Isopropyl alcohol and methanol were purchased through EMD Millipore Corporation. 1,3-Divinyltetramethyldisiloxane, poly(ethylene glycol) 400, and tetrahydrofuran were obtained through Sigma-Aldrich and triethoxy (1H, 1H,2H,2H-nonafluorohexyl)silane from AmBeed. Diaryliodonium hexafluorophosphate and tetrabutylammonium fluoride, 1M in THF, came from Acros Organics, and omnirad 819 from IGM Resins USA, Inc. 1,2-Bis(triethoxysilyl)ethane was obtained from Accela and methyltriethoxysilane through Alfa Aesar. Octamethylcyclotetrasiloxane, 2,4,6,8-tetramethyl, and 2,4,6,8-tetravinylcyclotetrasiloxane were purchased from TCI. Ethanol (200 proof) was purchased from Pharmco. Microflex powder-free nitrile gloves were purchased from Ansell Healthcare Products LLC. A Vivosun handheld garden pump pressure sprayer was purchased through Amazon Inc. Great Value distilled white vinegar, 5%, was locally purchased from Wal-mart Stores, Inc. Mixed vinylsilsesquioxane cages (T8, T10, T12) were synthesized according to known methods. Siloxane depolymerization solution was made according to international patent application PCT/US2022/014500.

### Experimental Methods

### Testing Solutions

Rust solution was made by diluting 350 mL of white vinegar to 1 L with distilled water and adding 3.048g NaCl.

Imitation hard water was produced by adding 1.4729 g NaCl, 2.8143g CaCl₂·2H₂O, and 5.0883 g MgCl₂ to 250 mL of distilled water.

Synthetic rain was made using 1 L of distilled water with a soda stream carbonated water system until a pH of 5 was achieved. Next, while stirring, five drops of nitric acid were added, and then sulfuric acid was added dropwise until a pH like acid rain (4.31) was achieved.

### Sample Preparation

To remove existing films or coatings, stone surfaces were stripped using 120 grit sandpaper (Ryobi 4″×36″ belt sander). Stone and glass samples were rinsed with distilled water, dried, sprayed with 0.1 M nitric acid, allowed to dry, then rinsed to imitate accelerated exposure to acid rain. Stainless steel surfaces were sandblasted to expose the raw surface and used as-is. Brick samples were scrubbed clean with a brush and water and then dried for several weeks. Nitrile gloves were used as-is.

### Synthesis of the Coating

General coating synthesis was made as a one-pot system by volume percentage. Solids were calculated as a mass-volume percentage to yield a final formula. Components of each formulation were added to a 500 ml bottle and the resulting solution was then vortexed and stored in a dark location at room temperature. The bottle was shaken and vortexed prior to any following usage. Ratios within the ranges depicted in Table 1 were used for their associated variants (i.e., thiols, allyl, epoxy, amine, initiators, and optional additives) in all formulations. Examples are given under formulations.

### Coating Application

Indoor methods: Three application methods were used. Samples were sprayed until the surface appeared damp, dipped into the solution, and then allowed to dry while hung/suspended, or wiped on using tissue and the solution. Upon coating, samples were exposed to UV A light (200-Watt Mercury Arc Lamp with 320-390 nm filter, OmniCure Series 1500, Excelitas Technologies, Lumen Dynmaics Group Inc.) for two minutes and allowed to sit for thirty minutes.

Outdoor methods: Samples were spray-coated outside under sunny conditions with a UV index above 7 (>175 mW/m²/s), temperature over 21° C., and a clear forecast for 12 hours after application. The application was made in a back and forth sweeping motion like aerosol paint usage. For small samples, disposable perfume bottles were used. For large samples, a handheld pressure sprayer was used.

### Analytical Methods

### Thermal Gravimetric Analysis (TGA)

Ceramic yields and thermal stabilities of samples were measured with a Hitachi STA7200 Thermal Analysis System (SN: 19112035C1-01) using Software for NEXTA (Hitachi High-Tech Science Corporation, 2018, 2019). 3.11, 4.44, and 9.60 mg samples were placed into a ceramic crucible and heated at a rate of 10° C. per minute from 25 to 1000° C. and an airflow of 60 mL/min. The pre-dried samples were baked at 45° C. for 24 hours to remove any solvent prior to thermal stability testing.

### Attenuated Total Reflection Fourier Transform Infrared Spectroscopy (ATR-FTIR)

Attenuated total reflection (ATR) methods were used, and spectra were collected using OMNIC Spectra (Thermo Scientific, 2017). Spectra were obtained on a Thermo Scientific ATR-FTIR (Nicolet iS5 Fourier Transform Infrared Spectrometer iD7 Attenuated Total Reflection, SN: ASB1817610). Liquid sample was placed on a ZnSe crystal, and the cured sample was obtained by coating a glass slide and placing the coated side down on the detector post-cure. The cured sample was obtained by coating a glass slide and placing the coated side down on a ZnSe crystal, and the liquid sample was placed directly on the ZnSe crystal and scanned. All samples were scanned from 4000 to 400 cm⁻¹ for 16 scans with 0.121 cm⁻¹data spacing.

### Scanning Electron Microscopy (SEM)

Samples were prepared using a Hummer VI-A Sputter Coater. Images were obtained using a Hitachi S-2700 Scanning Electron Microscope. Series of images were obtained using 50-1000× magnification with working distances ranging from 13-25, 15-20 KV, and an aperture of 3 or 4. The coating was applied to different materials, and images of the coated and uncoated areas were taken using the same settings.

### Pencil Hardness Assessment

Hardness tests were performed using an Elcometer 501 pencil hardness tester (7.5 Newtons, Elcometer Instruments Ltd., Manchester, England). Coated glass and stone samples were assessed in increasing hardness.

### Quantified Abrasion Resistance

Coated stone samples were weighed, sandpaper was placed on the surface with a weight (50.004 g) on top, and the paper was passed across the surface (100 times). Samples were then blown clean (45 psi airflow) and reweighed. This was done in series using smooth (400 grit) and then rough (220 grit) sandpaper. Then the samples were sandblasted (30 seconds, 45 psi) and reweighed to calculate. The mass lost was calculated between each test and the observations made.

### Coating Surface Analysis

Initial coating thickness measurements and topographic mapping were obtained using a 3D Laser Confocal Microscope (Keyence, VK-X1000 Scrics). Average coating thicknesses were obtained using an Alpha-Step IQ Surface Profiler (KLA Tencor). Glass slides were prepared using the dip-coat method, and five measurements were taken in opposite directions over the interface totaling ten thicknesses from which an average was obtained. Step height analysis was taken with a stylus force between 24.2-25.7 mg, 2000 μm scan length, 50 μm/s scan speed, 50 Hz sampling rate, 40 s scan time, 400 μm/23.8 pm sensor range, center bias adjustment, 1 μm resolution, contact speed of 5, and required radius of 5.0 μm.

### Submersion Tests

Before drying, coated stone samples were submerged in various solutions for 24 hours to investigate water and pH stability. Distilled water, tap water, synthetic acid rain (4.31 pH), and 0.1 M NaOH solutions were used. Samples were inspected for delamination, cracking, and discoloration.

### Chemical Resistance

Pieces of cured coating were placed on a watch glass then submerged in various solvents for 24 hours to check for reactivity and solubility. Tetrahydrofuran, hexane, dichloromethane, acetone, methanol, ethanol, isopropanol, 0.1 M nitric acid, 0.1 M sodium hydroxide, and water were used. Additional coating pieces were placed in a vial with the siloxane depolymerization solution and allowed to stir in the solution for one month.

### Graffiti Resistance

Two tests were conducted to investigate the effects of common vandalism tools on the final product. First, a line was drawn on samples using a Sharpie (Newell Brands). Then, tissue was used to wipe the permanent marker off the surface gently. Second, spray paint (Rust-Oleum Painters touch 2× Ultracover paint+primer) was applied to the surface and allowed to dry. Then tissue was used to remove the paint.

### Contact Angle Measurements

Water was added dropwise via syringe to surfaces, and images were obtained using a Zeiss Stemi 2000-C light microscope with an AxioCam ERc5s camera. Contact angle analysis was performed using ImageJ software (1.53e, National Institutes of Health, USA) and the manual points procedure through the contact angles plug-in. Values were derived by taking the mean of the right and left angles.

### Rust Resistance

A rusting solution was used to accelerate the occurrence of oxidation. Steel samples were dip-coated, and two testing methods were carried out. Samples were hung and sprayed with the solution on both sides daily for one week, and samples were submerged in the solution for two weeks exposing the same length of coated and uncoated sample to the solution.

### Stain Resistance

A mixture of 0.1 M NaCl, 0.1 M CaCl₂, and 0.1 M MgCl₂ was made and applied dropwise to glass slides (half coated, dip-coat method) on both areas. Two heating methods were used. A heating gun was used to rapidly dry the solution and leave the salt residues, and then a clean tissue was used to wipe the residue off the surfaces. An oven was set to 45° C., and the glass slide was baked for 24 hours and once cooled, a tissue was used to wipe the residue off the surfaces. Both were observed for staining, smearing, and adhesion.

Environmental Stability Testing

Indoor methods: Samples were placed in an oven at 45° C. for 24 hours, allowed to cool for 24 hours, and then heated again for two cycles to investigate heat resistance. Samples were placed in a freezer for 24 hours then allowed to warm to room temperature; this was repeated after submerging samples in water for 24 hours to imitate mixed rain and snow weather.

Outdoor methods: Samples were prepared outdoors, and the initial weather conditions were recorded, including temperature, forecast, the chance of precipitation, wind, humidity, dewpoint, atmospheric pressure, UV index, air quality, ozone, nitrogen dioxide, sulfur dioxide, carbon monoxide, and particulate (μg/m³). Weather data was recorded daily for the lifetime of the samples and will continue as long as they remain intact. Instances where data was not recorded the day of were noted, and historical records were used. Any unique phenomenon was noted, including regional wildfires, flooding, and nearby activities like construction which may alter the air quality of the test site.

### Fire Retardation Testing

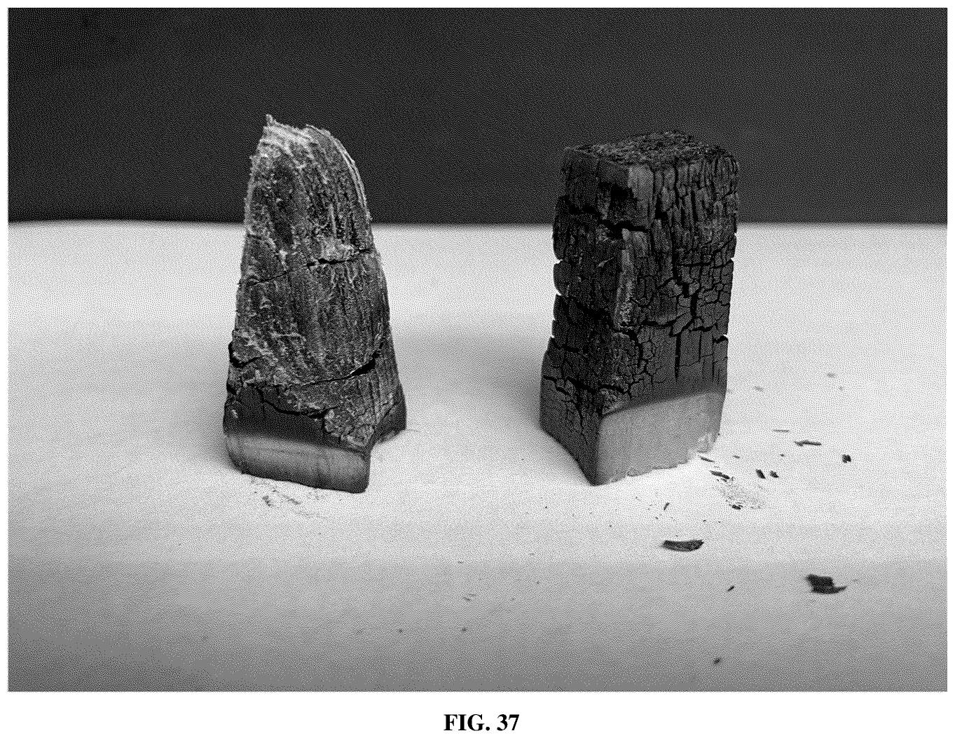

A test of the hybrid coatings' fire retardation abilities was conducted. Example 12 was coated onto a piece of wood and allowed to cure, and the coated wood was ignited alongside a non-coated piece of the same wood. FIG. 37 shows a photograph of the result, where the wood on the right in the photograph is coated with the cured hybrid coating and the wood on the left in the photograph is uncoated. As seen from FIG. 37, the hybrid coating is effective as a fire retardant.

### Material Release Testing

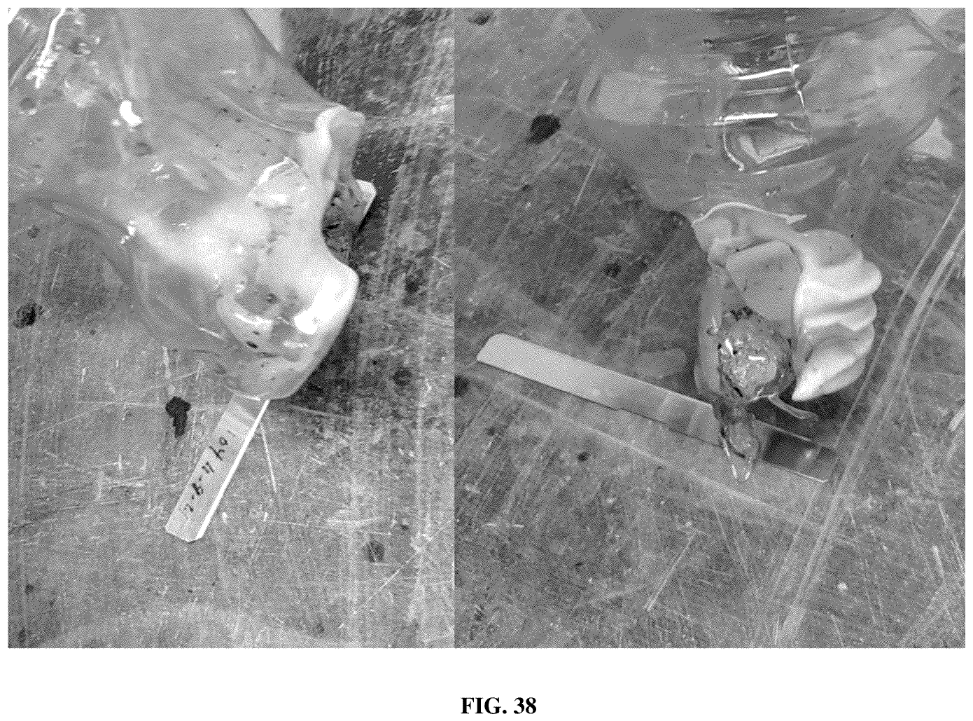

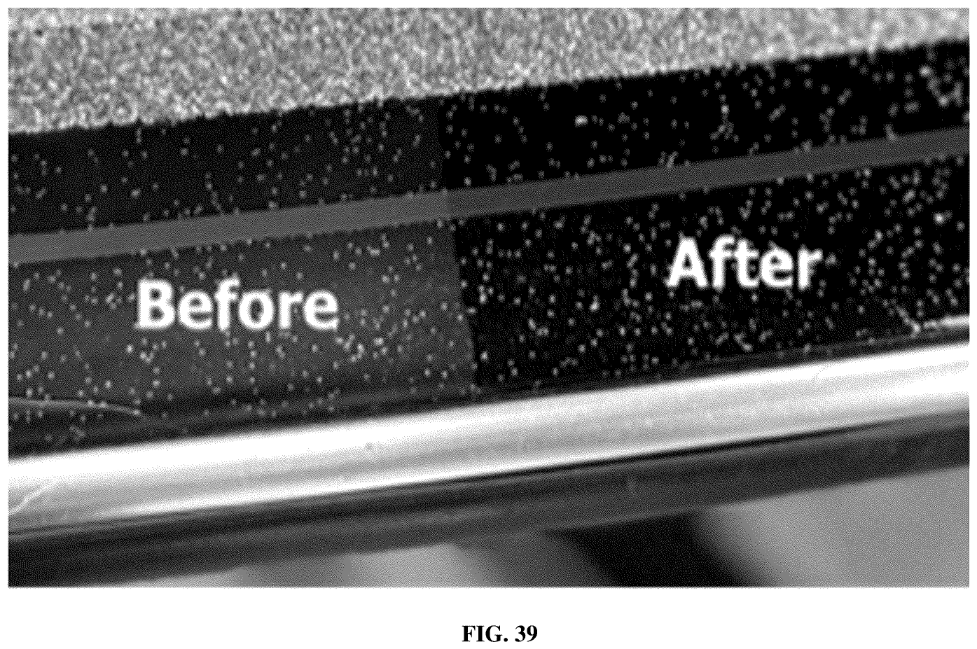

Tests of the hybrid coatings' ability to ease the release of materials used in industrial molds were conducted. An initial test utilized the histology blade partially coated using example 11. A PET #1 plastic bottle was heated with a heating gun until it reached a liquid consistency, and then it was deposited on both surfaces. Additional testing followed the same methods using stock aluminum and welding steel plates which were coated with example 12. The results are shown in FIG. 38.

### Marine Vehicle Testing

The hybrid coating was tested on a boat. FIG. 39 shows a photograph of a bass boat rail before and after coating with example 12. FIG. 39 highlights the transparency and protective nature of the hybrid coating. The hybrid coating gave a smooth, glossy finish which protected the boat rail from marring.

### Thermal Cure Testing

Tests of the hybrid coatings' ability to cure through thermal initiation was performed in a 20 mL vial where 2 mL of the hybrid coating, 0.22 g of ZnCl₂, and 4 drops of hydrogen peroxide (30% aqueous) were mixed and then split into two samples. Sample 1 was exposed to 65° C. for 5 minutes then allowed to rest at room temperature. After 30 minutes, the hybrid coating was stiff and would not run, and by 45 minutes the material had hardened. The material was spongy, like a firm gel, and did not take an impression. Sample 2 was allowed to rest at room temperature for an hour to observe its stability at room temperature. No changes were observed (no observable thickening or curing occurred), then the sample was exposed to >150° C. where it hardened within 30 seconds. Additional verification was done with the formula provided in Table 4 (example 15) to ensure the process occurs through a thermal process and confirm there was no activation of the photoinitiators through the thermal processes. In this version, the coating was exposed to 65° C. for 5 minutes and hardened within 45 minutes. This shows that the thermal cure can increase the rate by increasing the temperature, and results in stability at room temperature.

TABLE 4
Example formulation used in thermal cure process (example 15)
Thermal Cure

| Reagent | Volume (mL) | Concentration | |
|---|---|---|---|
| 3-Glycidyloxypropyltrimethoxysilane | 2.75 | 13.9% | v/v |
| 3-Aminopropyltriethoxysilane | 2.47 | 12.5% | v/v |
| (3-Mercaptopropyl)-trimethoxysilane | 1.00 | 5.1% | v/v |
| Vinyltriethoxysilane | 1.11 | 5.7% | v/v |
| ZnCl₂ (g) | 0.20 | 1.0% | m/w |
| Methanol | 3.62 | 18.4% | v/v |
| Isopropanol | 8.36 | 42.4% | v/v |
| 30% Hydrogen Peroxide | 4 drops | 1.0% | v/v |

### Encapsulant

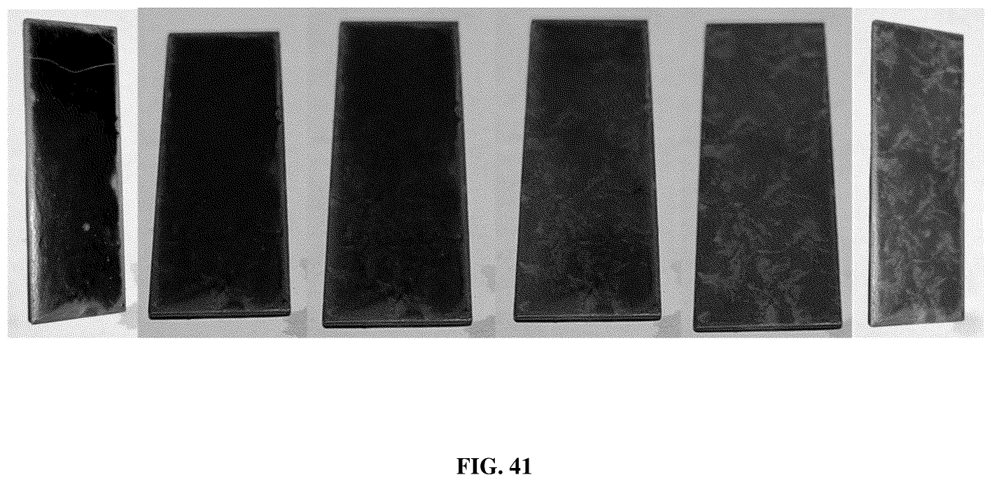

The hybrid coatings can be used to carry or encapsulate pigments, dyes, liquid crystals, or particulates. The hybrid coatings can be applied overtop of a paint or coating as a top-finish. Application of a hybrid coating with a dye overtop of a painted surface can use one or more active dyes to alter the surface color of the painted surface. FIG. 41 shows a still-frame time lapse (22 seconds) of a camo-painted surface coated with an active loaded hybrid coating (specifically, example 12).

### Active Pigment

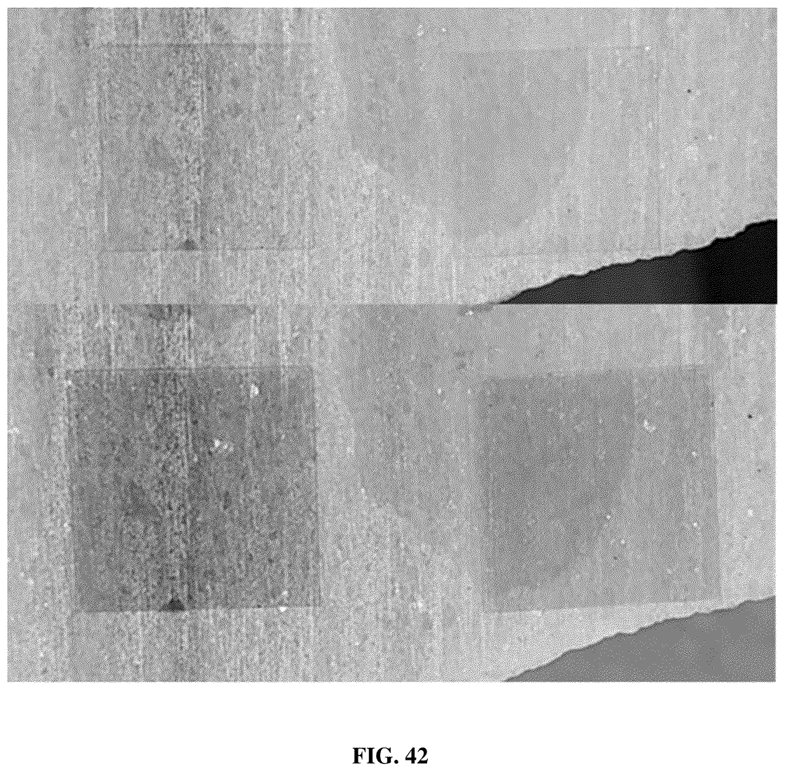

Active pigments on glass slides provide a photo transitioning effect. FIG. 42 shows glass squares coated with a hybrid coating (example 12) containing an active dye before (top) and after (bottom) 5 seconds of exposure to sunlight. The color vanishes seconds after removal from the sun.

### Pigments and Dyes

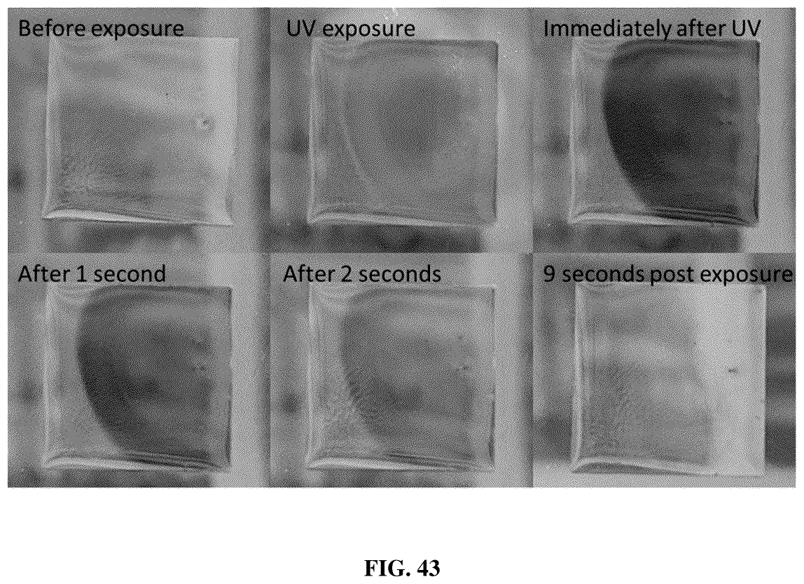

The addition of pigments and dyes to the hybrid coating prior to application to a surface can result in a colored finish. FIG. 43 shows a still-frame time lapse of a glass slide coated with the example 14 hybrid coating which further contained two dyes.

Reduced Glossiness From Salt on Semi-Gloss, Matte Finishes

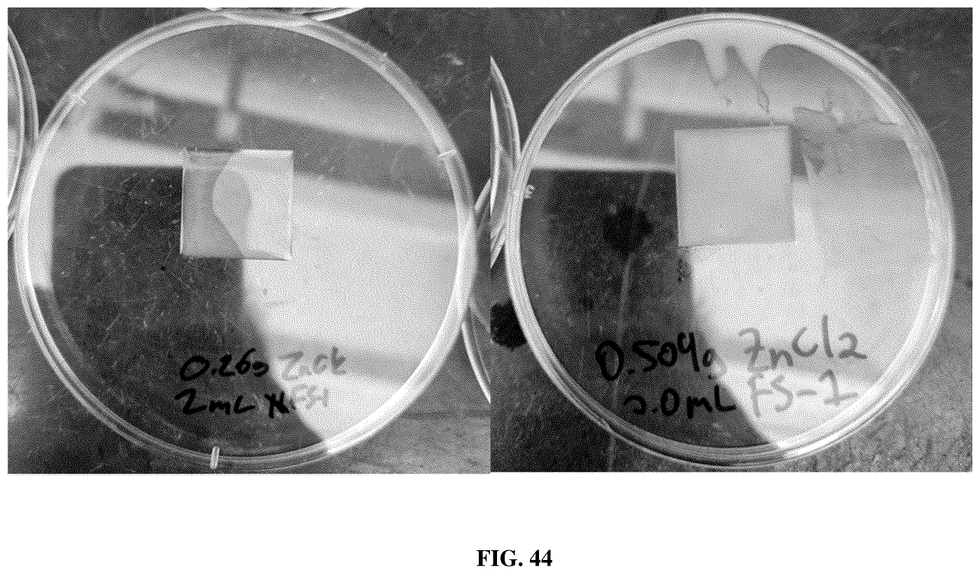

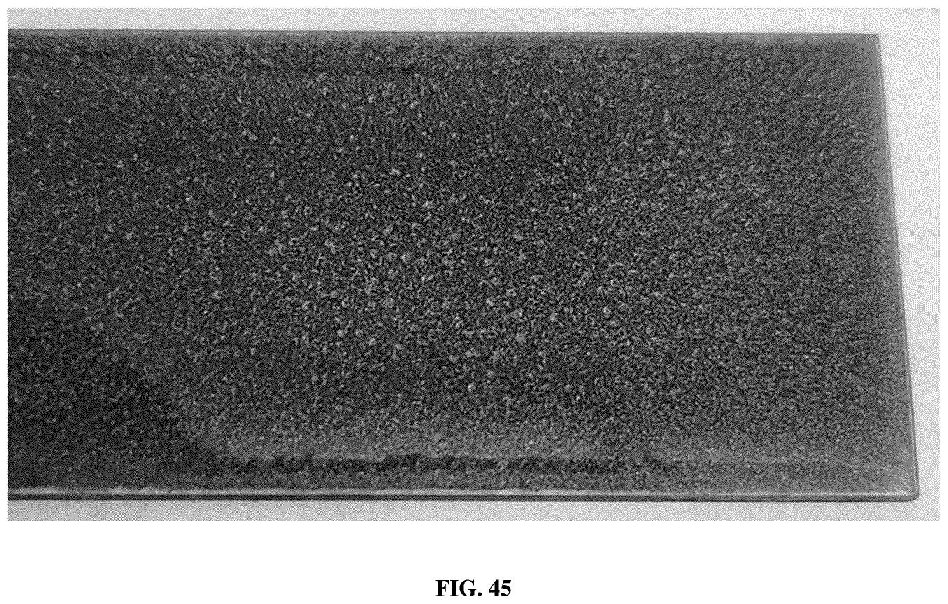

Use of ZnCl₂ in concentrations above 0.9 M in the tri-cure hybrid coating formulations yields a matte finish. FIG. 44 shows fluorocarbon-containing coatings (example 14) containing 0.95 M (left) and 1.84 M (right) ZnCl₂, exhibiting an off-white color and showing a loss of gloss and reflectiveness. (Notably, these amounts of ZnCl₂ are about 10× more than the amount of ZnCl2 used in example 15 for thermal curing.)

### Coating Impregnation

Metals such as copper, zinc, and iron, and carbon fibers such as graphene and nanotubes, can be added to the hybrid coatings in order to reduce static buildup on the coating surface. For example, copper powder can be suspended within the coating. FIG. 45 shows copper powder suspended and encapsulated within the example 12 hybrid coating.

### Coating/Film for Glasses

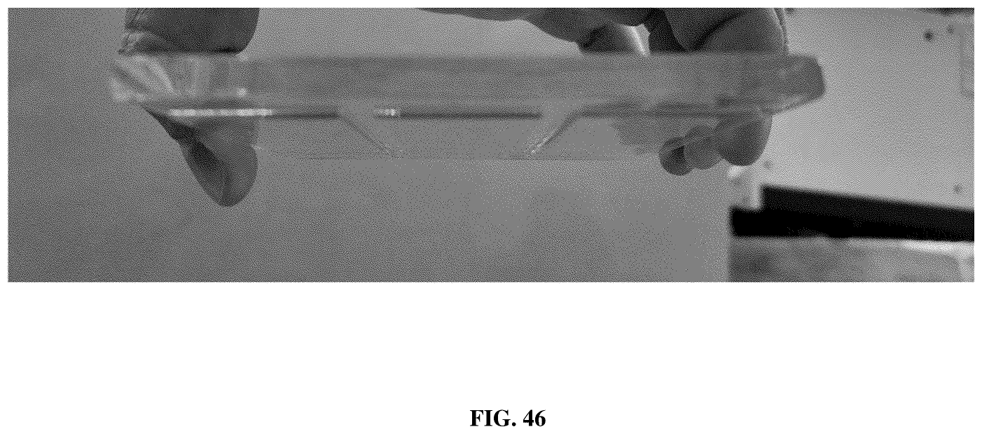

The hybrid coatings can be used as a coating or film for glass products, such as windows and windshields. The hybrid coatings can also be used as an adhesive for glass products. FIG. 46 shows glass slides adhered to a larger sheet of glass using a hybrid coating (specifically, example 14).

### Barrier for Oils

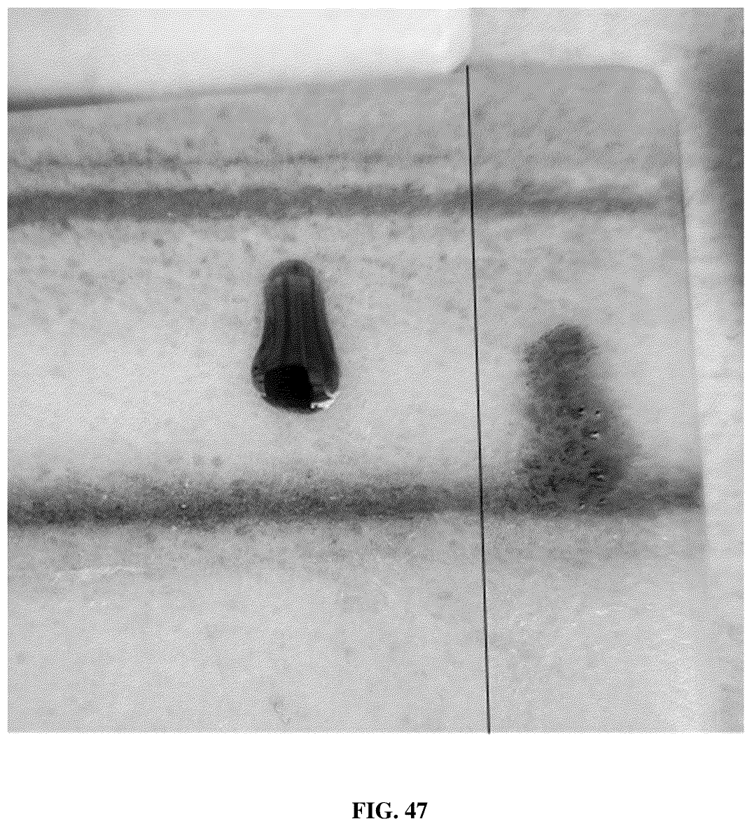

Used motor oil was deposited on a piece of marble and left to sit for one month. FIG. 47 shows the results. The marble on the left of the line in FIG. 47 is coated with the example 12 hybrid coating, which prevented the absorption of the oil. On the right side in FIG. 47, the marble was not coated and the oil was absorbed.

### Efflorescence

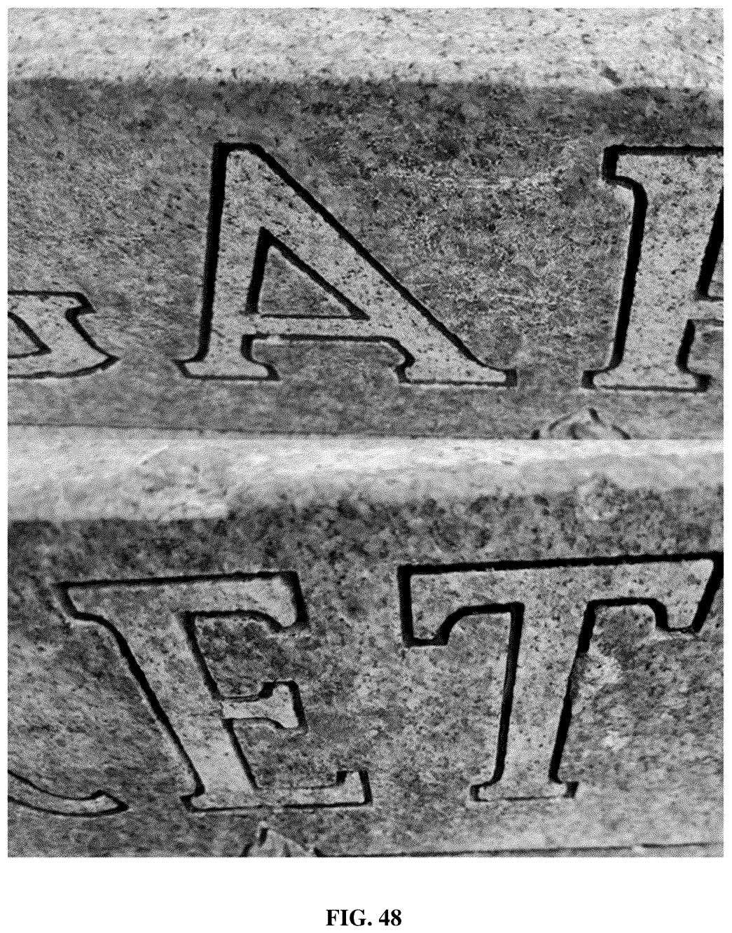

A granite tombstone was coated with a hybrid coating (example 12) and exposed to 100% humidity and 5% NaCl salt fog for 240 hours. FIG. 48 shows the results. The uncoated surface (top in FIG. 48) exhibited efflorescence or salt build-up, notable by the white powder in the cracks of the stone. The coated surface (bottom in FIG. 48) showed a major reduction in efflorescence.

### Flame Resistance

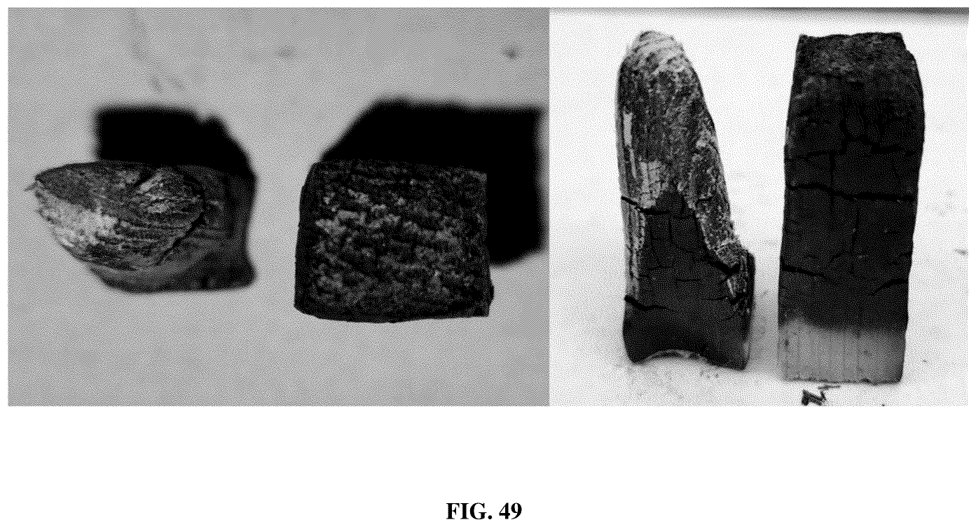

The hybrid coating provides self-extinguishing capabilities to wooden structures, reducing combustibility and reducing structural damage after fires (either natural or man-made). FIG. 49 shows a comparison of raw (left) and coated (right) pine wood which was burned for 4 minutes at greater than 1,000° C. The coated pine wood was coated with example 12.

### Bio-Medical Applications

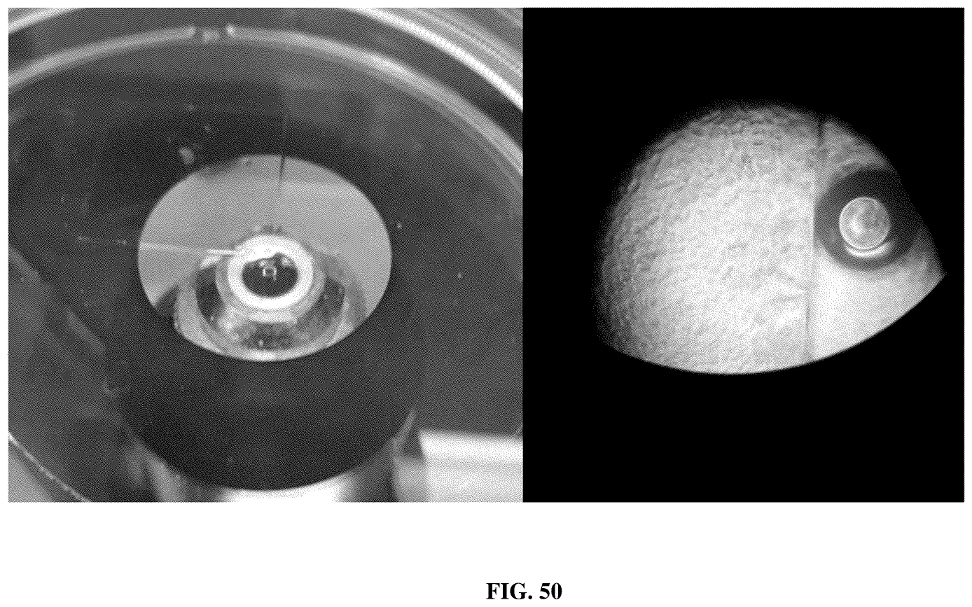

The hybrid coatings can be used to coat floors, equipment, instruments, and the like for bio-medical applications. Cells show reduced adhesion on coated surfaces, but hybrid coatings are non-toxic in that they do not inhibit growth. FIG. 50 shows photographs of a glass square coated with example 14 and inoculated with HEK293 mammalian adherence cells. The hybrid coating did not prevent growth but reduced adhesion of the cells to the glass.

### Anti-Microbial Properties

The hybrid coatings can be loaded with silver in a non-fluorinated formulation for anti-microbial coatings in medical or biotechnical applications. Sidechain functionality can be used for bio-medical purposes. For example, silver chloride can be added to the hybrid coatings to impart anti-microbial properties in addition to the reduced adhesion properties described above.

### Anti-Fouling

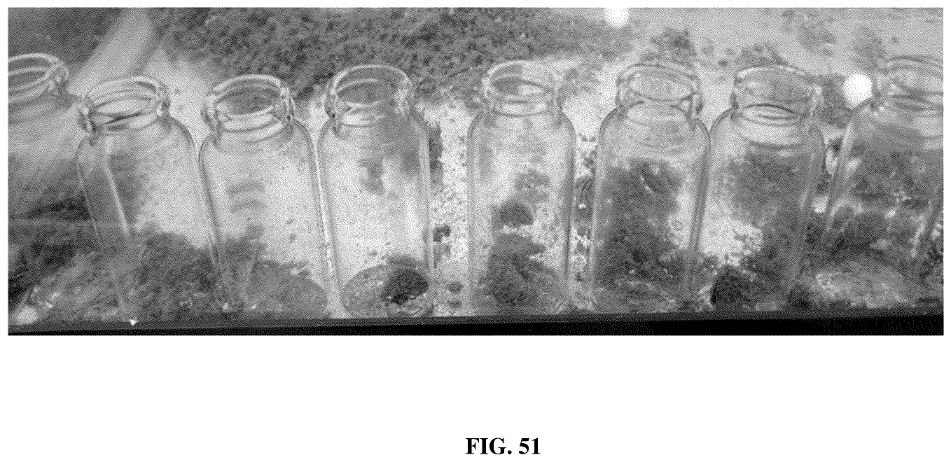

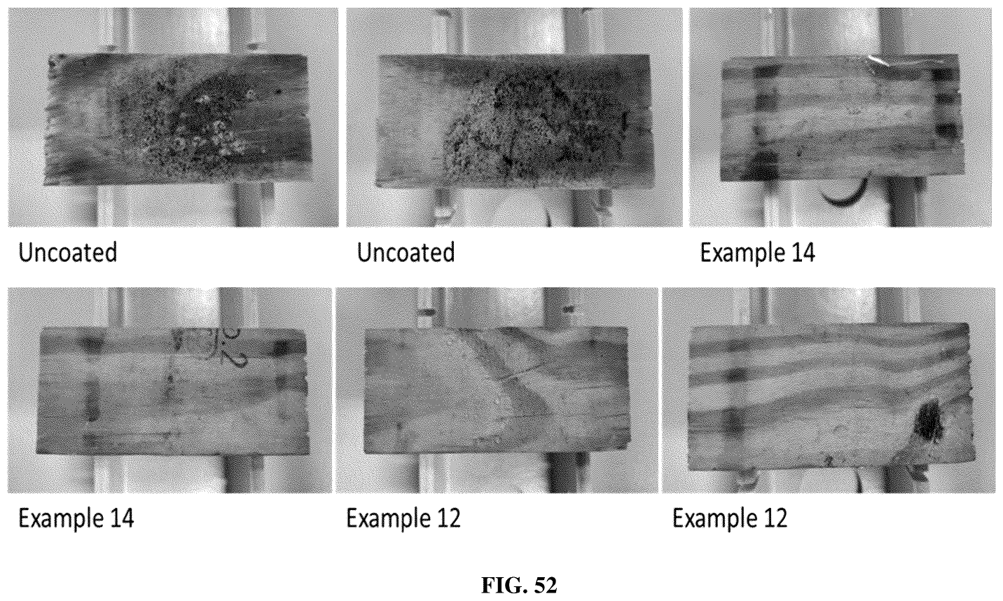

The hybrid coatings prevent microbes from adhering, or otherwise weakens the strength of adhesion by microbes to coated surfaces. This results in easier removal of bacteria from coated surfaces. In a water environment, for example, the hybrid coatings prevent mussels or barnacles from adhering to coated surfaces, or otherwise weakens the strength of adhesion by the mussels or barnacles, making it easier to remove mussels or barnacles from coated surfaces. FIG. 51 shows submerged glass vials with a coated interior. Zebra mussels were inserted in the glass vials to inspect their adhesion and determine if they will migrate out of the containers. From left to right in FIG. 51, two of the glass vials were uncoated, three of the glass vials were coated with example 14, and three of the glass vials were coated with example 12. Adhesion was minimal and the mussels showed difficulty climbing the interior of the vials.

### Anti-Fungal Properties

The hybrid coatings prevent black mold and mildew from growing on coated wood surfaces. FIG. 52 shows the difference in mold and mildew growth and color change when raw pine, non-fluorinated coated wood (coated with example 14), and fluorinated coated wood (coated with example 12) were saturated by a 100% humidity, 5% NaCl salt fog for 240 hours. The samples are still wet in the photographs.

### Rotting and Color Loss

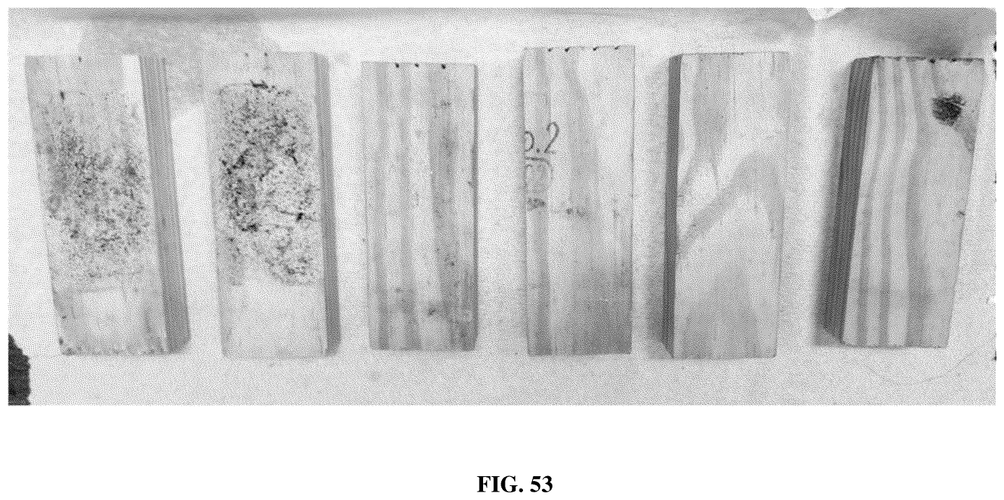

FIG. 53 shows the same blocks as seen in FIG. 52 after being left to dry for 6 months. The uncoated samples (left) still supported mold and mildew but had lost color and began to split on the ends. The non-fluorinated (middle; coated with example 14) and fluorinated (right; coated with example 12) hybrid coating coated samples retained their original color and had not begun to split on the ends.

Certain embodiments of the compositions and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A hybrid coating comprising:
a thiol alkoxysilane;
an alkene alkoxysilane;
an epoxy alkoxysilane;
an amine alkoxysilane; and
a solvent;
wherein the hybrid coating is in the form of a curable solution.

2. The hybrid coating of claim 1, further comprising a photoinitiator, wherein the hybrid coating is in the form of a photo-curable solution.

3-4. (canceled)

5. The hybrid coating of claim 1, wherein the alkene alkoxysilane comprises a vinyl group or an allyl group.

6-13. (canceled)

14. The hybrid coating of claim 1, further comprising a fluorocarbon up to about 30% v/v.

15. (canceled)

16. The hybrid coating of claim 1, further comprising a silsesquioxane.

17-20. (canceled)

21. The hybrid coating of claim 1, wherein the solvent comprises an alcohol having complementarity to one or more of the amine alkoxysilane, the epoxy alkoxysilane, the thiol alkoxysilane, or the alkene alkoxysilane.

22. The hybrid coating of claim 1, wherein:
the thio alkoxysilane includes a di- or tri-alkoxysilane;
the alkene alkoxysilane includes a di- or tri-alkoxysilane;
the epoxy alkoxysilane includes a di- or tri-alkoxysilane; and
the amine alkoxysilane includes a di- or tri-alkoxysilane.

23. (canceled)

24. The hybrid coating of claim 1, further comprising a spacer comprising D₄ octamethylcyclotetrasiloxane or a polyethylene glycol (PEG).

25. (canceled)

26. The hybrid coating of claim 1, further comprising an acid comprising glacial acetic acid, or a photoacid generator, or a combination thereof.

27-29. (canceled)

30. The hybrid coating of claim 1, comprising 3-glycidyloxypropyltrimethoxysilane, 3-aminopropyltriethoxysilane, triethoxy(1H,1H,2H,2H-nonafluorohexyl) silane, (3-mercaptopropyl)-trimethoxysilane, vinyltriethoxysilane, omnirad 819, diaryliodonium hexafluorophosphate, methanol, and isopropanol.

31. (canceled)

32. The hybrid coating of claim 1, comprising 3-glycidyloxypropyltrimethoxysilane, 3-aminopropyltriethoxysilane, (tridecafluoro-1,1,2,2-tetrahydrooctyl)triethoxysilane, (3-mercaptopropyl)-trimethoxysilane, vinyltriethoxysilane, omnirad 819, diaryliodonium hexafluorophosphate, methanol, and isopropanol and/or 1-butanol.

33-35. (canceled)

36. The hybrid coating of claim 1, further comprising a salt, a peroxide, or a thermal acid generator, wherein the hybrid coating is in the form of a thermally curable solution.

37-38. (canceled)

39. The hybrid coating of claim 36, comprising 3-glycidyloxypropyltrimethoxysilane, 3-aminopropyltriethyoxysilane, (3-mercaptopropyl)-trimethoxysilane, vinyltriethoxysilane, ZnCl₂, methanol, isopropanol, and hydrogen peroxide.

40-42. (canceled)

43. A hybrid coating comprising Formula I: 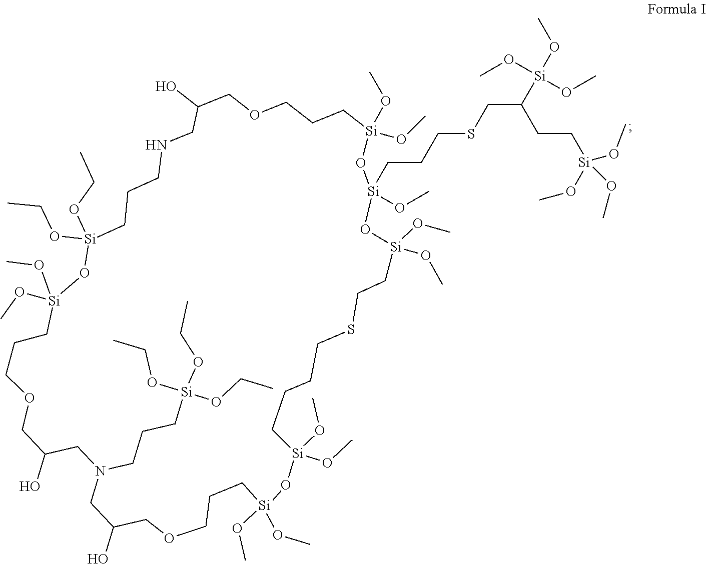
wherein the hybrid coating is in the form of a cured solid.

44-51. (canceled)

52. A method of protecting a surface from scratches, water, acid rain, or graffiti, or reducing cell adhesion to the surface, or forming a barrier to oil on the surface, or reducing efflorescence on the surface, or improving anti-fouling properties of the surface, or making the surface anti-fungal and resistant to rot, the method comprising applying the hybrid coating of claim 1 to a surface and allowing the hybrid coating to cure to protect the surface from scratches, water, acid rain, or graffiti, or reducing cell adhesion to the surface, or forming a barrier to oil on the surface, or reducing efflorescence on the surface, or improving anti-fouling properties of the surface, or making the surface anti-fungal and resistant to rot.

53. A method of protecting an item from fire damage or making a surface of the item more resistant to fire, the method comprising applying the hybrid coating of claim 1 to an item or a surface of the item and allowing the hybrid coating to cure to protect the item from fire damage or make the surface more resistant to fire.

54-60. (canceled)

61. A method of reducing glossiness of a surface, the method comprising incorporating a salt into the hybrid coating of claim 1, applying the salt-containing hybrid coating to a surface, and allowing the salt-containing hybrid coating to cure to reduce glossiness of the surface.

62. (canceled)

63. A method of reducing static build-up on a surface, the method comprising incorporating a metal or carbon fibers into a hybrid coating of claim 1, and applying the metal- or carbon fiber-containing hybrid coating to a surface, and allowing the metal- or carbon fiber-containing hybrid coating to cure to reduce static build-up on the surface.

64. (canceled)

65. A method of adhering two surfaces together, the method comprising applying the hybrid coating of claim 1 to at least one of two surfaces, pressing the two surfaces together, and allowing the hybrid coating to cure to adhere the two surfaces together.

66-76. (canceled)

77. A method of curing a hybrid coating, the method comprising:
coating a substrate with a hybrid coating solution containing a photoinitiator;
exposing the hybrid coating solution to sunlight or artificial UV light over a first period of time to allow a first curing process to occur so as to form a coating with a non-impressionable surface on the substrate;
allowing a second curing process to occur over a second period of time to improve adhesion between the coating and the substrate; and
allowing a third curing process to occur over a third period of time to harden the non-impressionable surface;
wherein the hybrid coating solution comprises a plurality of alkoxysilanes including epoxy, alkene, amine, and thiol components.

78-92. (canceled)
